(19) United States
(12) Patent Application Publication
(10) Pub. No.: US 2021/0069694 A1
(43) Pub. Date: Mar. 11, 2021

(54) ASSEMBLIES AND METHODS FOR SCREENING SAMPLE FLUIDS

(71) Applicant: Creoptix AG, Wadenswil (CH)

(72) Inventor: Kaspar COTTIER, Wadenswil (CH)

(21) Appl. No.: 16/772,185

(22) PCT Filed: Dec. 13, 2018
(86) PCT No.: PCT/IB2018/060000

§ 371 Date: Jun. 12, 2020

(30) Foreign Application Priority Data
Dec. 15, 2017 (CH) 01541/17

(51) Int. Cl. B01L 3/02; B01L 3/00

(52) U.S. Cl. CPC B01L 3/0293; B01L 3/502715; B01L 2400/0633; B01L 2300/0877; B01L 2400/049; B01L 2200/143

(57) ABSTRACT

According to the present invention there is provided an assembly comprising, a needle unit comprising n hollow needles wherein n is greater than one, and wherein each hollow needle can receive a respective sample fluid; a flow cell unit comprising m flow cells wherein m is greater than one, each flow cell having an input and an output, and a test surface on which ligands can be provided located between the input, and output; a means for consecutively moving sample fluids, from each of said n hollow needles respectively, into all said m flow cells, so that said sample fluids flow consecutively through the same flow cells. There is further provided a corresponding method of screening a sample fluid for molecules which can bind to predefined ligands.

### FIELD OF THE INVENTION

The present invention concerns assemblies and methods for screening sample fluids at increased throughput; specifically, the assemblies and methods allow a plurality of sample fluids to be consecutively flowed through flow cells in rapid succession, thereby allowing screening of said plurality of sample fluids in rapid succession.

### DESCRIPTION OF RELATED ART

In many applications, such as drug discovery and development, environmental testing, and diagnostics, there is a need to analyse a large number of liquid samples in a short amount of time. Devices for delivering the liquid samples are generally called autosamplers or auto-injectors and are interfaced to all manner of analysis systems including, but not limited to, optical or acoustic biosensors, mass spectrometers, chromatography systems, and spectrophotometric detectors.

Recently, the high throughput screening of molecular interactions has gained increased interest, in particular in pharmaceutical companies where drug to drug-target interactions are studied in drug discovery. During high throughput screening, typically a large number of candidate molecules are prepared at a single concentration such as 100 micromolar, and successively evaluated for binding to a drug target. If a binding event is detected, the candidate molecule is marked as a hit and further investigated. False positives are a common issue in high throughput screening, i.e. too many compounds are detected as “hits” which appear to bind, but need to be excluded during the further investigations, which is generating high additional costs. Murray et al., J Med Chem. 2014 Apr. 10; 57(7):2845-50, describes the concept of “off-rate screening”, which has the potential to overcome some current limitations, since the evaluation of a binding signal does not occur during a sample injection which can be affected by non-specific effects such as aggregation or refractive index mismatches, but during the dissociation phase which is less affected by these issues. However, current instruments lack the time resolution to resolve the fast off-rates in the order of 10 s−1 which are exhibited by the weak bindings observed in primary screens. It is therefore of great interest to provide devices for the measurement of fast off-rates.

A method for parallel sample pickup for mass spectrometers, which operates by parallel pickup of eight samples, followed by the serial injection of the samples into the analysis chamber, are known in the art. However this method cannot be readily adapted to biosensors, since the measurement channels first need to be addressed individually during sample loading in order to allow for effective referencing, and subsequently, the measurement channels need to be addressed simultaneously during the actual measurement. In addition, the time needed to complete a measurement cycle per sample is typically in the order of minutes, due to the fact that also slow kinetics need to be measured, necessitating an extended amount of time to record a meaningful change in signal in order to fit the data.

Therefore, current systems aiming at higher throughput, typically achieve this by straightforward parallelization. For example systems based on the effect of Surface Plasmon Resonance (SPR) are known in the art. However, the throughput obtained by these systems is still not sufficient to conduct a large-scale screen, and therefore these devices are restricted to secondary screening laboratory tasks. In addition, the systems suffer from several limitations which make manual intervention necessary. In particular, sensor surfaces can fail, e.g. due to compounds binding irreversibly to the surface, which needs to be detected and the chip manually exchanged. In addition, since the throughput increase is obtained by simple parallelization on these devices, parallel injections pass over different sensor surfaces which might present different characteristics, e.g. different target immobilization levels, and thus the results can become difficult to compare. Furthermore, due to the use of one syringe pump per needle, manufacturing costs are high, the instrument size is large, the risk of trapping air in a pump due to incomplete syringe pump priming is multiplied, and the buffer consumption for operating these devices is very high, requiring large buffer tanks and or frequent buffer change. Here, priming stands for filling an inner volume of a fluidic component or assembly with buffer liquid and evacuating air trapped in the fluidic component or assembly.

It is an aim of the present invention to obviate, or at least mitigate, one or more of the above-mentioned disadvantages.

### BRIEF SUMMARY OF THE INVENTION

According to the invention, these aims are achieved by means of an assembly and/or method having the features recited in the independent claims; wherein the dependent claims recite optional features of preferred embodiments.

### BRIEF DESCRIPTION OF THE DRAWINGS

The invention will be better understood with the aid of the description of an embodiment given by way of example and illustrated by the figures, in which:

FIG. 1 shows an assembly according to an embodiment of the present invention;

FIG. 2 shows an assembly according to a further embodiment of the present invention;

FIG. 3 shows an assembly according to a further embodiment of the present invention;

FIG. 4 shows a magnified view of one implementation of the first selector valve unit 4 which can be used in any of the assemblies of FIGS. 1-3;

FIG. 5 shows a magnified view of one implementation of the switching valve unit 7, which can be used any of the assemblies of the present invention.

FIG. 6a provides a perspective view of a portion of a disposable cartridge and FIG. 6b provides a perspective view of a plunger assembly, wherein the disposable cartridge and plunger assembly can mechanically cooperate with one another;

FIG. 7 provides the bottom view of a disposable cartridge, which can contain the flow cells which make up cell unit in any of the assemblies of FIG. 1 or 2.

### DETAILED DESCRIPTION OF POSSIBLE EMBODIMENTS OF THE INVENTION

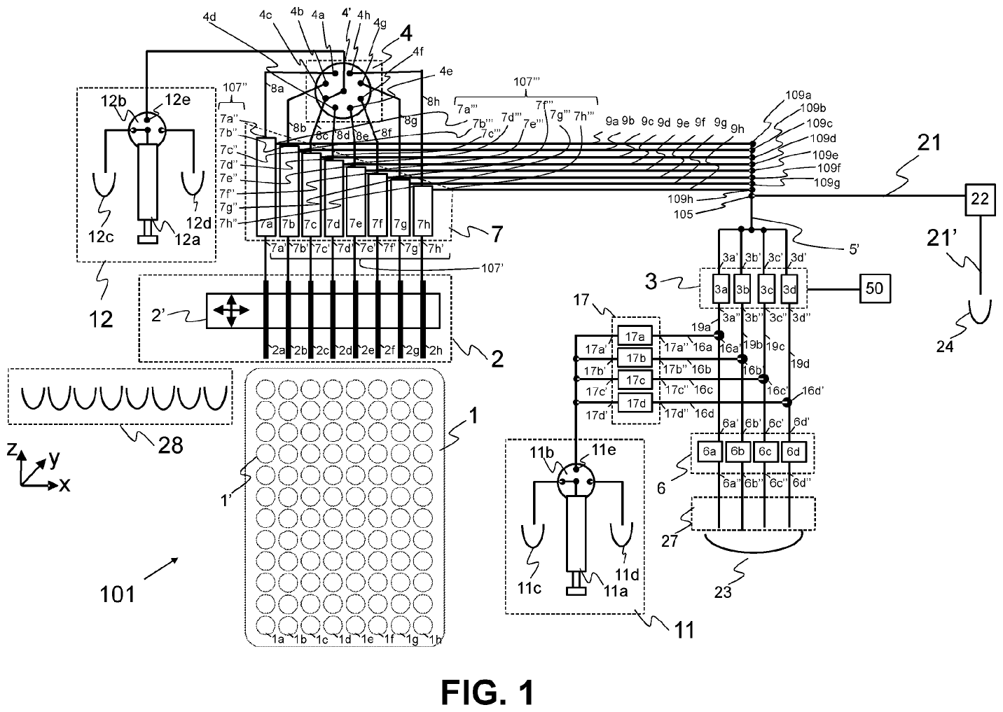

FIG. 1 illustrates an assembly 101 according to one embodiment of the present invention.

The assembly 101 comprises, a needle unit 2, a flow cell unit 3, a first selector valve unit 4, a pumping means 12, and a switching valve unit 7.

The needle unit 2 comprises n hollow needles 2a-h, wherein n is greater than one. In this particular example n is equal to eight so needle unit 2 comprises eight hollow needles 2a-h. However it should be understood that n may have any value greater than one.

The flow cell unit 3 comprises m flow cells 3a-d, wherein m is greater than one. In this example m is equal to four so that flow cell unit 3 comprises four flow cells 3a-3d, namely a first flow cell 3a, a second flow cell 3, a third flow cell 3c and a fourth flow cell 3d. However it should be understood that m many have any value greater than one. Each flow cell 3a-d has a respective input 3a′-3d′ and a respective output 3a″-3d″, and a test surface on which ligands can be provided located between its respective input 3a′-3d′ and output 3a″-3d″.

Preferably the assembly 101 further comprises a sensor 50 which can detect if molecules of a sample fluid which has flowed through one or more of the m flow cells 3a-d, have become bound to ligands on the test surface(s) of said one or more flow cells 3a-d. Preferably the sensor 50 can generate time-resolved signals for recording or monitoring binding of molecules to ligands on the test surface(s) of said one or more flow cells 3a-d, over time. The sensor 50 may take any suitable form, for example the sensor 50 may comprise a Surface Plasmon Resonance sensor, or, Waveguide interferometry sensor, or, surface acoustic sensor) which is configured to measure if molecules have become bound to the ligands on the test surface of a flow cell 3a-d of the flow cell unit 3. The sensor 50 is preferably operably connected to the flow cell unit 3 so that it can perform such measurements. In a typical drug discovery application, the aim is to identify samples which have molecules (which in this case are drug candidates) which can bind to predefined ligands (which in this case are drug targets), said predefined ligands preferably being a known type of protein which can be found in a human body; said predefined ligands are provided on the test surface of the flow cells 3a-d. Therefore if a flow cell has said specific ligand on its test surface, and if after a sample fluid has flowed through the flow cell the sensor 50 indicates that the molecules of that sample fluid have become bound to said predefined ligands in the flow cell, this indicates that the molecules of that sample fluid has the potential to bind to equivalent ligands found in the human body; in other words the sample fluid is thus identified as being a drug candidate which can bind to equivalent ligands (drug targets) found within the human body. If in addition several different concentrations of the drug candidate are flown through the flow cell, the time-resolved signal of the sensor 50 allows characterization of the binding, such as the determination of affinity and the kinetic on-rate and off-rate.

In a typical detection or concentration measurement application, molecules of a sample fluid bind to predefined ligands; therefore if a flow cell has a predefined ligand on its test surface, if after a sample fluid has flowed through the flow cell the sensor 50 indicates that the molecules of that sample fluid have become bound to said ligands, this indicates that the sample fluid contained molecules which can bind to the predefined ligands and can thus be used to bind to ligands within the human body, which are equivalent to said predefined ligands. In this way the presence (or absence) of molecules in a sample fluid which can bind to predefined ligands can be determined. Furthermore, the signal or time-resolved signal of the sensor 50 may allow to determine the concentration of the molecules in a sample fluid. It should be understood that in the present application, if a fluid is said to flow through a flow cell, this means that said fluid has flowed over the test surface of said flow cell.

In this embodiment there is provided a single pumping means 12. The single pumping means 12 can be selectively configured to provide positive pressure (e.g. positive fluid pressure) or negative pressure (e.g. negative fluid pressure). The single pumping means 12 may have any suitable configuration. In this example, the single pumping means 12 comprises a syringe 12a, a switching valve 12b, a buffer reservoir 12c which contains a buffer fluid, a waste reservoir 12d and an output 12e. Preferably, before providing positive pressure, the single pumping means 12 is typically primed by configuring the switching valve 12b to fluidly connect the syringe 12a to the waste reservoir 12d, so as to allow buffer fluid to pass from the syringe 12a to the waste reservoir 12d; then the buffer fluid contents of the syringe 12a are dispensed into the waste reservoir 12d. Then the switching valve 12b is configured to fluidly connect the syringe 12a to the buffer reservoir 12c, so as to allow buffer fluid to pass from the buffer reservoir 12c to the syringe 12a. The syringe 12a is then filled with buffer fluid from the buffer reservoir 12c by aspirating buffer fluid from the buffer reservoir 12c. In order to provide positive pressure, the switching valve 12b is configured to fluidly connect the syringe 12a to the output 12e; the buffer fluid contained in the syringe 12a is then dispensed from the syringe; the dispense buffer fluid creates the positive pressure. Similarly, preferably, before providing negative pressure, the syringe 12a is typically at least partially emptied (and most preferably is fully emptied); the switching valve 12b is configured to fluidly connect the syringe 12a to the waste reservoir 12d so as to allow fluid to pass from the syringe 12a to the waste reservoir 12d; the fluid contents of the syringe 12a is then at least partially emptied into the waste reservoir 12d. In order to provide negative pressure, the switching valve 12b is configured to fluidly connect the syringe 12a to the output 12e; then fluid 12e present in the output is aspirated into the syringe; aspirating fluid from the output 12e into the syringe 12a creates the negative pressure.

The first selector valve unit 4 has a single input 4′ which is fluidly connected to the single pumping means 12 (specifically to the output 12e of the single pumping mean 12), and n outputs 4a-h. As mentioned in this example n is equal to eight therefore the first selector valve unit 4 has eight outputs 4a-h (namely a first output 4a, second output 4b, third output 4c, fourth output 4d, fifth output 4e, sixth output 4f, seventh output 4g, eighth output 4h). Most preferably the number of outputs 4a-h which the first selector valve unit 4 has corresponds to the number of hollow needles in the needle unit 2.

The first selector valve unit 4 is configured such that it can selectively fluidly connect its single input 4′ with any one or more of its n outputs 4a-h; accordingly the first selector valve unit 4 is configured such that it can selectively fluidly connect the single pumping means 12 (which is fluidly connected to the single input 4′ of the first selector valve unit 4) with any one or more n outputs 4a-h of the first selector valve unit 4. Specifically in this embodiment the first selector valve unit 4 can be selectively configured into any one of n+1 different configurations (wherein n is the number of hollow needles 2a-h in the needle unit 2): when the first selector valve unit 4 is in a first configuration the single input 4′ is fluidly connected to the first output 4a only; when the first selector valve unit 4 is in a second configuration the single input 4′ is fluidly connected to the second output 4b only; when the first selector valve unit 4 is in a third configuration the single input 4′ is fluidly connected to the third output 4c only; when the first selector valve unit 4 is in a fourth configuration the single input 4′ is fluidly connected to the fourth output 4d only; when the first selector valve unit 4 is in a fifth configuration the single input 4′ is fluidly connected to the fifth output 4e only; when the first selector valve unit 4 is in a sixth configuration the single input 4′ is fluidly connected to the sixth output 4f only; when the first selector valve unit 4 is in a seventh configuration the single input 4′ is fluidly connected to the seventh output 4g only; when the first selector valve unit 4 is in an eighth configuration the single input 4′ is fluidly connected to the eighth output 4h only; when the first selector valve unit 4 is in a ninth configuration the single input 4′ is simultaneously fluidly connected to all of the first, second, third, fourth, fifth, sixth, seventh, and eighth outputs 4a-h.

It should be understood that the first selector valve unit 4 is not an essential feature of the invention. However in this embodiment the first selector valve unit 4 advantageously allows to minimize the number of pumping means 12 required in the assembly 101. Specifically, in this embodiment the first selector valve unit 4 advantageously allows to use only one single pumping means 12 only in order to aspirate sample fluid(s) into the hollow needles 2a-h of the needle unit 2.

The switching valve unit 7 has a first set 107′ of inputs comprising n inputs 7a′-7h′ which are fluidly connected to respective n hollow needles 2a-h, and a second set 107″ of inputs comprising n inputs 7a″-7h″ which are fluidly connected to respective n outputs 4a-h of the first selector valve unit 4, and a set of outputs 107′″ comprising n outputs 7a″′-7h″′.

A first input 7a′ of the first set 107′ is fluidly connected to a first hollow needle 2a of the needle unit 2; a second input 7b′ of the first set 107′ is fluidly connected to a second hollow needle 2b of the needle unit 2; a third input 7c′ of the first set 107′ is fluidly connected to a third hollow needle 2c of the needle unit 2; a fourth input 7d′ of the first set 107′ is fluidly connected to a fourth hollow needle 2d of the needle unit 2; a fifth input 7e′ of the first set 107′ is fluidly connected to a fifth hollow needle 2e of the needle unit 2; a sixth input 7f′ of the first set 107′ is fluidly connected to a sixth hollow needle 2f of the needle unit 2; a seventh input 7g′ of the first set 107′ is fluidly connected to a seventh hollow needle 2g of the needle unit 2; an eighth input 7h′ of the first set 107′ is fluidly connected to an eighth hollow needle 2h of the needle unit 2.

In this example each respective output 4a-h of the first selector valve unit 4 is fluidly connected to a respective input 7a″-7h″ of the second set 107″ of inputs of the switching valve unit 7, via a respective conduit (8a-8h), referred to hear after as buffer conduits (8a-8h). Specifically, in this example the assembly 101 comprises: a first buffer conduit 8a which fluidly connects the first output 4a of the first selector valve unit 4 to a first input 7a″ of the second set 107″ of inputs of the switching valve unit 7; a second buffer conduit 8b which fluidly connects the second output 4b of the first selector valve unit 4 to a second input 7b″ of the second set 107″ of inputs of the switching valve unit 7; a third buffer conduit 8c which fluidly connects the third output 4c of the first selector valve unit 4 to a third input 7c″ of the second set 107″ of inputs of the switching valve unit 7; a fourth buffer conduit 8d which fluidly connects the fourth output 4d of the first selector valve unit 4 to a fourth input 7d″ of the second set 107″ of inputs of the switching valve unit 7; a fifth buffer conduit 8e which fluidly connects the fifth output 4e of the first selector valve unit 4 to a fifth input 7e″ of the second set 107″ of inputs of the switching valve unit 7; a sixth buffer conduit 8f which fluidly connects the sixth output 4f of the first selector valve unit 4 to a sixth input 7f″ of the second set 107″ of inputs of the switching valve unit 7; a seventh buffer conduit 8g which fluidly connects the seventh output 4g of the first selector valve unit 4 to a seventh input 7g″ of the second set 107″ of inputs of the switching valve unit 7; and an eighth buffer conduit 8h which fluidly connects an eighth output 4h of the first selector valve unit 4 to an eighth input 7h″ of the second set 107″ of inputs of the switching valve unit 7.

The switching valve unit 7 can be selectively arranged in a first configuration or a second configuration, wherein in said first configuration the switching valve unit 7 fluidly connects the n inputs 7a′-7h′ of the first set 107′ of inputs with said n inputs 7a″-7h″ of the second set 107″ of inputs, and in said second configuration the switching valve unit 7 blocks the flow of fluid between the n inputs 7a′-7h′ of the first set 107′ of inputs and said n inputs 7a″-7h″ of the second set 107″ of inputs.

In this exemplary embodiment each of said n outputs 7a″′-7h′″ of said switching valve unit 7 is fluidly connected to a single conduit 5′. Specifically each of said n outputs 7a″′-7h′″ of said switching valve unit 7 is fluidly connected to a single conduit 5′ via a respective conduit 9a-h (referred to hereafter as a respective injection conduits 9a-h). Specifically a first injection conduit 9a fluidly connects a first output 7a′″ of the switching valve unit 7 to the single conduit 5′; a second injection conduit 9b fluidly connects a second output 7b′″ of the switching valve unit 7 to the single conduit 5′; a third injection conduit 9c fluidly connects a third output 7c′″ of the switching valve unit 7 to the single conduit 5′; a fourth injection conduit 9d fluidly connects a fourth output 7d′″ of the switching valve unit 7 to the single conduit 5′; a fifth injection conduit 9e fluidly connects a fifth output 7e′″ of the switching valve unit 7 to the single conduit 5′; a sixth injection conduit 9f fluidly connects a sixth output 7f′″ of the switching valve unit 7 to the single conduit 5′; a seventh injection conduit 9g fluidly connects a seventh output 7g′″ of the switching valve unit 7 to the single conduit 5′; and an eighth injection conduit 9h fluidly connects an eighth output 7h′″ of the switching valve unit 7 to the single conduit 5′.

Each of the respective injection conduits 9a-h may be connected to the single conduit 5′ using any suitable means; for example each of the respective injection conduits 9a-h can be connected to the single conduit 5′ by means of a valveless junction such as a simple T-junction, or the injection conduits 9a-h can be connected to the single conduit 5′ by means of a star junction; or each of the respective injection conduits 9a-h can be connected to the single conduit 5′ by means of a respective valve. In this example shown in FIG. 1, each of the respective injection conduits 9a-h are fluidly connected to the single conduit 5′ by means of a respective valveless T-junction 109a-h.

The single conduit 5′ is fluidly connected to the respective m inputs of said m flow cells 3a-d in said flow cell unit 3. Specifically the single conduit 5′ is fluidly connected to all of the inputs 3a′-3d′ of the flow cells 3a-d in the flow cell unit 3. Preferably the volume of the single conduit 5′, between any one of said valveless T-junctions 109a-h, and any one of said inputs 3a′-3d′ of the flow cells 3a-d is less than 10 microliters. Most preferably the volume of the single conduit 5′, between any one of said valveless T-junctions 109a-h, and any one of said inputs 3a′-3d′ of the flow cells 3a-d is less than 1 microliter.

It should be understood that it is not essential for the n outputs 7a″′-7h′″ of said switching valve unit 7 to be fluidly connected to a single conduit 5′; in an alternative embodiment, the assembly 101 does not comprise any single conduit 5′ any rather the n outputs 7a″′-7h′″ of said switching valve unit 7 to be fluidly connected to a single junction (such as a star junction). The single junction is fluidly connected to the respective m inputs of said m flow cells 3a-d in said flow cell unit 3.

The assembly 101 further comprises the following optional features: a second selector valve unit 6; a third selector valve unit 17; a first waste reservoir 23; a first valve 22; a second waste reservoir 24; a second pumping means 11.

Specifically, the first valve 22 is fluidly connected between said second waste reservoir 24 and a second junction 105, wherein said second junction 105 is located between where the n outputs of said switching valve unit are fluidly connected to said single conduit 5′ and the m inputs 3 of said m flow cells in said flow cell unit. In other words said second junction 105 is located between the valveless junctions 109a-h and the m inputs 3a′-3d′ of said m flow cells 3a-d in said flow cell unit 3. The first valve 22 can be selectively configured to be in an open configuration or closed configuration. When the first valve 22 is configured to be in an open configuration fluid can flow from the second junction 105 through the first valve 22 and into the second waste reservoir 24; when the first valve 22 is configured to be in an closed configuration the first valve 22 blocks the flow of fluid from the second junction 105 into the second waste reservoir 24. It should be understood that the first valve 22 may take any suitable form; for example the first valve 22 may comprise a solenoid valve or a rotary valve.

The second selector valve unit 6 is fluidly connected between respective m outputs 3a″-3d″ of the m flow cells 3a-d in said flow cell unit 3 and said first waste reservoir 23. The second selector valve unit 6 is configured to selectively fluidly connect one or more of said m outputs 3a″-3d″ of the m flow cells 3a-d with said first waste reservoir 23.

Specifically, the second selector valve unit 6 comprises m valves, each of the respective m valves is connected between a respective one of said m outputs 3a″-3d″ of the m flow cells 3a-d and the first waste reservoir 23. Most preferably the number of valves provided in the second selector valve unit 6 corresponds to the number of flow cells 3a-d in the flow cell unit 3. In this example since m is equal to four, the second selector valve unit 6 comprises a first valve 6a which has an input 6a′ and an output 6a″; a second valve 6b which has an input 6b′ and an output 6b″; a third valve 6c which has an input 6c′ and an output 6c″; and a fourth valve 6d which has an input 6d′ and an output 6d″. Most preferably each of said m valves is a solenoid valve. The input 6a′ of the first valve 6a is fluidly connected to the output 3a″ of the first flow cell 3a; specifically a first subsidiary conduit 19a fluidly connects the output 3a″ of the first flow cell 3a to the input 6a′ of the first valve 6a of the second selector valve unit 6. The input 6b′ of the second valve 6b is fluidly connected to the output 3b″ of the second flow cell 3b; specifically a second subsidiary conduit 19b fluidly connects the output 3b″ of the second flow cell 3b to the input 6b′ of the second valve 6b of the second selector valve unit 6. The input 6c′ of the third valve 6c is fluidly connected to the output 3c″ of the third flow cell 3c; specifically a third subsidiary conduit 19c fluidly connects the output 3c″ of the third flow cell 3c to the input 6c′ of the third valve 6c of the second selector valve unit 6. The input 6d′ of the fourth valve 17d is fluidly connected to the output 3d″ of the fourth flow cell 3d; specifically a fourth subsidiary conduit 19b fluidly connects the output 3d″ of the fourth flow cell 3d to the input 6d′ of the fourth valve 6d of the second selector valve unit 6.

The output 6a″ of the first valve 6a is fluidly connected to the first waste reservoir 23; the output 6b″ of the second valve 6b is fluidly connected to the first waste reservoir 23; the output 6c″ of the third valve 6c is fluidly connected to the first waste reservoir 23; the output 6d″ of the fourth valve 17d is fluidly connected to the first waste reservoir 23.

Optionally, the fluidic assembly 101 may further comprise a waste outlet 27 which fluidly connects the second selector valve unit 6 with the first waste reservoir 23. The waste outlet 27 may comprise one or more conduits which fluidly connects the second selector valve unit 6 with the first waste reservoir 23. In the assembly 101 the waste outlet 27 comprises a m conduits (wherein m is the number of flow cells 3a-d in the flow cell unit 3); the waste outlet 27 comprises a first, second, third and fourth conduit; a first end of the first conduit is connected to the output 6a″ of the first valve 6a, and the second opposite end of the first conduit is fluidly connected to the first waste reservoir 23; a first end of the second conduit is connected to the output 6b″ of the second valve 6b, and the second opposite end of the second conduit is fluidly connected to the first waste reservoir 23; a first end of the third conduit is connected to the output 6c″ of the third valve 6c, and the second opposite end of the third conduit is fluidly connected to the first waste reservoir 23; a first end of the fourth conduit is connected to the output 6d″ of the fourth valve 6d, and the second opposite end of the fourth conduit is fluidly connected to the first waste reservoir 23. It should be understood that the first waste reservoir may take any suitable form. For example the first waste reservoir 23 may comprise a bottle or other container adapted to receive waste liquid.

Accordingly, when the first valve 6a is opened it will fluidly connect the output 3a″ of the first flow cell 3a with the first waste reservoir 23, thereby allowing fluid which is flowing out of the first flow cell 3a to flow into the first waste reservoir 23; when the second valve 6b is opened it will fluidly connect the output 3b″ of the second flow cell 3b with the first waste reservoir 23, thereby allowing fluid which is flowing out of the second flow cell 3b to flow into the first waste reservoir 23; when the third valve 6c is opened it will fluidly connect the output 3c″ of the third flow cell 3c with the first waste reservoir 23, thereby allowing fluid which is flowing out of the third flow cell 3c to flow into the first waste reservoir 23; when the fourth valve 6d is opened it will fluidly connect the output 3d″ of the fourth flow cell 3d with the first waste reservoir 23, thereby allowing fluid which is flowing out of the fourth flow cell 3d to flow into the first waste reservoir 23. Each of the first, second, third and fourth valves 6a-d of the second selector valve unit 6 can be selectively opened or closed.

The second selector valve unit 6 is moveable between at least m+2 positions, where m is the number of flow cells 3a-d in the flow cell unit 3. Accordingly, in the embodiment the second selector valve unit 6 is moveable between at least six positions: When the second selector valve unit 6 is in a first position, the first valve 6a is opened and the second, third, fourth valves 6b-d are closed thereby fluidly connecting the output 3a″ of the first flow cell 3a only with the first waste reservoir 23; thus when the second selector valve 6 is in its first position fluid arriving at the flow cell unit 3 from the single conduit 5′, will flow through the first flow cell 3a only (not through the second, third or fourth flow cells 3b-d) and into the first waste reservoir 23. When the second selector valve unit 6 is in a second position, the second valve 6b is opened and the first, third, fourth valves 6a,c,d are closed thereby fluidly connecting the output 3b″ of the second flow cell 3b only with the first waste reservoir 23; thus when the second selector valve 6 is in its second position fluid arriving at the flow cell unit 3 from the single conduit 5′, will flow through the second flow cell 3b only (not through the first, third or fourth flow cells 3a,c,d) and into the first waste reservoir 23. When the second selector valve unit 6 is in a third position, the third valve 6c is opened and the first, second, and fourth valves 6a,b,d are closed thereby fluidly connecting the output 3c″ of the third flow cell 3c only with the first waste reservoir 23; thus when the second selector valve 6 is in its third position fluid arriving at the flow cell unit 3 from the single conduit 5′, will flow through the third flow cell 3c only (not through the first, second or fourth flow cells 3a,b,d) and into the first waste reservoir 23. When the second selector valve unit 6 is in a fourth position, the fourth valve 6c is opened and the first, second, and third valves 6a,b,c are closed thereby fluidly connecting the output 3d″ of the fourth flow cell 3d only with the first waste reservoir 23; thus when the second selector valve 6 is in its fourth position fluid arriving at the flow cell unit 3 from the single conduit 5′, will flow through the fourth flow cell 3d only (not through the first, second or third flow cells 3a,b,c) and into the first waste reservoir 23. When the second selector valve unit 6 is in a fifth position, all of the first, second, third and fourth valves 6a-d are opened thereby fluidly connecting all of the outputs 3a″-3d″ of all of the flow cells 3a-d in the flow cell unit 3 with the first waste reservoir 23; thus fluid arriving at the flow cell unit 3 from the single conduit 5′, will flow through all of the flow cell 3a-d and into the first waste reservoir 23. Finally, when the second selector valve unit 6 is in a sixth position, all of the first, second, third and fourth valves 6a-d are closed; thus when the second selector valve unit 6 is in its sixth position fluid arriving at the flow cell unit 3 from the single conduit 5′, will not flow through any of the flow cells 3a-d.

In a variation of this embodiment instead of a second selector valve unit 6 comprising m solenoid valves 6a-d, the second selector valve unit 6 comprises a rotary valve which can be arranged in at least five configurations: a first configuration wherein the second selector valve unit 6 fluidly connects the output 3a″ of the first flow cell 3a only with the first waste reservoir 23; a second configuration wherein the second selector valve unit 6 fluidly connects the output 3b″ of the second flow cell 3b only with the first waste reservoir 23; a third configuration wherein the second selector valve unit 6 fluidly connects the output 3c″ of the third flow cell 3c only with the first waste reservoir 23; a fourth configuration wherein the second selector valve unit 6 fluidly connects the output 3d″ of the fourth flow cell 3a only with the first waste reservoir 23; and a fifth configuration wherein the second selector valve unit 6 fluidly connects the all of the outputs 3a″-d″ of all of the flow cells 3a-d in the flow cell unit 3 with the first waste reservoir 23.

The second pumping means 11 can be selectively configured to provide positive pressure (e.g. positive fluid pressure) or negative pressure (e.g. negative fluid pressure). The second pumping means 11 may have any suitable configuration. In this example, the second pumping means 11 comprises a syringe 11a, a switching valve 11b, a buffer reservoir 11c which contains a buffer fluid, a waste reservoir 11d and an output 11e. Preferably, before providing positive pressure, the second pumping means 11 is typically primed by configuring the switching valve 11b to fluidly connect the syringe 11a to the waste reservoir 11d, so as to allow buffer fluid to pass from the syringe 11a to the waste reservoir 11d; then the buffer fluid contents of the syringe 11a are dispensed into the waste reservoir 11d. Then the switching valve 11b is configured to fluidly connect the syringe 11a to the buffer reservoir 11c, so as to allow buffer fluid to pass from the buffer reservoir 11c to the syringe 11a. The syringe 11a is then filled with buffer fluid from the buffer reservoir 11c by aspirating buffer fluid from the buffer reservoir 11c. In order to provide positive pressure, the switching valve 11b is configured to fluidly connect the syringe 11a to the output 11e; the buffer fluid contained in the syringe 11a is then dispensed from the syringe; the dispense buffer fluid creates the positive pressure. Similarly, preferably, before providing negative pressure, the syringe 11a is typically at least partially emptied (and most preferably is fully emptied); the switching valve 11b is configured to fluidly connect the syringe 11a to the waste reservoir 11d so as to allow buffer fluid to pass from the syringe 11a to the waste reservoir 11d; the buffer fluid contents of the syringe 11a is then at least partially emptied into the waste reservoir 11d. In order to provide negative pressure, the switching valve 11b is configured to fluidly connect the syringe 11a to the output 11e; then fluid present in the output 11e is aspirated into the syringe; aspirating fluid from the output 11e into the syringe 11a creates the negative pressure.

The third selector valve unit 17 is arranged between the second pumping means 11 and respective m outputs 3a″-3d″ of the m flow cells 3a-d. The third selector valve unit 17 is configured to selectively fluidly connect the second pumping means 11 (specifically the output 11e of the second pumping means 11) with one or more of said m outputs 3a″-3d″ of the m flow cells 3a-d. Specifically, the third selector valve unit 17 comprises at least m valves (wherein m is the number of flow cells 3a-d in the flow cell unit 3), each of the respective m valve is connected between a respective one of said m outputs 3a″-3d″ of the m flow cells 3a-d and the second pumping means 11. Most preferably the number of valves provided in the third selector valve unit 17 corresponds to the number of flow cells 3a-d in the flow cell unit 3. In this example since m is equal to four, the third selector valve unit 17 comprises a first valve 17a which has an input 17a′ and an output 17a″; a second valve 17b which has an input 17b′ and an output 17b″; a third valve 17c which has an input 17c′ and an output 17c″; and a fourth valve 17d which has an input 17d′ and an output 17d″. In this example the first, second, third, and fourth valves 17a-d are each defined by a respective switching valve; for example the first, second, third, and fourth valves 17a-d may each be a respective solenoid valve; however it should be understood that the valves 17a-d may take any suitable form.

Conduits 16a-d (referred to hereafter as buffer inlet conduits 16a-d) fluidly connect the respective outputs 17a″-17d″ of the first, second, third and fourth, valves 17a-d to the respective subsidiary conduits 19a-d; specifically a first buffer inlet conduit 16a fluidly connects the output 17a″ of the first valve 17a to the first subsidiary conduit 19a (which is fluidly connected to the output 3a″ of the first flow cell 3a); a second buffer inlet conduit 16b fluidly connects the output 17b″ of the second valve 17b to the second subsidiary conduit 19b (which is fluidly connected to the output 3b″ of the second flow cell 3b); a third buffer inlet conduit 16c fluidly connects the output 17c″ of the third valve 17c to the third subsidiary conduit 19c (which is fluidly connected to the output 3c″ of the third flow cell 3c); a fourth buffer inlet conduit 16d fluidly connects the output 17d″ of the fourth valve 17d to the fourth subsidiary conduit 19d (which is fluidly connected to the output 3d″ of the fourth flow cell 3d). In this embodiment the first, second, third and fourth buffer inlet conduits 16a-d are connected to the respective first, second, third and fourth subsidiary conduit 19a-d at a respective junction 16a′-16d′; in this example each of said junctions 16a′-16d′ is a valveless junction 16a′-16d′ (and more specifically is a valveless T-junction); however it should be understood that the respective junctions 16a′-16d′ may take any suitable form, for example the respective junctions 16a′-16d′ may each comprise a valve.

It should be understood that in a variation of this embodiment the first, second, third and fourth buffer inlet conduits 16a-d could, instead, be arranged to connect the respective outputs 17a″-d″ of the respective valves 17a-d directly to the respective outputs 3a″-d″ of the respective flow cells 3a-d. In other words one end of the first inlet conduit 16a could be connect to the output 17a″ of the first valve 17a and the opposite end of the first inlet conduit 16a could be directly connected to the output 3a″ of the first flow cell 3a; one end of the second inlet conduit 16d could be connect to the output 17b″ of the second valve 17b and the opposite end of the second inlet conduit 16d could be directly connected to the output 3b″ of the second flow cell 3b; one end of the third inlet conduit 16c could be connect to the output 17c″ of the third valve 17c and the opposite end of the third inlet conduit 16c could be directly connected to the output 3c″ of the third flow cell 3c; one end of the fourth inlet conduit 16d could be connect to the output 17d″ of the fourth valve 17d and the opposite end of the fourth inlet conduit 16d could be directly connected to the output 3d″ of the first flow cell 3d.

Referring back to the assembly 101 shown in FIG. 1, the input 17a′ of the first valve 17a is fluidly connected to the second pumping means 11 and the output 17a″ of the first valve 17a is fluidly connected to the output 3a″ of the first flow cell 3a; the input 17b′ of the second valve 17b is fluidly connected to the second pumping means 11 and the output 17b″ of the second valve 17b is fluidly connected to the output 3b″ of the second flow cell 3b; the input 17c′ of the third valve 17c is fluidly connected to the second pumping means 11 and the output 17c″ of the third valve 17c is fluidly connected to the output 3c″ of the third flow cell 3c; the input 17d′ of the fourth valve 17d is fluidly connected to the second pumping means 11 and the output 17d″ of the fourth valve 17d is fluidly connected to the output 3d″ of the fourth flow cell 3d.

The third selector valve unit 17 is configured such that it can be selectively arranged in at least m+1 configuration, where m is the number of flow cells 3a-d within the flow cell unit 3. Therefore, in the assembly 101 the third selector valve unit 17 is configured such that it can be selectively arranged into at least five configurations. When the third selector valve unit 17 is in a first configuration, the first valve 17a is opened and the second, third, and fourth valves 17b-d are closed; thus when the third selector valve unit 17 is in its first configuration the second pumping means 11 is fluidly connected to the first flow cell 3a only. When the third selector valve unit 17 is in a second configuration, the second valve 17d is opened and the first, third, and fourth valves 17a,c,d are closed; thus when the third selector valve unit 17 is in its second configuration the second pumping means 11 is fluidly connected to the second flow cell 3a only. When the third selector valve unit 17 is in a third configuration, the third valve 17c is opened and the first, second, and fourth valves 17a,b,d are closed; thus when the third selector valve unit 17 is in its third configuration the second pumping means 11 is fluidly connected to the third flow cell 3c only. When the third selector valve unit 17 is in a fourth configuration, the fourth valve 17d is opened and the first, second, and third valves 17a,b,c are closed; thus when the third selector valve unit 17 is in its fourth configuration the second pumping means 11 is fluidly connected to the fourth flow cell 3d only. When the third selector valve unit 17 is in a fifth configuration, the all of the first, second, third and fourth valves 17a-d are opened; thus when the third selector valve unit 17 is in its fifth configuration the second pumping means 11 is fluidly connected to all of the flow cells 3a-d.

In a further variation of this embodiment the third selector valve unit 17, instead of providing first, second, third and fourth switching valves 17a-d, the third selector valve unit 17 may comprise a rotary valve with customized stator and rotor layout for achieving the same fluid connections as those achieved by the above-mentioned five configurations.

The assembly 101 further comprises the following optional features: a moveable stage 2′; a sample holder tray 1; and a wash station 28.

The sample holder tray 1 comprises a plurality of reservoirs 1′, each of which can hold a fluid. In this example the sample holder tray 1 comprises a series of rows of reservoirs 1′; each row comprises n reservoirs 1′. In other words the number of reservoirs 1′ in a row correspond to the number of hollow needles 2a-h in the needle unit 2. Accordingly, each row comprises eight reservoirs 1a-h. Each reservoir 1a-d of each row is configured (in particular is dimensioned) such that each of hollow needles 2a-h in the needle unit 2 can be inserted into the a respective reservoir 1a-h in a row, so that fluid in each respective reservoir 1a-h in a row can be aspirated into a respective hollow needles 2a-h of the needle unit 2.

The wash station 28 is configured to such that it can wash the hollow needles 2a-h of the needle unit 2. The wash station 28 may comprise any suitable configuration. Suitable constructions of wash stations are also known in the art. The wash station 28 may comprise m wells each comprising drains for removing excess liquid which is contained in the hollow needles 2a-h; and/or may comprise inputs means which can provide clearing liquids into said hollow needles 2a-h. Optionally, the wash station 28 may comprise several sections, such as a first section for washing the hollow needles 2a-h with a cleaning liquid such as a detergent, and a second section for rinsing hollow needles 2a-h with a buffer.

The moveable stage 2′ is operable selectively move the needle unit 2 between a first position wherein the needle unit 2 is arranged over the sample holder tray 1 so that each of hollow needles 2a-h in the needle unit 2 can be inserted into the a respective reservoir 1a-h in a row, so that fluid in each respective reservoir 1a-h in a row can be aspirated into a respective hollow needles 2a-h of the needle unit 2; and a second position, where the needle unit 2 is located at the wash station 28 where the needles 2a-h can be washed. The moveable stage 2′ may have any suitable configuration. For example the moveable stage 2′ may be defined by a robotic arm which can hold and can move the needle unit 2 between said first and second positions; and/or the moveable stage 2′ may be defined by xyz table on which the needle unit 2 is mounted and which can move the needle unit 2 between said first and second positions. In the above example the sample holder tray 1 and wash station 28 have a fixed position and the needle unit 2 is moved (by the moveably stage 2′) with respect to the sample holder tray 1 and wash station 28; in a variation of this embodiment the needle unit 2 has a fixed position, and the sample holder tray 1 and wash station 28 are moved with respect to the needle unit 2.

It is understood that in the assembly 101 each of the conduits in the assembly 101 may comprise tubing, such as PEEK or PFA or stainless steel tubings. For example the buffer conduits 8a-8h may each comprise tubing with an internal volume between 10 microliters and 1000 microliters.

The assembly 101 can be used to perform a method of screening a plurality of sample fluids to identify if any one or more of said sample fluids contain molecules which can bind to predefined ligands (said predefined ligands being of the type provided on the test surfaces of one or more of the flow cells 3a-d) according to an embodiment of the present invention:

During use a sample holder tray 1 which comprises a plurality of reservoirs 1′ is provided; sample fluids are provided in at least some of the reservoirs 1′. In the example shown in FIG. 1, the sample holder tray 1 comprises a series of rows of reservoirs 1′; in at least one of the rows all of the reservoirs 1′ in that row are provided with sample fluids which are to undergo screening. Preferably in at least two of the rows all of the reservoirs 1′ in those two rows are provided with sample fluids which are to undergo screening. Most preferably sample fluids are provided in all of the reservoirs 1′ of said sample holder tray 1.

Different sample fluids may be provided in each respective reservoir 1′; in other words the sample fluids provided in said different reservoirs 1′ may have different compositions (however this is not essential; it could be that some of the sample fluids in different reservoirs 1′ have the same composition). In this example the different sample fluids having different compositions are provided in said respective reservoirs 1′: In a first row of reservoirs, a first sample fluid is provided in a first reservoir 1a′ of that row; a second sample fluid is provided in a second reservoir 1b′ of said row; a third sample fluid is provided in a third reservoir 1c′ of said row; a fourth sample fluid is provided in a fourth reservoir 1d′ of said row; a fifth sample fluid is provided in a fifth reservoir 1e′ of said row; a sixth sample fluid is provided in a sixth reservoir 1f′ of said row; a seventh sample fluid is provided in a seventh reservoir 1g′ of said row; an eighth sample fluid is provided in an eighth reservoir 1h′ of said row.

The needle unit 2 is then arranged so that each of the respective n hollow needles 2 is simultaneously inserted into a respective reservoir 1a-h; specifically the needle unit 2 is arranged so that, the first hollow needle 2a is inserted into said first reservoir 1a′, the second hollow needle 2b is inserted into said second reservoir 1b′, the third hollow needle 2c is inserted into said third reservoir 1c′, the fourth hollow needle 2d is inserted into said fourth reservoir 1d′, the fifth hollow needle 2e is inserted into said fifth reservoir 1e′, the sixth hollow needle 2f is inserted into said sixth reservoir 1f, the seventh hollow needle 2g is inserted into said seventh reservoir 1g′, the eighth hollow needle 2h is inserted into said eighth reservoir 1h′. At least the tip of each hollow needle 2a-h is submerged in the respective sample fluids contained in the respective reservoirs 1a′-h′. It should be noted that the moveable stage 2′ may move the needle unit 2 into a position wherein each of the respective n hollow needles 2 are simultaneously inserted into a respective reservoir 1a-h.

Preferably the second selector valve unit 6 is then moved into its sixth position wherein all of the first, second, third and fourth valves 6a-d of the second selector valve unit 6 are closed. The second valve 22 is also configured to be closed, so that the first valve 22 can block the flow of fluid from the second junction 105 into the second waste reservoir 24. When the second selector valve unit 6 is in its sixth position and the second valve 22 is closed, the flow of fluids along the n injection conduits 9a-h is restricted; accordingly fluids flowing from the hollow needles 2a-h into the n inputs 7a′-7h′ of the first set 107′ of inputs of the switching valve unit 7, will flow into the respective buffer conduits 8a-h via the n inputs 7a″-7h″ of the second set 107″ of inputs of the switching valve unit 7.

The switching valve unit 7 is arranged in its first configuration (if the switching valve unit 7 is not already arranged in its first configuration) so that the switching valve unit 7 simultaneously fluidly connects each of the n inputs 7a′-7h′ of the first set 107′ of inputs with a respective n output 7a″′-7h′″ (specifically the switching valve unit 7 simultaneously fluidly connects all of the first, second, third, fourth, fifth, sixth, seventh and eight inputs 7a′-7h′ of the first set 107′ of inputs with the respective first, second, third, fourth, fifth, sixth, seventh and eighth outputs 7a″′-7h′″).

The first selector valve unit 4 is then arranged into its ninth configuration, such that the first selector valve unit 4 fluidly connect its single input 4′ with all of its n outputs; specifically the first selector valve unit 4 is arranged so that all of its first, second, third, fourth, fifth, sixth, seventh and eighth outputs 4a-h are simultaneously fluidly connected to the single input 4′. When the first selector valve unit 4 is in its ninth configuration, the single pumping means 12 is simultaneously fluidly connected to each of said first, second, third, fourth, fifth, sixth, seventh and eighth outputs 4a-h of the first selector valve unit 4.

The single pumping means 12 is then configured to provide a negative pressure (e.g. negative fluid pressure) so that the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7. In this example the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7, and out of the switching valve unit 7 via the n inputs 7a″-7h″ of the second set 107″ of inputs of the switching valve unit 7, into the respective buffer conduits 8a-h.

Specifically, the first sample fluid present in the first reservoir 1a is aspirated into the first hollow needle 2a of said needle unit 2, and from there the negative pressure forces the first immobilization reagent to flow through the first hollow needle 2a, through the switching valve unit 7, and into the first buffer conduit 8a; the second sample fluid present in the second reservoir 1b is aspirated into the second hollow needle 2b and from there the negative pressure forces the second sample fluid to flow through the second hollow needle 2b, through the switching valve unit 7, and into the second buffer conduit 8b; the third sample fluid present in the third reservoir 1c is aspirated into the third hollow needle 2c and from there the negative pressure forces the third sample fluid to flow through the third hollow needle 2c, through the switching valve unit 7, and into the third buffer conduit 8c; the fourth sample fluid present in the fourth reservoir 1d is aspirated into the fourth hollow needle 2d and from there the negative pressure forces the fourth sample fluid to flow through the fourth hollow needle 2d, through the switching valve unit 7, and into the fourth buffer conduit 8d; the fifth sample fluid present in the fifth reservoir 1e is aspirated into the fifth hollow needle 2e and from there the negative pressure forces the fifth sample fluid to flow through the fifth hollow needle 2e, through the switching valve unit 7, and into the fifth buffer conduit 8e; the sixth sample fluid present in the sixth reservoir if is aspirated into the sixth hollow needle 2f and from there the negative pressure forces the sixth sample fluid to flow through the sixth hollow needle 2f, through the switching valve unit 7, and into the sixth buffer conduit 8f; the seventh sample fluid present in the seventh reservoir 1g is aspirated into the seventh needle 2g, and from there the negative pressure forces the seventh sample fluid to flow through the seventh hollow needle 2g, through the switching valve unit 7, and into the seventh buffer conduit 8g; the eighth sample fluid present in the eighth reservoir 1h′ is aspirated into the eighth hollow needle 2h and from there the negative pressure forces the eighth sample fluid to flow through the eighth hollow needle 2h, through the switching valve unit 7, and into the eighth buffer conduit 8h.

Accordingly after this step has been performed the first, second, third, fourth, fifth, sixth, seventh, and eighth sample fluids are present in the respective first, second, third, fourth, fifth, sixth, seventh, and eighth buffer conduits 8a-f.

The switching valve unit 7 then arranged in its second configuration so that the switching valve unit 7 blocks the flow of fluid between said n inputs 7a′-7h′ of the first set 107′ of inputs and the n outputs 7a″′-7h″′. In this second configuration the switching valve unit 7 prevents fluid, which is present at any of the n outputs 7a″′-7h′″ or which is present in any of the n buffer conduits 8a-f, from flowing back into the hollow needles 2a-h.

The first selector valve unit 4 it then arranged into its first configuration, so that the first selector valve unit 4 fluidly connect its single input 4′ with the first output 4a only of the first selector valve unit 4. When the first selector valve unit 4 is in its first configuration, the single pumping means 12 is fluidly connected to said first output 4a only of the first selector valve unit 4.

Preferably the second selector valve unit 6 is also moved into its fifth position, so that all of the first, second, third and fourth valves 6a-d of the second selector valve unit 6 are opened, thereby fluidly connecting all of the outputs 3a″-3d″ of all of the flow cells 3a-d in the flow cell unit 3 with the first waste reservoir 23.

The single pumping means 12 is then configured to provide a positive pressure; the positive pressure forces the first sample fluid present in the first buffer conduit 8a, to flow through all of the m flow cells 3a-d. Specifically the positive pressure provided by the single pumping means 12 flows through the single input 4′ of the first selector valve unit 4, and then into the first output 4a first selector valve unit 4, and from the first output 4a of the first selector valve unit 4 into the first buffer conduit 8a where the positive pressure pushes the first sample fluid along the first buffer conduit 8a, into the first input 7a″ of the second set 107″ of inputs of the switching valve unit 7, and then into the first injection conduit 9a via the first output 7a′″ of the switching valve unit 7, along the first injection conduit 9a, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the first sample fluid will contact the test surfaces of each of the first, second, third and fourth flow cells 3a-d; and more specifically will contact ligands which are present on said respective test surfaces. If the first sample fluid contains molecules which can bind to the ligands which are on the test surfaces of any the first, second, third and fourth flow cells 3a-d, these molecules will become bound to those ligands when the first sample fluid flows through that flow cell.

Most preferably the assembly 101 further comprises a sensor 50 which can detect if molecules of a sample fluid have become bound to ligands on the test surfaces of a flow cell. As the first sample fluid flows through the first, second, third and fourth flow cells 3a-d, this sensor 50 is operated to detect if molecules of the first sample fluid have become bound to ligands on the test surfaces of any of the first, second, third or fourth flow cells 3a-d.

The first sample fluid will flow out of the respective first, second, third and fourth flow cells 3a-d, via the respective outputs 3a″-3d″ of the respective flow cells 3a-d. The first sample fluid which flows out of the first flow cell 3a will flow through the first valve 6a of the second selector valve unit 6, and into the first waste reservoir 23; the first sample fluid which flows out of the second flow cell 3b will flow through the second valve 6b of the second selector valve unit 6, and into the first waste reservoir 23; the first sample fluid which flows out of the third flow cell 3c will flow through the third valve 6c of the second selector valve unit 6, and into the first waste reservoir 23; the first sample fluid which flows out of the fourth flow cell 3d will flow through the fourth valve 6d of the second selector valve unit 6, and into the first waste reservoir 23.

Optionally, the flow cells 3a-d in the flow cell unit 3 are then rinsed in a rinsing step: The second pumping means 11 may be selectively configured to dispense buffer fluid which can be used to rinse the flow cells 3a-d. In order to rinse the flow cells 3a-d the first pumping means 12 is configured so that it does not provide any positive or negative pressure (e.g. the first pumping means 12 is turned off); the second selector valve unit 6 is moved into its sixth position wherein all of the first, second, third and fourth valves 6a-d of the second selector valve unit 6 are closed; the first valve 22 is configured to be in its open configuration so that fluid can flow from the second junction 105 through the first valve 22 and into the second waste reservoir 24; the third selector valve unit 17 is arranged into it fifth configuration so that the second pumping means 11 is fluidly connected to all of the flow cells 3a-d. The second pumping means 11 is then operated to dispense buffer fluid. Specifically, the second pumping means 11 is typically first emptied by configuring the switching valve 11b to fluidly connect the syringe 11a to the waste reservoir 11d, and then dispensing the fluid contents of the syringe 11a into the waste reservoir 11d. Then the switching valve 11b is configured to fluidly connect the syringe 11a to the buffer reservoir 11c, so as to allow buffer fluid which is preset in the buffer reservoir 11c, to pass from the buffer reservoir 11c to the syringe 11a. The syringe 11a is then filled with buffer fluid from the buffer reservoir 11c by aspirating buffer fluid from the buffer reservoir 11c. The switching valve 11b is then configured to fluidly connect the syringe 11a to the output 11e; the buffer fluid contained in the syringe 11a is then dispensed from the syringe 11a.

The buffer fluid flows from the second pumping means 11, through all of the valves 17a-d of the third selector valve unit 17, along the buffer inlet conduits 16a, 16b, 16c, 16d, and into all of the flow cells 3a-d in the flow cell unit 3 via the subsidiary conduits 19a, 19b, 19c, 19d. Since the second selector valve unit 6 is in its sixth position the buffer fluid will be prevented from flowing along the subsidiary conduits 19a, 19b, 19c, 19d and into the first waste reservoir 23, thus the buffer fluid is forced to flow along the subsidiary conduits 19a, 19b, 19c, 19d to the flow cells 3a-d. When the buffer fluid flows through the flow cells 3a-d it will rinse the flow cells 3a-d. The buffer fluid flows through the flow cells 3a-d and along the single conduit 5′, through the second junction 105, through the first valve 22 (which is opened) and into the second waste reservoir 24. Preferably, the assembly is kept in this configuration for a predefined amount of time until the flow cells 3a-d have been rinsed for said predefined amount of time. Accordingly the second pumping means 11 is maintained in its configuration where it dispenses buffer fluid for said predefined amount of time. After said predefined amount of time has lapsed, the second pumping means 11 is configured to stop dispensing buffer fluid (e.g. the second pumping means 11 is turned off); and the first valve 22 is configured to be in its closed configuration so that it blocks the flow of fluid from the second junction 105 into the second waste reservoir 24.

The first selector valve unit 4 it then arranged into its second configuration, so that the first selector valve unit 4 fluidly connect its single input 4′ with the second output 4b only of the first selector valve unit 4. When the first selector valve unit 4 is in its second configuration, the single pumping means 12 is fluidly connected to said second output 4b only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the second sample fluid present in the second buffer conduit 8b, to flow through all of the m flow cells 3a-d. Specifically the positive pressure provided by the single pumping mean 12 flows through the single input 4′ of the first selector valve unit 4, and then into the second output 4b of the first selector valve unit 4, and from the second output 4b of the first selector valve unit 4 into the second buffer conduit 8b where the positive pressure pushes the second sample fluid along the second buffer conduit 8b, into the second input 7b″ of the second set 107″ of inputs of the switching valve unit 7, and then into the second injection conduit 9b via the second output 7b′″ of the switching valve unit 7, along the second injection conduit 9b, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the second sample fluid will contact the test surfaces of each of the first, second, third and fourth flow cells 3a-d; and more specifically will contact ligands which are present on said respective test surfaces. If the second sample fluid contains molecules which can bind to the ligands which are on the test surfaces of any the first, second, third and fourth flow cells 3a-d, these molecules will become bound to those ligands when the second sample fluid flows through that flow cell.

As the second sample fluid flows through the first, second, third and fourth flow cells 3a-d, this sensor 50 is operated to detect if molecules of the second sample fluid have become bound to ligands on the test surfaces of any of the first, second, third or fourth flow cells 3a-d.

The second sample fluid will flow out of the respective first, second, third and fourth flow cells 3a-d, via the respective outputs 3a″-3d″ of the respective flow cells 3a-d. The second sample fluid which flows out of the first flow cell 3a will flow through the first valve 6a of the second selector valve unit 6, and into the first waste reservoir 23; the second sample fluid which flows out of the second flow cell 3b will flow through the second valve 6b of the second selector valve unit 6, and into the first waste reservoir 23; the second sample fluid which flows out of the third flow cell 3c will flow through the third valve 6c of the second selector valve unit 6, and into the first waste reservoir 23; the second sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its third configuration, so that the first selector valve unit 4 fluidly connect its single input 4′ with the third output 4c only of the first selector valve unit 4. When the first selector valve unit 4 is in its third configuration, the single pumping means 12 is fluidly connected to said third output 4c only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the third sample fluid present in the third buffer conduit 8c, to flow through all of the m flow cells 3a-d. Specifically the positive pressure provided by the single pumping mean 12 flows through the single input 4′ of the first selector valve unit 4, and then into the third output 4c of the first selector valve unit 4, and from the third output 4c of the first selector valve unit 4 into the third buffer conduit 8c where the positive pressure pushes the third sample fluid along the third buffer conduit 8c, into the s third input 7c″ of the second set 107″ of inputs of the switching valve unit 7, and then into the third injection conduit 9c via the third output 7b′″ of the switching valve unit 7, along the third injection conduit 9c, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the third sample fluid will contact the test surfaces of each of the first, second, third and fourth flow cells 3a-d; and more specifically will contact ligands which are present on said respective test surfaces. If the third sample fluid contains molecules which can bind to the ligands which are on the test surfaces of any the first, second, third and fourth flow cells 3a-d, these molecules will become bound to those ligands when the third sample fluid flows through that flow cell.

As the third sample fluid flows through the first, second, third and fourth flow cells 3a-d, this sensor 50 is operated to detect if molecules of the third sample fluid have become bound to ligands on the test surfaces of any of the first, second, third or fourth flow cells 3a-d.

The third sample fluid will flow out of the respective first, second, third and fourth flow cells 3a-d, via the respective outputs 3a″-3d″ of the respective flow cells 3a-d. The third sample fluid which flows out of the first flow cell 3a will flow through the first valve 6a of the second selector valve unit 6, and into the first waste reservoir 23; the third sample fluid which flows out of the second flow cell 3b will flow through the second valve 6b of the second selector valve unit 6, and into the first waste reservoir 23; the third sample fluid which flows out of the third flow cell 3c will flow through the third valve 6c of the second selector valve unit 6, and into the first waste reservoir 23; the third sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its fourth configuration, so that the first selector valve unit 4 fluidly connects its single input 4′ with the fourth output 4d only of the first selector valve unit 4. When the first selector valve unit 4 is in its fourth configuration, the single pumping means 12 is fluidly connected to said fourth output 4d only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the fourth sample fluid present in the fourth buffer conduit 8d, to flow through all of the m flow cells 3a-d. Specifically the positive pressure provided by the single pumping mean 12 flows through the single input 4′ of the first selector valve unit 4, and then into the fourth output 4d of the first selector valve unit 4, and from the fourth output 4d of the first selector valve unit 4 into the fourth buffer conduit 8d where the positive pressure pushes the fourth sample fluid along the fourth buffer conduit 8d, into the fourth input 7d″ of the second set 107″ of inputs of the switching valve unit 7, and then into the fourth injection conduit 9d via the fourth output 7d′″ of the switching valve unit 7, along the fourth injection conduit 9d, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the fourth sample fluid will contact the test surfaces of each of the first, second, third and fourth flow cells 3a-d; and more specifically will contact ligands which are present on said respective test surfaces. If the fourth sample fluid contains molecules which can bind to the ligands which are on the test surfaces of any the first, second, third and fourth flow cells 3a-d, these molecules will become bound to those ligands when the fourth sample fluid flows through that flow cell.

As the fourth sample fluid flows through the first, second, third and fourth flow cells 3a-d, this sensor 50 is operated to detect if molecules of the fourth sample fluid have become bound to ligands on the test surfaces of any of the first, second, third or fourth flow cells 3a-d.

The fourth sample fluid will flow out of the respective first, second, third and fourth flow cells 3a-d, via the respective outputs 3a″-3d″ of the respective flow cells 3a-d. The fourth sample fluid which flows out of the first flow cell 3a will flow through the first valve 6a of the second selector valve unit 6, and into the first waste reservoir 23; the fourth sample fluid which flows out of the second flow cell 3b will flow through the second valve 6b of the second selector valve unit 6, and into the first waste reservoir 23; the fourth sample fluid which flows out of the third flow cell 3c will flow through the third valve 6c of the second selector valve unit 6, and into the first waste reservoir 23; the fourth sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its fifth configuration, so that the first selector valve unit 4 fluidly connect its single input 4′ with the fifth output 4e only of the first selector valve unit 4. When the first selector valve unit 4 is in its firth configuration, the single pumping means 12 is fluidly connected to said fifth output 4e only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the fifth sample fluid present in the fifth buffer conduit 8e, to flow through all of the m flow cells 3a-d. Specifically the positive pressure provided by the single pumping mean 12 flows through the single input 4′ of the first selector valve unit 4, and then into the fifth output 4e of the first selector valve unit 4, and from the fifth output 4e of the first selector valve unit 4 into the fifth buffer conduit 8e where the positive pressure pushes the fifth sample fluid along the fifth buffer conduit 8e, into the fifth input 7e″ of the second set 107″ of inputs of the switching valve unit 7, and then into the fifth injection conduit 9e via the fifth output 7e′″ of the switching valve unit 7, along the fifth injection conduit 9e, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the fifth sample fluid will contact the test surfaces of each of the first, second, third and fourth flow cells 3a-d; and more specifically will contact ligands which are present on said respective test surfaces. If the fifth sample fluid contains molecules which can bind to the ligands which are on the test surfaces of any the first, second, third and fourth flow cells 3a-d, these molecules will become bound to those ligands when the fifth sample fluid flows through that flow cell.

As the fifth sample fluid flows through the first, second, third and fourth flow cells 3a-d, this sensor 50 is operated to detect if molecules of the fifth sample fluid have become bound to ligands on the test surfaces of any of the first, second, third or fourth flow cells 3a-d.

The fifth sample fluid will flow out of the respective first, second, third and fourth flow cells 3a-d, via the respective outputs 3a″-3d″ of the respective flow cells 3a-d. The fifth sample fluid which flows out of the first flow cell 3a will flow through the first valve 6a of the second selector valve unit 6, and into the first waste reservoir 23; the fifth sample fluid which flows out of the second flow cell 3b will flow through the second valve 6b of the second selector valve unit 6, and into the first waste reservoir 23; the fifth sample fluid which flows out of the third flow cell 3c will flow through the third valve 6c of the second selector valve unit 6, and into the first waste reservoir 23; the fifth sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its sixth position, so that the first selector valve unit 4 fluidly connects its single input 4′ with the sixth output 4f only of the first selector valve unit 4. When the first selector valve unit 4 is in its sixth configuration, the single pumping means 12 is fluidly connected to said sixth output 4f only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the sixth sample fluid present in the sixth buffer conduit 8f, to flow through all of the m flow cells 3a-d. Specifically the positive pressure provided by the single pumping mean 12 flows through the single input 4′ of the first selector valve unit 4, and then into the sixth output 4f of the first selector valve unit 4, and from the sixth output 4f of the first selector valve unit 4 into the sixth buffer conduit 8f where the positive pressure pushes the sixth sample fluid along the sixth buffer conduit 8f, into the sixth input 7e″ of the second set 107″ of inputs of the switching valve unit 7, and then into the sixth injection conduit 9f via the sixth output 7f′″ of the switching valve unit 7, along the sixth injection conduit 9f, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the sixth sample fluid will contact the test surfaces of each of the first, second, third and fourth flow cells 3a-d; and more specifically will contact ligands which are present on said respective test surfaces. If the sixth sample fluid contains molecules which can bind to the ligands which are on the test surfaces of any the first, second, third and fourth flow cells 3a-d, these molecules will become bound to those ligands when the sixth sample fluid flows through that flow cell.

As the sixth sample fluid flows through the first, second, third and fourth flow cells 3a-d, this sensor 50 is operated to detect if molecules of the sixth sample fluid have become bound to ligands on the test surfaces of any of the first, second, third or fourth flow cells 3a-d.

The sixth sample fluid will flow out of the respective first, second, third and fourth flow cells 3a-d, via the respective outputs 3a″-3d″ of the respective flow cells 3a-d. The sixth sample fluid which flows out of the first flow cell 3a will flow through the first valve 6a of the second selector valve unit 6, and into the first waste reservoir 23; the sixth sample fluid which flows out of the second flow cell 3b will flow through the second valve 6b of the second selector valve unit 6, and into the first waste reservoir 23; the sixth sample fluid which flows out of the third flow cell 3c will flow through the third valve 6c of the second selector valve unit 6, and into the first waste reservoir 23; the sixth sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its seventh configuration, so that the first selector valve unit 4 fluidly connect its single input 4′ with the seventh output 4g of the first selector valve unit 4. When the first selector valve unit 4 is in its seventh configuration, the single pumping means 12 is fluidly connected to said seventh output 4g only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the seventh sample fluid present in the seventh buffer conduit 8g, to flow through all of the m flow cells 3a-d. Specifically the positive pressure provided by the single pumping mean 12 flows through the single input 4′ of the first selector valve unit 4, and then into the seventh output 4g of the first selector valve unit 4, and from the seventh output 4g of the first selector valve unit 4 into the seventh buffer conduit 8g where the positive pressure pushes the seventh sample fluid along the seventh buffer conduit 8g, into the seventh input 7g″ of the second set 107″ of inputs of the switching valve unit 7, and then into the seventh injection conduit 9g via the seventh output 7g′″ of the switching valve unit 7, along the seventh injection conduit 9g, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the seventh sample fluid will contact the test surfaces of each of the first, second, third and fourth flow cells 3a-d; and more specifically will contact ligands which are present on said respective test surfaces. If the seventh sample fluid contains molecules which can bind to the ligands which are on the test surfaces of any the first, second, third and fourth flow cells 3a-d, these molecules will become bound to those ligands when the seventh sample fluid flows through that flow cell.

As the seventh sample fluid flows through the first, second, third and fourth flow cells 3a-d, this sensor 50 is operated to detect if molecules of the seventh sample fluid have become bound to ligands on the test surfaces of any of the first, second, third or fourth flow cells 3a-d.

The seventh sample fluid will flow out of the respective first, second, third and fourth flow cells 3a-d, via the respective outputs 3a″-3d″ of the respective flow cells 3a-d. The seventh sample fluid which flows out of the first flow cell 3a will flow through the first valve 6a of the second selector valve unit 6, and into the first waste reservoir 23; the seventh sample fluid which flows out of the second flow cell 3b will flow through the second valve 6b of the second selector valve unit 6, and into the first waste reservoir 23; the seventh sample fluid which flows out of the third flow cell 3c will flow through the third valve 6c of the second selector valve unit 6, and into the first waste reservoir 23; the seventh sample fluid which flows out of the fourth flow cell 3d will flow through the fourth valve 6d of the second selector valve unit 6, and into the first waste reservoir 23.

Optionally, the above-mentioned rinsing step is performed again.

The first selector valve unit 4 it then arranged into its eighth configuration, so that first selector valve unit 4 fluidly connect its single input 4′ with the eighth output 4h only of the first selector valve unit 4. When the first selector valve unit 4 is in its eighth configuration, the single pumping means 12 is fluidly connected to said eighth output 4h only of the first selector valve unit 4. (The switching valve unit 7 is maintained in its second configuration, and the second selector valve unit 6 is maintained in its fifth position).

The single pumping means 12 is then configured to provide a positive pressure; the positive pressure forces the eighth sample fluid present in the eighth buffer conduit 8h, to flow through all of the m flow cells 3a-d. Specifically the positive pressure provided by the single pumping mean 12 flows through the single input 4′ of the first selector valve unit 4, and then into the eighth output 4h of the first selector valve unit 4, and from the eighth output 4h of the first selector valve unit 4 into the eighth buffer conduit 8h where the positive pressure pushes the eighth sample fluid along the eighth buffer conduit 8h, into the eighth input 7h″ of the second set 107″ of inputs of the switching valve unit 7, and then into the eighth injection conduit 9h via the eighth output 7h′″ of the switching valve unit 7, along the eighth injection conduit 9h, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the eighth sample fluid will contact the test surfaces of each of the first, second, third and fourth flow cells 3a-d; and more specifically will contact ligands which are present on said respective test surfaces. If the eighth sample fluid contains molecules which can bind to the ligands which are on the test surfaces of any the first, second, third and fourth flow cells 3a-d, these molecules will become bound to those ligands when the eighth sample fluid flows through that flow cell.

As the eighth sample fluid flows through the first, second, third and fourth flow cells 3a-d, this sensor 50 is operated to detect if molecules of the eighth sample fluid have become bound to ligands on the test surfaces of any of the first, second, third or fourth flow cells 3a-d.

The eighth sample fluid will flow out of the respective first, second, third and fourth flow cells 3a-d, via the respective outputs 3a″-3d″ of the respective flow cells 3a-d. The eighth sample fluid which flows out of the first flow cell 3a will flow through the first valve 6a of the second selector valve unit 6, and into the first waste reservoir 23; the eighth sample fluid which flows out of the second flow cell 3b will flow through the second valve 6b of the second selector valve unit 6, and into the first waste reservoir 23; the eighth sample fluid which flows out of the third flow cell 3c will flow through the third valve 6c of the second selector valve unit 6, and into the first waste reservoir 23; the eighth sample fluid which flows out of the fourth flow cell 3d will flow through the fourth valve 6d of the second selector valve unit 6, and into the first waste reservoir 23.

Optionally, the above-mentioned rinsing step is performed again.

Advantageously, in the present embodiment, rapid screening of a plurality of sample fluids, to identify if any one or more of said sample fluids have molecules which can bind to predefined ligands (said predefined ligands being of the type provided on the test surfaces of one or more of the flow cells 3a-d) can be achieved. In this example each of the eight sample fluids which were present in the respective reservoirs 1a-h of a first row of the sample tray holder 1 are passed consecutively, without any substantial delay between sample fluids, through the flow cells 3a-d in the flow cell unit 3, and the sensor 50 is used to detect if the molecules bind to ligands on the test surfaces of the flow cells as each respective sample fluid is passed through the flow cells 3a-d.

In a preferred embodiment, the respective sample fluids are flowed through the flow cells 3a-d in rapid succession, this is to ensure that the molecules of the sample fluids contact the same test surface (of the flow cells 3a-d) in rapid succession. Preferably, the time period between passing flowing consecutive sample fluids through the flow cells 3a-d is less than 10 seconds, or is preferably is less than below 5 seconds, or is more preferably is less than 2 seconds, or is most preferably is less than 1 second. For example the time period between the time when the single pumping means 12 is configured to provide a positive pressure which forces the first sample fluid present in the first injection conduit 9a, to flow through all of the m flow cells 3a-d, and the time when the single pumping means 12 is configured to provide a positive pressure which forces the second sample fluid present in the second injection conduit 9b, to flow through all of the m flow cells 3a-d, is less than 10 seconds (or is preferably is less than below 5 seconds, or is more preferably is less than 2 seconds, or is most preferably is less than 1 second). Likewise the time period between the time when the single pumping means 12 is configured to provide a positive pressure which forces the second sample fluid present in the second injection conduit 9c, to flow through all of the m flow cells 3a-d, and the time when the single pumping means 12 is configured to provide a positive pressure which forces the third sample fluid present in the third injection conduit 9c, to flow through all of the m flow cells 3a-d, is less than 10 seconds (or is preferably is less than below 5 seconds, or is more preferably is less than 2 seconds, or is most preferably is less than 1 second). The same is true for all of the respective sample fluid—in other words, the time period between the time when the single pumping means 12 is configured to provide a positive pressure which forces a sample fluid present in an injection conduit, to flow through all of the m flow cells 3a-d, and the time when the single pumping means 12 is configured to provide a positive pressure which forces the next sample fluid present in an injection conduit, to flow through all of the m flow cells 3a-d, is less than 10 seconds (or is preferably is less than below 5 seconds, or is more preferably is less than 2 seconds, or is most preferably is less than 1 second).

In another preferred embodiment, in order to minimize sample dilution edge effects due to Taylor Aris dispersion, the single pumping means 12 dispenses buffer fluid at a high flowrate when it is configured to provide a positive pressure which forces sample fluid present in a injection conduit 9a-h, to flow through all of the flow cells 3a-d. Likewise the pumping means 11 dispenses buffer fluid at a high flowrate during the rinsing step. Preferably, the respective pumping means dispense buffer fluid at a flowrate above 500 microliters per minute, or above 1 millilitres per minute, or above 2 millilitres per minute, or above 5 millilitres per minute.

In a further preferred embodiment, the time-resolved sensor signals from the sensor 50 are recorded at a rate of more than 50 sensor signal data points per seconds, or more than 100 sensor signal data points per second, or more than 100 sensor signal data points per second, while sample fluids flow through all of the flow cells 3a-d or at least during the rinsing step; this allows to resolve fast transitions and fast off-rates.

Optionally, after all of the first, second, third, fourth, fifth, sixth, seventh, and eighth sample fluids have been passed through the flow cells 3a-d the needle unit 2 is moved (preferably by the moveably stage 2′) to the washing station 28. At the washing station 28 the hollow needles 2a-d are washed to avoid contamination of sample fluids (residing in another, second, row of reservoirs 1a-h provided in the sample tray holder 1) which will be subsequently aspirated into the respective hollow needles 2a-h of the needle unit 2.

Preferably in order to wash the hollow needles 2a-h of the needle unit 2, the following steps may be carried out. First the hollow needles are preferably inserted into one or several wells of the washing station 28, then switching valve unit 7 is arranged in its first configuration and the first selector valve unit 4 is arranged into its ninth configuration, then the single pumping means 12 is configured to dispense buffer fluid which flows from the single pumping means 12, through all of the hollow needles 2a-h and into the wells of the washing station 28, so that the inside of all of the hollow needles 2a-h are rinsed. Preferably, when rinsing the inside of the hollow needles 2a-h the level of buffer fluid within said wells rises, effectively rinsing the outside of the hollow needles 2a-h. Excess buffer fluid is then removed by the drains of the wells. Optionally, for washing the hollow needles 2a-h with a cleaning liquid different from the buffer fluid in a first section of the wash station 28, first the hollow needles 2a-h are inserted into the wells corresponding to the first section of the wash station, then the cleaning liquid is injected into said wells through appropriate inputs by means of an auxiliary pumping means, then the switching valve unit 7 is arranged in its first configuration and the first selector valve unit 4 is arranged into its ninth configuration, then the single pumping means 12 is configured to execute several aspiration/dispense cycles such as the cleaning liquid is aspirated and dispensed through the hollow needles 2a-h several times. Excess liquid is then removed by the drains of the wells.

Preferably, after the hollow needles 2a-h have been washed the needle unit 2 is moved so that the hollow needles 2a-h are simultaneously inserted into another row of reservoirs 1a′-h′ (each of which contain respective sample fluids to be screened); preferably said other row of reservoirs 1a′-1h′ will be the row of reservoirs which is adjacent to the row of reservoirs 1a-1h into which the needles were last inserted. As before, at least the tip of each hollow needle 2a-h is submerged in the respective sample fluids contained in the respective reservoirs 1a′-h′ of said other row. It should be noted that the moveable stage 2′ may move the needle unit 2 into a position wherein each of the respective n hollow needles 2 are simultaneously inserted into said respective reservoirs 1a′-h′ of said other row.

The afore mentioned steps are then repeated so that each of the sample fluids contained in said other row of reservoirs 1a′-h′ are screened.

If the sample tray holder 1 comprises more than one other row of reservoirs which contain sample fluids which are to be screened then, preferably, the above-mentioned steps are repeated until the sample fluids contained in all of the rows of reservoirs have been screened.

In the above embodiment the sample fluids being aspirated into the hollow needles 2a-h from the sample tray holder 1, however it should be understood that this is not an essential step; in another embodiment, instead of the sample fluids being aspirated into the hollow needles 2a-h from the sample tray holder 1, the sample fluids are already present in one or more of said n hollow needles 2a-h of said needle unit 2. For example a first sample fluid is present in the first hollow needle 2a; a second sample fluid is present in the second hollow needle 2b; a third sample fluid is present in the first hollow needle 2c; a fourth sample fluid is present in the fourth hollow needle 2d; a fifth sample fluid is present in the fifth hollow needle 2e; a sixth sample fluid is present in the sixth hollow needle 2f; a seventh sample fluid is present in the seventh hollow needle 2g; an eighth sample fluid is present in the eighth hollow needle 2h.

Also It should be understood that the present invention is not limited to requiring that the sample fluids in each of the n hollow needles 2a-h be different sample fluids (i.e. different compositions); on the contrary in another embodiment some of the sample fluids in the n hollow needles 2a-h have the same composition e.g. two of more of the n hollow needles may have sample fluids which have the same composition. It can be that the composition of the sample fluids is entirely unknown. The sample fluids in each of the n hollow needles 2a-h could have come from the same or be different sources.

As mentioned above, the sensor 50 is operated to detect if molecules of a sample fluid have become bound to ligands on the test surfaces of any of the first, second, third or fourth flow cells 3a-d. One way to detect using the sensor 50 if molecules of a particular sample fluid have become bound to ligands on the test surface of any of a flow cell 3a-d is to compare an output signal of the sensor 50 to a reference output signal which is a signal which the sensor 50 outputs when said sample fluid flows through said flow cell, hereafter called reference flow cell, when no ligands are provided on its test surface. Alternatively, the test surface of the reference flow cell may contain reference ligands, such as ligands with similar characteristics as a test ligand but lacking a specific molecular structure relevant to a specific molecular binding. Thus, the method may further comprise the steps of, for each of the respective m (eight) sample fluids: passing that sample fluid through the reference flow cell; obtaining an output signal from the sensor 50 as the sample fluid passes through the reference flow cell, wherein this output signal defines a reference signal. Then any of the above-mentioned steps of operating the sensor 50 to detect if molecules of a sample fluid have become bound to ligands on the test surfaces of any of the first, second, third or fourth flow cells 3a-d, may comprise, obtaining an output signal from the sensor as the sample fluid passes through the first, second, third or fourth flow cells 3a-d (one or more of which are not the reference flow cell); and comparing said output signal with said reference signal. It is then determined that a molecule of said sample fluid has bound to the ligands of a flow cell if the output signal differs from the reference signal. Most preferably, the steps of passing that sample fluid through the reference flow cell and passing that sample fluid through one or more of the flow cells which are not the reference flow cell, are executed simultaneously. In other words, most preferable, in the assembly 101 one of the flow cells 3a-d in the flow cell unit may be a reference flow cell; and during the method of screening a plurality of sample fluids, the step of passing that sample fluid through the reference flow cell takes place simultaneously to passing that sample fluid through the other flow cells (which are not reference flow cells).

Optionally, prior to performing the method of screening a plurality of sample fluids, to identify if any one or more of said sample fluids have molecules which can bind to predefined ligands (said predefined ligands being of the type provided on the test surfaces of one or more of the flow cells 3a-d) described above, a further step of providing ligands on the respective test surfaces of one or more of said m flow cells 3a-h in said flow cell unit 3 may be performed.

50505050Most preferably such a further step of providing ligands on the respective test surfaces of one or more of said m flow cells 3a-h in said flow cell unit 3 would be performed prior to using the assembly 101 to screen one or more sample fluids for molecules which can bind to predefined ligands (said predefined ligands being of the type provided on the test surfaces of one or more of the flow cells 3a-d)), and even prior to providing sample fluids in said n hollow needles 2a-h. Most preferably the step of providing ligands on the respective test surfaces of one or more of said m flow cells 3a-h in said flow cell unit 3 comprises providing ligands on the test surfaces of a plurality (at least two) said flow cells 3a-h in said flow cell unit 3, wherein the type of ligands provided on the test surfaces differ between flow cells such that the test surfaces of said plurality of flow cells have different types of ligands.

In the following there will be described the steps carried out to provide: ligands of a first type, which can bind to a first type of molecule, are provided on the test surface of the first flow cell 3a; ligands of a second type, which can bind to a second type of molecule, are provided on the test surface of the second flow cell 3b; ligands of a third type, which can bind to a third type of molecule, are provided on the test surface of the third flow cell 3c; ligands of a fourth type, which can bind to a fourth type of molecule, are provided on the test surface of the fourth flow cell 3d (it should be understood that it is optional to provide ligands of a fourth type on the test surface of the fourth flow cell 3d; in a variation of this embodiment no ligands are provided on the test surface of the fourth flow cell 3b, so in other words the test surface of the fourth flow cell 3b is without any ligands):

A first immobilization reagent is provided in a first reservoir 1a of a row in said sample try holder 1. It should be understood that the first immobilization reagent may comprise any suitable immobilization reagent; for example the first immobilization reagent may comprise qa mixture of 1-Ethyl-3-(3-dimethylaminopropyl)carbodiimide(EDC) and N-hydroxysuccinimide (NHS) and/or Ethanolamine for amine coupling, and/or NiCl2 for His-Tag coupling, and/or any other suitable reagents. In this example the first immobilization reagent comprises a 1:1 mixture of EDC/NHS.

r different types of ligands are provided in respective r different reservoirs 1a-h of said row of said sample tray holder 1, wherein r is greater than one. As mentioned in this example four different types of ligands will be provided on the respective test surfaces of the respective flow cells 3a-d accordingly in this example r is four. It should be understood that r may have any value greater than one. In this example r is equal to m so four different types of ligands are provided in the respective second, third, fourth and fifth reservoirs 1b′-f′ of said row (i.e. the same row to which said first reservoir 1a′ belongs) of said sample tray holder 1:

Ligands of a first type (referred to hereafter as first ligands) are provided in the second reservoir 1b of said row. In this example said first ligands, optionally diluted in acetate buffer, are provided in the second reservoir 1b.

Ligands of a second type (referred to hereafter as second ligands) are provided in the third reservoir 1c. In this example said second ligands, optionally diluted in acetate buffer, are provided in the second reservoir 1c.

Ligands of a third type (referred to hereafter as third ligands) are provided in the fourth reservoir 1d′. In this example said third ligands, optionally diluted in acetate buffer, is provided in the fourth reservoir 1d′.

In this example ligands of a fourth type (referred to hereafter as fourth ligands) are provided in the fifth reservoir 1e. In this example said fourth ligands, optionally diluted in acetate buffer, are provided in the fifth reservoir 1e. In this particular example the fourth ligands are the same type as either the first, second, or third ligands, with the exception that the fourth ligands are modified (genetically) so that the fourth ligands lack any binding sites. However, it should be understood that it is optional to provide ligands of a fourth type in the fifth reservoir 1e; in a variation of this embodiment no ligands are provided on the test surface of the fourth flow cell 3b, in which case no ligands are provided in the fifth reservoir 1e.

A second immobilization reagent is provided in at least one of the remaining reservoirs 1f-h in said row. In this example the second immobilization reagent comprises Ethanolamine, however it will be understood that the second immobilization reagent may take any suitable form. In this example the second immobilization reagent is provided in the sixth reservoir 1f of said row.

Optionally a buffer is provided in the seventh and eighth reservoirs 1g, 1h of said row.

The needle unit 2 is then arranged so that each of the respective n hollow needles 2a-h is simultaneously inserted into a respective reservoir 1a-h; at least the tip of each hollow needle 2a-h is simultaneously submerged in the respective sample fluid contained in the respective reservoir 1a-h into which it is inserted. It should be noted that the moveable stage 2′ may move the needle unit 2 into this position.

Preferably the second selector valve unit 6 is then moved into its sixth position wherein all of the first, second, third and fourth valves 6a-d of the second selector valve unit 6 are closed. The second valve 22 is also configured to be closed, so that the first valve 22 can block the flow of fluid from the second junction 105 into the second waste reservoir 24. When the second selector valve unit 6 is in its sixth position and the second valve 22 is closed, the flow of fluids along the n injection conduits 9a-h is restricted; accordingly fluids flowing from the hollow needles 2a-h into the n inputs 7a′-7h′ of the first set 107′ of inputs of the switching valve unit 7, will flow into the respective buffer conduits 8a-h via the n inputs 7a″-7h″ of the second set 107″ of inputs of the switching valve unit 7.

The switching valve unit 7 is then arranged in its first configuration so that the switching valve unit 7 simultaneously fluidly connects each of the n inputs 7a′-7h′ of the first set 107′ of inputs with a respective n output 7a″′-7h′″ (specifically the switching valve unit 7 simultaneously fluidly connects all of the first, second, third, fourth, fifth, sixth, seventh and eight inputs 7a′-7h′ of the first set 107′ of inputs with the respective first, second, third, fourth, fifth, sixth, seventh and eighth outputs 7a″′-7h′″).

The first selector valve unit 4 is then arranged into its ninth configuration, such that the first selector valve unit 4 fluidly connect its single input 4′ with all of its n outputs; specifically the first selector valve unit 4 is arranged so that all of its first, second, third, fourth, fifth, sixth, seventh and eighth outputs 4a-h are simultaneously fluidly connected to the single input 4′. When the first selector valve unit 4 is in its ninth configuration, the single pumping means 12 is simultaneously fluidly connected to each of said first, second, third, fourth, fifth, sixth, seventh and eighth outputs 4a-h of the first selector valve unit 4.

The single pumping means 12 is then configured to provide a negative pressure (e.g. negative fluid pressure) so that respective fluids in each of said reservoirs 1a-h are aspirated, simultaneously, into the respective hollow needles 2a-h, through the respective hollow needles 2a-h and through the switching valve unit 7, and into respective buffer conduits 8a-h: Specifically, in this example the first immobilization reagent is aspirated into the first hollow needle 2a of said needle unit 2, and from there the negative pressure forces the first immobilization reagent to flow through the first hollow needle 2a, through the switching valve unit 7, and into the first buffer conduit 8a; said first ligands (which are optionally diluted in an acetate buffer) are aspirated into the second hollow needle 2b and from there the negative pressure forces the first ligands to flow through the second hollow needle 2b, through the switching valve unit 7, and into the second buffer conduit 8b; said second ligands (which are optionally diluted in an acetate buffer) are aspirated into the third hollow needle 2c and from there the negative pressure forces the second ligands to flow through the third hollow needle 2c, through the switching valve unit 7, and into the third buffer conduit 8c; said third ligands (which are optionally diluted in an acetate buffer) are aspirated into the fourth hollow needle 2d and from there the negative pressure forces the third ligands to flow through the fourth hollow needle 2d, through the switching valve unit 7, and into the fourth buffer conduit 8d; said fourth ligands (which are optionally diluted in an acetate buffer) are aspirated into the fifth hollow needle 2e and from there the negative pressure forces the fourth ligands to flow through the fifth hollow needle 2e, through the switching valve unit 7, and into the fifth buffer conduit 8e; said second immobilization reagent is aspirated into the sixth hollow needle 2f and from there the negative pressure forces the second immobilization reagent to flow through the sixth hollow needle 2f, through the switching valve unit 7, and into the sixth buffer conduit 8f; and optionally, said buffer fluid in the seventh reservoir 1g is aspirated into the seventh needle 2g, and from there the negative pressure forces the buffer fluid to flow through the seventh hollow needle 2g, through the switching valve unit 7, and into the seventh buffer conduit 8g; and optionally, said buffer fluid in the eighth reservoir 1h is aspirated into the eighth hollow needle 2h and from there the negative pressure forces the buffer fluid to flow through the eighth hollow needle 2h, through the switching valve unit 7, and into the eighth buffer conduit 8h.

Accordingly, after this step has been performed the first buffer conduit 8a contains the first immobilization reagent; the second buffer conduit 8b contains the said first ligands (which are optionally diluted in an acetate buffer); the third buffer conduit 8c contains said second ligands (which are optionally diluted in an acetate buffer); the fourth buffer conduit 8d contains said third ligands (which are optionally diluted in an acetate buffer); the fifth buffer conduit 8e contains said fourth ligands (which are optionally diluted in an acetate buffer); the sixth buffer conduit 8f contains said second immobilization reagent; and optionally, the seventh buffer conduit 8g contains buffer fluid; and optionally, the eighth buffer conduit 8h contains buffer fluid.

The switching valve unit 7 arranged in its second configuration so that the switching valve unit 7 blocks the flow of fluid between said n inputs 7a′-7h′ of the first set 107′ of inputs and the n outputs 7a″′-7h″′. In this second configuration the switching valve unit 7 prevents fluid, which is present in any of the n buffer conduits 8a-h, from flowing back into the hollow needles 2a-h.

The first selector valve unit 4 it then arranged in its first configuration so that the single input 4′ of the first selector valve unit 4 is fluidly connected to the first output 4a only of the first selector valve unit 4.

The second selector valve unit 6 is arranged in its fifth position so that second selector valve unit 6 fluidly connects all of the outputs 3a″-d″ of all of the flow cells 3a-d in the flow cell unit 3 with the first waste reservoir 23.

The single pumping means 12 is then configured to provide a positive pressure; the positive pressure forces the first immobilization reagent present in the first buffer conduit 8a, to flow through all of the m flow cells. Specifically the positive pressure provided by the single pumping mean 12 flows through the single input 4′ of the first selector valve unit 4, and then into the first output 4a first selector valve unit 4, and from the first output 4a of the first selector valve unit 4 into the first buffer conduit 8a where the positive pressure pushes the first immobilization reagent along the first buffer conduit 8a, into the first input 7a″ of the second set 107″ of inputs of the switching valve unit 7, and then into the first injection conduit 9a via the first output 7a′ of the switching valve unit 7, along the first injection conduit 9a, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23.

When the first immobilization reagent flows through the first, second, third and fourth flow cells 3a-d, the first immobilization reagent will contact the test surfaces of each flow cell 3a-d, thereby activating the test surfaces. Activation of a test surface of a flow cell means providing an immobilization agent (i.e. an agent which can hold a ligand) on the test surface of the flow cell. An immobilization agent may include reactive groups by carboxyl activation for example. Importantly, once a test surface of a flow cell has been activated by the first immobilization agent, ligands which subsequently contact that test surface (e.g. ligands which flow over that test surface) will become attached to said test surface. The ligands which have become attached to the test surface, can in turn bind to molecules in sample fluids which flow through said flow cell. The sensor 50 can be used to detect if molecules in a sample fluid have bound to the ligands on the test surface of a flow cell.

Optionally, the flow cells 3a-d in the flow cell unit 3 are then rinsed in a rinsing step: The second pumping means 11 may be selectively configured to dispense a buffer fluid which can be used to rinse the flow cells 3a-d.

In order to rinse the flow cells 3a-d the first pumping means 12 is configured so that it does not provide any positive or negative pressure (e.g. the first pumping means 12 is turned off); the second selector valve unit 6 is moved into its sixth position wherein all of the first, second, third and fourth valves 6a-d of the second selector valve unit 6 are closed; the first valve 22 is configured to be in its open configuration so that fluid can flow from the second junction 105 through the first valve 22 and into the second waste reservoir 24; the third selector valve unit 17 is arranged into its fifth configuration so that the second pumping means 11 is fluidly connected to all of the flow cells 3a-d.

The second pumping means 11 is then operated to dispense buffer fluid. Specifically, the second pumping means 11 is typically first emptied by configuring the switching valve 11b to fluidly connect the syringe 11a to the waste reservoir 11d, and then dispensing the fluid contents of the syringe 11a into the waste reservoir 11d. Then the switching valve 11b is configured to fluidly connect the syringe 11a to the buffer reservoir 11c, so as to allow buffer fluid which is present in the buffer reservoir 11c, to pass from the buffer reservoir 11c to the syringe 11a. The syringe 11a is then filled with buffer fluid from the buffer reservoir 11c by aspirating buffer fluid from the buffer reservoir 11c. The switching valve 11b is then configured to fluidly connect the syringe 11a to the output 11e; the buffer fluid contained in the syringe 11a is then dispensed from the syringe 11a.

The buffer fluid flows from the second pumping means 11, through all of the valves 17a-d of the third selector valve unit 17, along the buffer inlet conduits 16a, 16b, 16c, 16d, and into all of the flow cells 3a-d in the flow cell unit 3 via the subsidiary conduits 19a, 19b, 19c, 19d. Since the second selector valve unit 6 is in its sixth position the buffer fluid will be prevented from flowing along the subsidiary conduits 19a, 19b, 19c, 19d and into the first waste reservoir 23, thus the buffer fluid is forced to flow along the subsidiary conduits 19a, 19b, 19c, 19d to the flow cells 3a-d. When the buffer fluid flows through the flow cells 3a-d it will rinse the flow cells 3a-d. The buffer fluid flows through the flow cells 3a-d and along the single conduit 5′, through the second junction 105, through the first valve 22 (which is opened) and into the second waste reservoir 24.

The assembly is kept in this configuration for a predefined amount of time until the flow cells 3a-d have been rinsed for said predefined amount of time. Accordingly the second pumping means 11 is maintained in its configuration where it dispenses buffer fluid for said predefined amount of time.

After said predefined amount of time has lapsed, the second pumping means 11 is configured to stop dispensing buffer fluid (e.g. the second pumping means 11 is turned off); and the first valve 22 is configured to be in its closed configuration so that it blocks the flow of fluid from the second junction 105 into the second waste reservoir 24.

Once the above-mentioned, optional, rinsing of the flow cells 3a-d has been performed the next steps in the method may be executed:

The first selector valve unit 4 it then arranged in its second configuration so that the single input 4′ of the first selector valve unit 4 is fluidly connected to the second output 4b only of the first selector valve unit 4.

The second selector valve unit 6 is arranged in its first position wherein the first valve 6a is opened and the second, third, fourth valves 6b-d are closed thereby fluidly connecting the output 3a″ of the first flow cell 3a only with the first waste reservoir 23. The third selector valve unit 17 is arranged in its first configuration.

The single pumping means 12 is then configured to provide a positive pressure; the positive pressure forces the first ligands present in the second buffer conduit 8b, to flow through the first flow cell 3a only. Specifically the positive pressure provided by the single pumping means 12 flows through the single input 4′ of the first selector valve unit 4, and then into the second output 4b of the first selector valve unit 4, and from the second output 4b of the first selector valve unit 4 into the second buffer conduit 8b where the positive pressure pushes the first ligands along the second buffer conduit 8b, into the second input 7b″ of the second set 107″ of inputs of the switching valve unit 7, and then into the second injection conduit 9b via the second output 7b′″ of the switching valve unit 7, along the second injection conduit 9b, and then along the single conduit 5′, and subsequently through the first flow cell 3a only, through the first valve 6a only of the second selector valve 6 and into the first waste reservoir 23.

Because the second selector valve 6 is in its first position, the first ligands arriving at the flow cell unit 3 from the single conduit 5′, will flow through the first flow cell 3a only (not through the second, third or fourth flow cells 3b-d) and into the first waste reservoir 23. As the first ligands flow through the first flow cell 3a they will become attached to the test surface of the first flow cell 3a (the first immobilization agent which flowed over the test surface of the first flow cell 3a in the preceding step primed the test surface of the first flow cell 3a so that the first ligands will attach to the test surface of the first flow cell 3a when the first ligands flow over the test surface of the first flow cell 3a). Accordingly the test surface of the first flow cell 3a is thus provided with the first ligands.

Optionally, the sensor 50 is used to monitor the amount of first ligands which attach to the test surface of the first flow cell 3a. This can be done by recording the signal output by the sensor 50 as the first ligands flow through the first flow cell 3a.

Optionally, the above-mentioned rinsing step is performed again.

The first selector valve unit 4 it then arranged in its third configuration so that the single input 4′ of the first selector valve unit 4 is fluidly connected to the third output 4c only of the first selector valve unit 4.

The second selector valve unit 6 is arranged in its second position wherein the second valve 6b is opened and the first, third, and fourth valves 6a,c,d are closed thereby fluidly connecting the output 3b″ of the second flow cell 3b only with the first waste reservoir 23. The third selector valve unit 17 is arranged in its second configuration.

The single pumping means 12 is then configured to provide a positive pressure; the positive pressure forces the second ligands present in the third buffer conduit 8c, to flow through the second flow cell 3b only. Specifically the positive pressure provided by the single pumping mean 12 flows through the single input 4′ of the first selector valve unit 4, and then into the third output 4c of the first selector valve unit 4, and from the third output 4c of the first selector valve unit 4 into the third buffer conduit 8c where the positive pressure pushes the second ligands along the third buffer conduit 8c, into the third input 7c″ of the second set 107″ of inputs of the switching valve unit 7, and then into the third injection conduit 9c via the third output 7b′″ of the switching valve unit 7, along the third injection conduit 9c, and then along the single conduit 5′, and subsequently through the second flow cell 3b only, and then through the second valve 6a only of the second selector valve 6 and into the first waste reservoir 23.

Because the second selector valve 6 is in its second position, the second ligands arriving at the flow cell unit 3 from the single conduit 5′, will flow through the second flow cell 3b only (not through the first, third or fourth flow cells 3a,c,d) and into the first waste reservoir 23. As the second ligands flow through the second flow cell 3b they will become attached to the test surface of the second flow cell 3a (the first immobilization agent which flowed over the test surface of the second flow cell 3b primed the test surface of the second flow cell 3b so that the second ligands will attach to the test surface of the second flow cell 3b when the second ligands flow over the test surface of the second flow cell 3b). Accordingly the test surface of the second flow cell 3b is thus provided with the second ligands.

Optionally, the sensor 50 is used to monitor the amount of second ligands which attach to the test surface of the second flow cell 3b. This can be done by recording the signal output by the sensor 50 as the second ligands flow through the second flow cell 3b.

Optionally, the above-mentioned rinsing step is performed again.

The first selector valve unit 4 it then arranged in its fourth configuration so that the single input 4′ of the first selector valve unit 4 is fluidly connected to the fourth output 4b only of the first selector valve unit 4.

The second selector valve unit 6 is arranged in its third position wherein the third valve 6c is opened and the first, second, and fourth valves 6a,b,d are closed thereby fluidly connecting the output 3c″ of the third flow cell 3c only with the first waste reservoir 23. The third selector valve unit 17 is arranged in its third configuration.

The single pumping means 12 is then configured to provide a positive pressure; the positive pressure forces the third ligands present in the fourth buffer conduit 8d, to flow through the third flow cell 3c only.

Specifically the positive pressure provided by the single pumping mean 12 flows through the single input 4′ of the first selector valve unit 4, and then into the fourth output 4d of the first selector valve unit 4, and from the fourth output 4d of the first selector valve unit 4 into the fourth buffer conduit 8d where the positive pressure pushes the third ligands along the fourth buffer conduit 8d, into the fourth input 7d″ of the second set 107″ of inputs of the switching valve unit 7, and then into the fourth injection conduit 9d via the fourth output 7d′″ of the switching valve unit 7, along the fourth injection conduit 9d, and then along the single conduit 5′, and subsequently through the third flow cell 3a only, and then through the third valve 6d only of the second selector valve 6 and into the first waste reservoir 23.

Because the second selector valve 6 is in its third position, the third ligands arriving at the flow cell unit 3 from the single conduit 5′, will flow through the third flow cell 3c only (not through the first, second or fourth flow cells 3a,b,d) and into the first waste reservoir 23. As the third ligands flow through the third flow cell 3c they will become attached to the test surface of the third flow cell 3c (the first immobilization agent which flowed over the test surface of the third flow cell 3c primed the test surface of the third flow cell 3c so that the third ligands will attach to the test surface of the third flow cell 3c when the third ligands flow over the test surface of the third flow cell 3b). Accordingly the test surface of the third flow cell 3c is thus provided with the third ligands.

Optionally, the sensor 50 is used to monitor the amount of third ligands which attach to the test surface of the third flow cell 3c. This can be done by recording the signal output by the sensor 50 as the third ligands flow through the third flow cell 3c.

Optionally, the above-mentioned rinsing step is performed again.

The first selector valve unit 4 it then arranged in its fifth configuration so that the single input 4′ of the first selector valve unit 4 is fluidly connected to the fifth output 4e only of the first selector valve unit 4.

The second selector valve unit 6 is arranged in its fourth position wherein the fourth valve 6d is opened and the first, second, and third valves 6a,b,c are closed thereby fluidly connecting the output 3d″ of the fourth flow cell 3d only with the first waste reservoir 23. The third selector valve unit 17 is arranged in its fourth configuration.

The single pumping means 12 is then configured to provide a positive pressure; the positive pressure forces the fourth ligands present in the fifth buffer conduit 8e, to flow through the fourth flow cell 3d only.

Specifically the positive pressure provided by the single pumping mean 12 flows through the single input 4′ of the first selector valve unit 4, and then into the fifth output 4e of the first selector valve unit 4, and from the fifth output 4e of the first selector valve unit 4 into the fifth buffer conduit 8e where the positive pressure pushes the fourth ligands along the fifth buffer conduit 8e, into the fifth input 7e″ of the second set 107″ of inputs of the switching valve unit 7, and then into the fifth injection conduit 9e via the fifth output 7e′″ of the switching valve unit 7, along the fifth injection conduit 9e, and then along the single conduit 5′, and subsequently through the fourth flow cell 3a only, and then through the fourth valve 6d only of the second selector valve 6 and into the first waste reservoir 23.

Because the second selector valve 6 is in its fourth position, the fourth ligands arriving at the flow cell unit 3 from the single conduit 5′, will flow through the fourth flow cell 3d only (not through the first, second or third flow cells 3a,b,c) and into the first waste reservoir 23. As the fourth ligands flow through the fourth flow cell 3d they will become attached to the test surface of the fourth flow cell 3d (the first immobilization agent which flowed over the test surface of the fourth flow cell 3c primed the test surface of the fourth flow cell 3d so that the fourth ligands will attach to the test surface of the fourth flow cell 3d when the fourth ligands flow over the test surface of the fourth flow cell 3d). Accordingly the test surface of the fourth flow cell 3d is thus provided with the fourth ligands.

In this particular example the fourth ligands are the same as either the first, second, or third ligands, with the exception that the fourth ligands are modified (genetically) so that the fourth ligands lack a specific binding site. Most preferably the aim when screening a plurality of sample fluids is to identify sample(s) which have molecules which can bind to a specific binding site of a ligand. It is possible that molecules bind to other parts of the ligand (which are not binding sites), and molecules of a sample fluid which bind to other parts of the ligand which are not binding sites of the ligand, are referred to as being a sticky compound”. Advantageously, having a fourth ligands which are the same as either the first, second, or third ligands, with the exception that the fourth ligands are modified (genetically) so that the fourth ligands lack a specific binding site, allows to identify if a sample fluid contains a “sticky compound”, thus allowing to determine if molecules of a sample fluid which have bound to ligands in that flow cell have bound to the specific binding site of the ligand or have likely bound to another part of the ligand. For example, if the fourth ligands are the same as the first ligands, but are modified (genetically) so that the fourth ligands lack a specific binding site, and molecules within a sample fluid which has been passed through the flow cells 3a-d were shown (via the sensor) to bind to the first ligands in the first flow cell, and to also bind to the fourth ligands in the fourth flow cell, this indicates that the sample fluid contains a “sticky compound” and potentially the molecules of the sample fluid did not bind to the specific binding site on the first ligands but rather bound to another part of the first ligands (often such a sample fluid would not be considered as a good drug candidate for binding to equivalent ligands within the human body). If on the other hand the molecules within a sample fluid which has been passed through the flow cells 3a-d was shown (via the sensor) to bind to the first ligands in the first flow cell, but not to bind to the fourth ligands in the fourth flow cell, this indicates that sample fluid does not contain a “sticky compound” and that the molecules of the sample fluid did bind to the specific binding site on the first ligands (often such a sample fluid would be considered to be a good drug candidate for binding to equivalent ligands within the human body).

Optionally, the sensor 50 is used to monitor the amount of fourth ligands which attach to the test surface of the fourth flow cell 3d. This can be done by recording the signal output by the sensor 50 as the fourth ligands flow through the fourth flow cell 3d.

Optionally, the above-mentioned rinsing step is performed again.

It should be understood that providing the fourth flow cell with ligands (in this case fourth ligands) is an optional step; in a variation of this embodiment the fourth flow cell is not provided with any ligands on its test surface. According the test surface of the fourth flow cell 3d is without any ligands. In such a case the output of the sensor measuring binding in the fourth flow cell, when the sample fluid passes through all of the flow cells, can be used as a reference signal, to which the output of the sensor measuring binding in the first, second, and third flow cell 3a-c can be compared. When a sample fluid is passed through all of the flow cells 3a-d, and if the output of the sensor measuring binding in the first flow cell 3a, differs from the output of the sensor measuring binding in the fourth flow cell 3d, this indicates that molecules of that sample fluid have bound to the first ligands in the first flow cell 3a. Likewise when a sample fluid is passed through all of the flow cells 3a-d, and if the output of the sensor measuring binding in the second flow cell 3b, differs from the output of the sensor measuring binding in the fourth flow cell 3d, this indicates that molecules of that sample fluid have bound to the second ligands in the second flow cell 3b. Likewise, when a sample fluid is passed through all of the flow cells 3a-d, and if the output of the sensor measuring binding in the third flow cell 3c, differs from the output of the sensor measuring binding in the fourth flow cell 3d, this indicates that molecules of that sample fluid have bound to the third ligands in the third flow cell 3c.a

Referring back to the present embodiment, the first selector valve unit 4 it then arranged in its sixth configuration so that the single input 4′ of the first selector valve unit 4 is fluidly connected to the sixth output 4f only of the first selector valve unit 4.

The second selector valve unit 6 is arranged in its fifth position so that second selector valve unit 6 fluidly connects all of the outputs 3a″-d″ of all of the flow cells 3a-d in the flow cell unit 3 with the first waste reservoir 23.

The single pumping means 12 is then configured to provide a positive pressure; the positive pressure forces the second immobilization reagent present in the sixth buffer conduit 8f, to flow through all of the m flow cells 3a-d.

Specifically the positive pressure provided by the single pumping mean 12 flows through the single input 4′ of the first selector valve unit 4, and then into the sixth output 4f first selector valve unit 4, and from the sixth output 4f of the first selector valve unit 4 into the sixth buffer conduit 8f where the positive pressure pushes the second immobilization reagent along the sixth buffer conduit 8f, into the sixth input 7f″ of the second set 107″ of inputs of the switching valve unit 7, and then into the sixth injection conduit 9f via the sixth output 7f′″ of the switching valve unit 7, along the sixth injection conduit 9f, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23.

When the second immobilization reagent flows through the first, second, third and fourth flow cells 3a-d, the second immobilization reagent will act to passivate the test surfaces of the respective first, second, third and fourth flow cells 3a-d. In the present application to passivate a test surface means to provide a passivating agent on the test surface, wherein a passivating agent is an agent removes immobilization agents from the test surface (thereby ensuring that there is no immobilization agent which can hold a ligand present on the test surface, thus ensuring that there is no ligands present on the test surface). An example of a passivating agent includes, but is not limited to, Ethanolamine.

Optionally, the above-mentioned rinsing step is performed again.

Optionally, the first selector valve unit 4 it then arranged in its seventh configuration so that the single input 4′ of the first selector valve unit 4 is fluidly connected to the seventh output 4e only of the first selector valve unit 4.

The second selector valve unit 6 is maintained in its fifth position so that second selector valve unit 6 fluidly connects all of the outputs 3a″-d″ of all of the flow cells 3a-d in the flow cell unit 3 with the first waste reservoir 23.

The single pumping means 12 is then configured to provide a positive pressure; the positive pressure forces the optional buffer which is present in the seventh buffer conduit 8g, to flow through all of the m flow cells 3a-h.

Specifically the positive pressure provided by the single pumping mean 12 flows through the single input 4′ of the first selector valve unit 4, and then into the seventh output 4g of the first selector valve unit 4, and from the seventh output 4g of the first selector valve unit 4 into the seventh buffer conduit 8g where the positive pressure pushes the buffer along the seventh buffer conduit 8g, into the seventh input 7g″ of the second set 107″ of inputs of the switching valve unit 7, and then into the seventh injection conduit 9g via the seventh output 7g′″ of the switching valve unit 7, along the seventh injection conduit 9g, and then along the single conduit 5′, and subsequently through the first, second, third and fourth flow cells 3a-d, and through the second selector valve 6 (i.e. through the first, second, third and/or fourth valves 6a-d of the second selector valve 6) and into the first waste reservoir 23.

When the buffer flows through the first, second, third and fourth flow cells 3a-d, the buffer will act to equilibrate the test surfaces within the flow cells 3a-d.

Optionally, the above-mentioned rinsing step is performed again.

Optionally, the first selector valve unit 4 it then arranged in its eighth configuration so that the single input 4′ of the first selector valve unit 4 is fluidly connected to the eighth output 4h only of the first selector valve unit 4.

The second selector valve unit 6 is maintained in its fifth position so that second selector valve unit 6 fluidly connects all of the outputs 3a″-d″ of all of the flow cells 3a-d in the flow cell unit 3 with the first waste reservoir 23.

The single pumping means 12 is then configured to provide a positive pressure; the positive pressure forces the optional buffer which is present in the eighth buffer conduit 8h, to flow through all of the m flow cells 3a-h.

Specifically the positive pressure provided by the single pumping mean 12 flows through the single input 4′ of the first selector valve unit 4, and then into the eighth output 4h of the first selector valve unit 4, and from the eighth output 4h of the first selector valve unit 4 into the eighth buffer conduit 8h where the positive pressure pushes the buffer along the eighth buffer conduit 8h, into the eighth input 7h″ of the second set 107″ of inputs of the switching valve unit 7, and then into the eighth injection conduit 9h via the eighth output 7h′″ of the switching valve unit 7, along the eighth injection conduit 9h, and then along the single conduit 5′, and subsequently through the first, second, third and fourth flow cells 3a-d, and through the second selector valve 6 (i.e. through the first, second, third and/or fourth valves 6a-d of the second selector valve 6) and into the first waste reservoir 23.

When the buffer flows through the first, second, third and fourth flow cells 3a-d, the buffer will act to equilibrate the test surfaces within the flow cells 3a-d. Example of suitable buffers are Phosphate-buffered saline (PBS), or buffers based on 4-(2-hydroxyethyl)-1-piperazineethanesulfonic acid) (HEPES).

Optionally, the above-mentioned rinsing step is performed again.

Optionally the hollow needles 2a-h in the needle unit 2 are then washed. Most preferably the hollow needles 2a-h are washed before they are filled with sample fluids which is to undergo screening according to the afore-method. For example after the ligands have been provided on the test surfaces of the respective flow cells 3 the moveable stage 2′ may operate to move the needle unit 2 to the wash station 28 where the hollow needles 2a-h are washed; after the hollow needles 2a-h have been washed the moveable stage 2′ moves the needle unit 2 to a position over the sample tray holder 1 where each of the needle unit 2 can aspirate sample fluids from respective reservoirs which are to be screened.

It should be understood that the first, second, third and fourth ligands may take any suitable form. The first, second, third and fourth ligands can bind to molecules which have a predefined characteristic such as having a high affinity to the ligands either via a simple lock-and-key mechanism where a molecule fits into a so-called binding pocket of a ligand, or assisted by more complex molecular processes such as conformational changes. Thus, it can be determined which molecules in a sample fluid have said predefined characteristic of having a high affinity to the ligands, by passing the sample fluid over the surfaces of the flow cell unit 3 and then determining which molecules have become bound to the ligands. In drug discovery applications where a multitude of molecules from a compound library are screened for finding suitable drug candidates binding to a drug target, typically, the different ligands can be used to exclude non-specific binding effects, for instance by providing a drug target as first ligands, and similar molecules as the drug target but lacking a specific binding pocket as second and third and fourth ligands. Thus, any of the flow cells comprising test surfaces with immobilized second, third or fourth ligands can be used as reference flow cell. In another example, three different drug targets are provided as first, second and third ligands on the test surfaces of three flow cells, and the fourth flow cell is the reference flow cell with an empty test surface.

It should be understood that in a variation of the above-described embodiment, instead of providing the first immobilization reagent, the first ligand, second ligand, third ligand, fourth ligand, second immobilization reagent, and buffers, in the respective, first, second, third, fourth, fifth, sixth, seventh, and eighth, reservoirs 1a-h of said sample tray holder 1, and then aspirating these into the respective hollow needles 2a-h, the first immobilization reagent, the first ligand, second ligand, third ligand, fourth ligand, second immobilization reagent, and buffers, could be initially present in the respective, first, second, third, fourth, fifth, sixth, seventh, and eighth, hollow needles 2a-h. In such an embodiment no sample tray holder 1 is required.

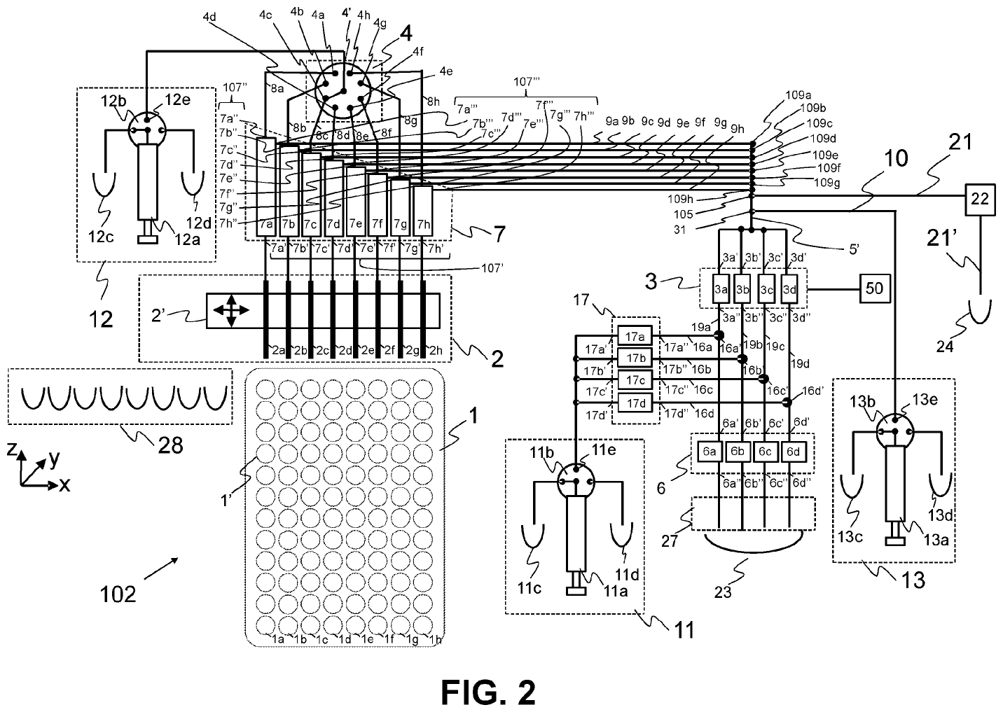

FIG. 2 shows an assembly 102 according to a further embodiment of the present invention. The assembly 102 has many of the same features as the assembly 101 shown in FIG. 1 and like features are awarded the same reference numbers.

FIG. 2 illustrates an assembly 102 according to a further embodiment of the present invention. The assembly 102 comprises many of the same features of the assembly 101 of FIG. 1 and like features are awarded the same reference numbers.

The assembly 102 further comprises, a third pumping means 13 which can be selectively configured to provide positive pressure or negative pressure. Said third pumping means is fluidly connected to a third junction 31, wherein said third junction 31 is located along the single conduit 5′. between where the injection conduits 9a-h are fluidly connected to said single conduit 5′ and the m inputs 3a′-3d′ of said m flow cells 3a-d in said flow cell unit. Specifically, in the assembly 102 the third junction is located along the single conduit 5′, between said second junction 105 and the m inputs 3a′-3d′ of said m flow cells 3a-d in said flow cell unit 3.

The third pumping means 13 may have any suitable configuration. In this example, the third pumping means 13 comprises a syringe 13a, a switching valve 13b, a buffer reservoir 13c which contains a buffer fluid, a waste reservoir 13d and an output 13e. Preferably, before providing positive pressure, the third pumping means 13 is typically primed by configuring the switching valve 13b to fluidly connect the syringe 13a to the waste reservoir 13d, so as to allow buffer fluid to pass from the syringe 13a to the waste reservoir 13d; then the buffer fluid contents of the syringe 13a are dispensed into the waste reservoir 13d. Then the switching valve 13b is configured to fluidly connect the syringe 13a to the buffer reservoir 13c, so as to allow buffer fluid to pass from the buffer reservoir 13c into the syringe 13a. The syringe 13a is then filled with buffer fluid from the buffer reservoir 13c by aspirating buffer fluid from the buffer reservoir 13c. In order to provide positive pressure, the switching valve 13b is configured to fluidly connect the syringe 13a to the output 13e; buffer fluid contained in the syringe 13a is then dispensed from the syringe; the dispensed buffer fluid creates the positive pressure. Similarly, preferably, before providing negative pressure, the syringe 13a is typically at least partially emptied (and most preferably is fully emptied); the switching valve 13b is configured to fluidly connect the syringe 13a to the waste reservoir 13d so as to allow fluid to pass from the syringe 13a to the waste reservoir 13d; the fluid contents of the syringe 13a is then at least partially emptied into the waste reservoir 13d. In order to provide negative pressure, the switching valve 13b is configured to fluidly connect the syringe 13a to the output 13e; then fluid 13e present in the output is aspirated into the syringe 13a; aspirating fluid from the output 13e into the syringe 13a creates the negative pressure.

Most preferably the third pumping means 13 (specifically the output 13e of the third pumping means 13) is fluidly connected to the third junction 31 via a conduit 10 referred to hereafter as the pump conduit 10. One end of the pump conduit 10 is connected to the output 13e and the opposite end of the pump conduit 10 is connected to the third junction 31. Preferably, the pump conduit 10 has a volume greater than three times the combined inner volume of all conduits between the sample container 1 and the junction 5, such as samples do not reach and contaminate the third pumping means 13 during the alternative pickup step. Preferably, the pump conduit 10 has a volume greater than 10 microliters, or greater than 50 microliters, or greater than 100 microliters.

The assembly 102 operates (for screening samples and/or for capturing or immobilizing ligands on sensor surfaces present in the flow cell unit 3, and) in substantially the same manner as the assembly 101 with the exception that the third pumping means 13 is used to aspirate fluids from the respective reservoirs 1a-h in the sample tray holder 1, into the respective injection conduits 9a-9h, instead of using the first pumping means 12 to aspirate fluids into the respective buffer conduits 8a-h.

For example, instead of said steps of arranging the first selector valve unit 4 into its ninth configuration, such that the first selector valve unit 4 fluidly connect its single input 4′ with all of its n outputs; and then configuring the single pumping means 12 to provide a negative pressure (e.g. negative fluid pressure) so that the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7, and out of the switching valve unit 7 via the n inputs 7a″-7h″ of the second set 107″ of inputs of the switching valve unit 7, into the respective buffer conduits 8a-h, as is done in the assembly 101, in the assembly 102, the second selector valve unit 6 is moved into its sixth position, and the second switch 22 is closed; then the switching valve unit 7 is moved into its first position, and the third pumping means 13 is configured to provide a negative pressure e.g. negative fluid pressure) so that the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7, and out of the switching valve unit 7 via the n outputs 7a″′-7h′″ of the switching valve unit 7, and into the respective injection conduits 9a-h.

For example, instead of configuring the single pumping means 12 to provide a negative pressure (e.g. negative fluid pressure) so that: the first immobilization reagent is aspirated into the first hollow needle 2a of said needle unit 2, and from there the negative pressure forces the first immobilization reagent to flow through the first hollow needle 2a, through the switching valve unit 7, and into the first buffer conduit 8a; said first ligands (which are optionally diluted in an acetate buffer) are aspirated into the second hollow needle 2b and from there the negative pressure forces the first ligands to flow through the second hollow needle 2b, through the switching valve unit 7, and into the second buffer conduit 8b; said second ligands (which are optionally diluted in an acetate buffer) are aspirated into the third hollow needle 2c and from there the negative pressure forces the second ligands to flow through the third hollow needle 2c, through the switching valve unit 7, and into the third buffer conduit 8c; said third ligands (which are optionally diluted in an acetate buffer) are aspirated into the fourth hollow needle 2d and from there the negative pressure forces the third ligands to flow through the fourth hollow needle 2d, through the switching valve unit 7, and into the fourth buffer conduit 8d; said fourth ligands (which are optionally diluted in an acetate buffer) are aspirated into the fifth hollow needle 2e and from there the negative pressure forces the fourth ligands to flow through the fifth hollow needle 2e, through the switching valve unit 7, and into the fifth buffer conduit 8e; said second immobilization reagent is aspirated into the sixth hollow needle 2f and from there the negative pressure forces the second immobilization reagent to flow through the sixth hollow needle 2f, through the switching valve unit 7, and into the sixth buffer conduit 8f; and optionally, said buffer fluid in the seventh reservoir 1g is aspirated into the seventh needle 2g, and from there the negative pressure forces the buffer fluid to flow through the seventh hollow needle 2g, through the switching valve unit 7, and into the seventh buffer conduit 8g; and optionally, said buffer fluid in the eighth reservoir 1h is aspirated into the eighth hollow needle 2h and from there the negative pressure forces the buffer fluid to flow through the eighth hollow needle 2h, through the switching valve unit 7, and into the eighth buffer conduit 8h, as is done in the assembly 101, in the assembly 102, the second selector valve unit 6 is moved into its sixth position, and the second switch 22 is closed; then the switching valve unit 7 is moved into its first position, and the third pumping means 13 is configured to provide a negative pressure e.g. negative fluid pressure) so that the first immobilization reagent is aspirated into the first hollow needle 2a of said needle unit 2, and from there the negative pressure forces the first immobilization reagent to flow through the first hollow needle 2a, through the switching valve unit 7, and into the first injection conduit 9a; said first ligands (which are optionally diluted in an acetate buffer) are aspirated into the second hollow needle 2b and from there the negative pressure forces the first ligands to flow through the second hollow needle 2b, through the switching valve unit 7, and into the second injection conduit 9b; said second ligands (which are optionally diluted in an acetate buffer) are aspirated into the third hollow needle 2c and from there the negative pressure forces the second ligands to flow through the third hollow needle 2c, through the switching valve unit 7, and into the third injection conduit 9c; said third ligands (which are optionally diluted in an acetate buffer) are aspirated into the fourth hollow needle 2d and from there the negative pressure forces the third ligands to flow through the fourth hollow needle 2d, through the switching valve unit 7, and into the fourth injection conduit 9d; said fourth ligands (which are optionally diluted in an acetate buffer) are aspirated into the fifth hollow needle 2e and from there the negative pressure forces the fourth ligands to flow through the fifth hollow needle 2e, through the switching valve unit 7, and into the fifth injection conduit 9e; said second immobilization reagent is aspirated into the sixth hollow needle 2f and from there the negative pressure forces the second immobilization reagent to flow through the sixth hollow needle 2f, through the switching valve unit 7, and into the sixth injection conduit 9f; and optionally, said buffer fluid in the seventh reservoir 1g is aspirated into the seventh needle 2g, and from there the negative pressure forces the buffer fluid to flow through the seventh hollow needle 2g, through the switching valve unit 7, and into the seventh injection conduit 9g; and optionally, said buffer fluid in the eighth reservoir 1h is aspirated into the eighth hollow needle 2h and from there the negative pressure forces the buffer fluid to flow through the eighth hollow needle 2h, through the switching valve unit 7, and into the eighth injection conduit 9h.

Preferably, when aspirating sample from the reservoirs 1a-h, a volume of more than three times the combined inner volume of all conduits between the sample container 1 and the junction 5 is aspirated by the third pumping means, such as the sample concentration within the portion of the injection conduits 9a through 9h close to the junction 5 is only minimally diluted due to Taylor-Aris dispersion. Advantageously, the sample concentration within the portion of the injection conduits 9a through 9h close to the junction 5 is then close to 100% of the original sample concentration in the respective well of the sample container 1.

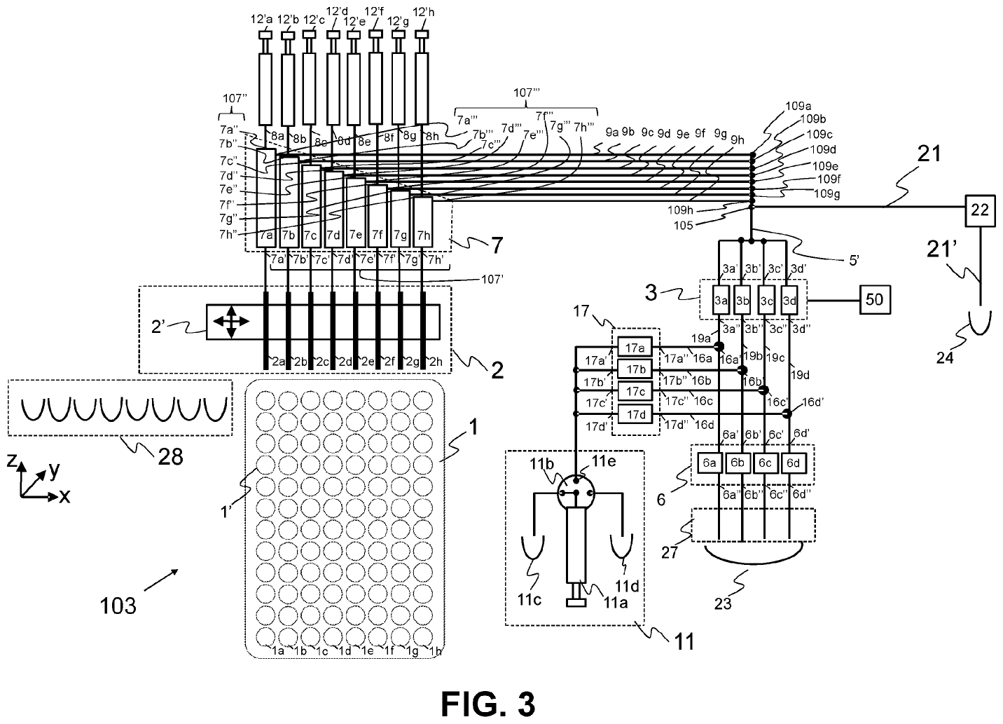

FIG. 3 shows an assembly 103 according to a further embodiment of the present invention. The assembly 103 has many of the same features as the assembly 101 shown in FIG. 1 and like features are awarded the same reference numbers.

However, instead of having a single pumping means 12 and first selector valve unit 4, as is the case in the assembly 101, the assembly 103 comprises n pumping means 12′a-h. As already mentioned in this example n is equal to eight therefore the assembly 103 comprises eight pumping means, namely a first pumping means 12′a, a second pumping means 12′b, a third pumping means 12′c, a fourth pumping means 12′d, a fifth pumping means 12′e, a sixth pumping means 12′f, a seventh pumping means 12′g, an eighth pumping means 12′h. Most preferably the number of pumping means (12′a-h) corresponds to the number of hollow needles in the needle unit 2.

Each of then pumping means (12′a-12′h) has a respective output 12a′-12h′ thereby providing n outputs. Each of the pumping means (12′a-h) can be selectively configured to provide positive pressure (e.g. positive fluid pressure) or negative pressure (e.g. negative fluid pressure, such as a vacuum) at its respective output 12a′-12h′. Each respective output 12a′-h′ is fluidly connected to a respective input 7a″-h″ belonging to the second set 107″ of inputs of the switching valve unit 7. Specifically, the output 12a′ of the first pumping means 12′a is fluidly connected to the first input 7a″ of the second set 107″ of inputs of the switching valve unit 7; the output 12b′ of the second pumping means 12′b is fluidly connected to the second input 7b″ of the second set 107″ of inputs of the switching valve unit 7; the output 12c′ of the third pumping means 12′c is fluidly connected to the third input 7c″ of the second set 107″ of inputs of the switching valve unit 7; the output 12d′ of the fourth pumping means 12′d is fluidly connected to the fourth input 7d″ of the second set 107″ of inputs of the switching valve unit 7; the output 12e′ of the fifth pumping means 12′e is fluidly connected to the fifth input 7e″ of the second set 107″ of inputs of the switching valve unit 7; the output 12f′ of the sixth pumping means 12′f is fluidly connected to the sixth input 7f″ of the second set 107″ of inputs of the switching valve unit 7; the output 12g′ of the seventh pumping means 12′g is fluidly connected to the seventh input 7g″ of the second set 107″ of inputs of the switching valve unit 7; the output 12h′ of the eighth pumping means 12′h is fluidly connected to the eighth input 7h″ of the second set 107″ of inputs of the switching valve unit 7.

The assembly 103 can be used to perform a method of screening a plurality of sample fluids to identify if any one or more of said sample fluids contain molecules which can bind to predefined ligands (said predefined ligands being of the type provided on the test surfaces of one or more of the flow cells 3a-d), according to a further embodiment of the present invention:

During use a sample holder tray 1 which comprises a plurality of reservoirs 1′ is provided; sample fluids are provided in at least some of the reservoirs 1′. In the example shown in FIG. 1, the sample holder tray 1 comprises a series of rows of reservoirs 1′; in at least one of the rows all of the reservoirs 1′ in that row are provided with sample fluids which are to undergo screening. Preferably in at least two of the rows all of the reservoirs 1′ in those two rows are provided with sample fluids which are to undergo screening. Most preferably sample fluids are provided in all of the reservoirs 1′ of said sample holder tray 1.

Different sample fluids may be provided in each respective reservoir 1′; in other words the sample fluids provided in said different reservoirs 1′ may have different compositions (this is not essential; it could be that some of the sample fluids in different reservoirs 1′ have the same composition). In this example the different sample fluids having different compositions are provided in said respective reservoirs 1′: In a first row of reservoirs, a first sample fluid is provided in a first reservoir 1a′ of that row; a second sample fluid is provided in a second reservoir 1b′ of said row; a third sample fluid is provided in a third reservoir 1c′ of said row; a fourth sample fluid is provided in a fourth reservoir 1d′ of said row; a fifth sample fluid is provided in a fifth reservoir 1e′ of said row; a sixth sample fluid is provided in a sixth reservoir 1f′ of said row; a seventh sample fluid is provided in a seventh reservoir 1g′ of said row; an eighth sample fluid is provided in an eighth reservoir 1h′ of said row.

The needle unit 2 is then arranged so that each of the respective n hollow needles 2 is simultaneously inserted into a respective reservoir 1a-h; specifically the needle unit 2 is arranged so that, the first hollow needle 2a is inserted into said first reservoir 1a′, the second hollow needle 2b is inserted into said second reservoir 1b′, the third hollow needle 2c is inserted into said third reservoir 1c′, the fourth hollow needle 2d is inserted into said fourth reservoir 1d′, the fifth hollow needle 2e is inserted into said fifth reservoir 1e′, the sixth hollow needle 2f is inserted into said sixth reservoir 1f, the seventh hollow needle 2g is inserted into said seventh reservoir 1g′, the eighth hollow needle 2h is inserted into said eighth reservoir 1h′. At least the tip of each hollow needle 2a-h is submerged in the respective sample fluids contained in the respective reservoirs 1a′-h′. It should be noted that the moveable stage 2′ may move the needle unit 2 into a position wherein each of the respective n hollow needles 2 are simultaneously inserted into a respective reservoir 1a-h.

Preferably the second selector valve unit 6 is then moved into its sixth position wherein all of the first, second, third and fourth valves 6a-d of the second selector valve unit 6 are closed. The second valve 22 is also configured to be closed, so that the first valve 22 can block the flow of fluid from the second junction 105 into the second waste reservoir 24. When the second selector valve unit 6 is in its sixth position and the second valve 22 is closed, the flow of fluids along the n injection conduits 9a-h is restricted; accordingly fluids flowing from the hollow needles 2a-h into the n inputs 7a′-7h′ of the first set 107′ of inputs of the switching valve unit 7, will flow into the respective buffer conduits 8a-h via the n inputs 7a″-7h″ of the second set 107″ of inputs of the switching valve unit 7.

The switching valve unit 7 is arranged in its first configuration (if the switching valve unit 7 is not already arranged in its first configuration) so that the switching valve unit 7 simultaneously fluidly connects each of the n inputs 7a′-7h′ of the first set 107′ of inputs with a respective n output 7a″′-7h′″ (specifically the switching valve unit 7 simultaneously fluidly connects all of the first, second, third, fourth, fifth, sixth, seventh and eighth inputs 7a′-7h′ of the first set 107′ of inputs with the respective first, second, third, fourth, fifth, sixth, seventh and eighth outputs 7a″′-7h′″).

Each of the n pumping means (12′a-12′h) are then configured to provide a negative pressure (e.g. negative fluid pressure) so that the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7. In this example the respective sample fluids in each of said respective reservoirs 1a′-h in said row are aspirated, simultaneously, into said respective hollow needles 2a-h; and said respective sample fluids are forced to simultaneously flow out of the respective hollow needles 2a-h and through the switching valve unit 7, and out of the switching valve unit 7 via the n inputs 7a″-7h″ of the second set 107″ of inputs of the switching valve unit 7, into the respective buffer conduits 8a-h.

Specifically, the first sample fluid present in the first reservoir 1a is aspirated into the first hollow needle 2a of said needle unit 2, and from there the negative pressure forces the first immobilization reagent to flow through the first hollow needle 2a, through the switching valve unit 7, and into the first buffer conduit 8a; the second sample fluid present in the second reservoir 1b is aspirated into the second hollow needle 2b and from there the negative pressure forces the second sample fluid to flow through the second hollow needle 2b, through the switching valve unit 7, and into the second buffer conduit 8b; the third sample fluid present in the third reservoir 1c is aspirated into the third hollow needle 2c and from there the negative pressure forces the third sample fluid to flow through the third hollow needle 2c, through the switching valve unit 7, and into the third buffer conduit 8c; the fourth sample fluid present in the fourth reservoir 1d is aspirated into the fourth hollow needle 2d and from there the negative pressure forces the fourth sample fluid to flow through the fourth hollow needle 2d, through the switching valve unit 7, and into the fourth buffer conduit 8d; the fifth sample fluid present in the fifth reservoir 1e is aspirated into the fifth hollow needle 2e and from there the negative pressure forces the fifth sample fluid to flow through the fifth hollow needle 2e, through the switching valve unit 7, and into the fifth buffer conduit 8e; the sixth sample fluid present in the sixth reservoir if is aspirated into the sixth hollow needle 2f and from there the negative pressure forces the sixth sample fluid to flow through the sixth hollow needle 2f, through the switching valve unit 7, and into the sixth buffer conduit 8f; the seventh sample fluid present in the seventh reservoir 1g is aspirated into the seventh needle 2g, and from there the negative pressure forces the seventh sample fluid to flow through the seventh hollow needle 2g, through the switching valve unit 7, and into the seventh buffer conduit 8g; the eighth sample fluid present in the eighth reservoir 1h′ is aspirated into the eighth hollow needle 2h and from there the negative pressure forces the eighth sample fluid to flow through the eighth hollow needle 2h, through the switching valve unit 7, and into the eighth buffer conduit 8h.

Accordingly after this step has been performed the first, second, third, fourth, fifth, sixth, seventh, and eighth sample fluids are present in the respective first, second, third, fourth, fifth, sixth, seventh, and eighth buffer conduits 8a-f.

The switching valve unit 7 then arranged in its second configuration so that the switching valve unit 7 blocks the flow of fluid between said n inputs 7a′-7h′ of the first set 107′ of inputs and the n outputs 7a″′-7h″′. In this second configuration the switching valve unit 7 prevents fluid, which is present at any of the n outputs 7a″′-7h′″ or which is present in any of the n buffer conduits 8a-f, from flowing back into the hollow needles 2a-h.

Preferably the second selector valve unit 6 is then moved into its fifth position, so that all of the first, second, third and fourth valves 6a-d of the second selector valve unit 6 are opened, thereby fluidly connecting all of the outputs 3a″-3d″ of all of the flow cells 3a-d in the flow cell unit 3 with the first waste reservoir 23.

The first pumping means 12′a is then configured to provide a positive pressure; the positive pressure forces the first sample fluid present in the first buffer conduit 8a, to flow through all of the m flow cells 3a-d. Specifically the positive pressure provided by the single pumping means 12 flows into the first buffer conduit 8a where the positive pressure pushes the first sample fluid along the first buffer conduit 8a, into the first input 7a″ of the second set 107″ of inputs of the switching valve unit 7, and then into the first injection conduit 9a via the first output 7a′″ of the switching valve unit 7, along the first injection conduit 9a, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the first sample fluid will contact the test surfaces of each of the first, second, third and fourth flow cells 3a-d; and more specifically will contact ligands which are present on said respective test surfaces. If the first sample fluid contains molecules which can bind to the ligands which are on the test surfaces of any the first, second, third and fourth flow cells 3a-d, these molecules will become bound to those ligands when the first sample fluid flows through that flow cell.

Most preferably the assembly 101 further comprises a sensor 50 which can detect if molecules of a sample fluid have become bound to ligands on the test surfaces of a flow cell. As the first sample fluid flows through the first, second, third and fourth flow cells 3a-d, this sensor 50 is operated to detect if molecules of the first sample fluid have become bound to ligands on the test surfaces of any of the first, second, third or fourth flow cells 3a-d.

The first sample fluid will flow out of the respective first, second, third and fourth flow cells 3a-d, via the respective outputs 3a″-3d″ of the respective flow cells 3a-d. The first sample fluid which flows out of the first flow cell 3a will flow through the first valve 6a of the second selector valve unit 6, and into the first waste reservoir 23; the first sample fluid which flows out of the second flow cell 3b will flow through the second valve 6b of the second selector valve unit 6, and into the first waste reservoir 23; the first sample fluid which flows out of the third flow cell 3c will flow through the third valve 6c of the second selector valve unit 6, and into the first waste reservoir 23; the first sample fluid which flows out of the fourth flow cell 3d will flow through the fourth valve 6d of the second selector valve unit 6, and into the first waste reservoir 23.

Optionally, the flow cells 3a-d in the flow cell unit 3 are then rinsed in a rinsing step: The second pumping means 11 may be selectively configured to dispense buffer fluid which can be used to rinse the flow cells 3a-d. In order to rinse the flow cells 3a-d each of the n pumping means (12′a-12′h) are configured so that it does not provide any positive or negative pressure (e.g. each of the n pumping means (12′a-12′h) are turned off); the second selector valve unit 6 is moved into its sixth position wherein all of the first, second, third and fourth valves 6a-d of the second selector valve unit 6 are closed; the first valve 22 is configured to be in its open configuration so that fluid can flow from the second junction 105 through the first valve 22 and into the second waste reservoir 24; the third selector valve unit 17 is arranged into it fifth configuration so that the second pumping means 11 is fluidly connected to all of the flow cells 3a-d. The second pumping means 11 is then operated to dispense buffer fluid by providing positive pressure. Specifically, the second pumping means 11 is typically first emptied by configuring the switching valve 11b to fluidly connect the syringe 11a to the waste reservoir 11d, and then dispensing the fluid contents of the syringe 11a into the waste reservoir 11d. Then the switching valve 11b is configured to fluidly connect the syringe 11a to the buffer reservoir 11c, so as to allow buffer fluid which is preset in the buffer reservoir 11c, to pass from the buffer reservoir 11c to the syringe 11a. The syringe 11a is then filled with buffer fluid from the buffer reservoir 11c by aspirating buffer fluid from the buffer reservoir 11c. The switching valve 11b is then configured to fluidly connect the syringe 11a to the output 11e; the buffer fluid contained in the syringe 11a is then dispensed from the syringe 11a. The buffer fluid flows from the second pumping means 11, through all of the valves 17a-d of the third selector valve unit 17, along the buffer inlet conduits 16a, 16b, 16c, 16d, and into all of the flow cells 3a-d in the flow cell unit 3 via the subsidiary conduits 19a, 19b, 19c, 19d. Since the second selector valve unit 6 is in its sixth position the buffer fluid will be prevented from flowing along the subsidiary conduits 19a, 19b, 19c, 19d and into the first waste reservoir 23, thus the buffer fluid is forced to flow along the subsidiary conduits 19a, 19b, 19c, 19d to the flow cells 3a-d. When the buffer fluid flows through the flow cells 3a-d it will rinse the flow cells 3a-d. The buffer fluid flows through the flow cells 3a-d and along the single conduit 5′, through the second junction 105, through the first valve 22 (which is opened) and into the second waste reservoir 24. Preferably, the assembly is kept in this configuration for a predefined amount of time until the flow cells 3a-d have been rinsed for said predefined amount of time. Accordingly the second pumping means 11 is maintained in its configuration where it dispenses buffer fluid for said predefined amount of time. After said predefined amount of time has lapsed, the second pumping means 11 is configured to stop dispensing buffer fluid (e.g. the second pumping means 11 is turned off); and the first valve 22 is configured to be in its closed configuration so that it blocks the flow of fluid from the second junction 105 into the second waste reservoir 24.

The second pumping means 12′b is then configured to provide a positive pressure; the positive pressure forces the second sample fluid present in the second buffer conduit 8b, to flow through all of the m flow cells 3a-d. Specifically the positive pressure provided by the single pumping mean 12 flows into the second buffer conduit 8b where the positive pressure pushes the second sample fluid along the second buffer conduit 8b, into the second input 7b″ of the second set 107″ of inputs of the switching valve unit 7, and then into the second injection conduit 9b via the second output 7b′″ of the switching valve unit 7, along the second injection conduit 9b, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the second sample fluid will contact the test surfaces of each of the first, second, third and fourth flow cells 3a-d; and more specifically will contact ligands which are present on said respective test surfaces. If the second sample fluid contains molecules which can bind to the ligands which are on the test surfaces of any the first, second, third and fourth flow cells 3a-d, these molecules will become bound to those ligands when the second sample fluid flows through that flow cell.

As the second sample fluid flows through the first, second, third and fourth flow cells 3a-d, this sensor 50 is operated to detect if molecules of the second sample fluid have become bound to ligands on the test surfaces of any of the first, second, third or fourth flow cells 3a-d.

The second sample fluid will flow out of the respective first, second, third and fourth flow cells 3a-d, via the respective outputs 3a″-3d″ of the respective flow cells 3a-d. The second sample fluid which flows out of the first flow cell 3a will flow through the first valve 6a of the second selector valve unit 6, and into the first waste reservoir 23; the second sample fluid which flows out of the second flow cell 3b will flow through the second valve 6b of the second selector valve unit 6, and into the first waste reservoir 23; the second sample fluid which flows out of the third flow cell 3c will flow through the third valve 6c of the second selector valve unit 6, and into the first waste reservoir 23; the second sample fluid which flows out of the fourth flow cell 3d will flow through the fourth valve 6d of the second selector valve unit 6, and into the first waste reservoir 23.

Optionally, the above-mentioned rinsing step is performed again.

The third pumping means 12′c is then configured to provide a positive pressure; the positive pressure forces the third sample fluid present in the third buffer conduit 8c, to flow through all of the m flow cells 3a-d. Specifically the positive pressure provided by the single pumping mean 12 flows into the third buffer conduit 8c where the positive pressure pushes the third sample fluid along the third buffer conduit 8c, into the s third input 7c″ of the second set 107″ of inputs of the switching valve unit 7, and then into the third injection conduit 9c via the third output 7b′″ of the switching valve unit 7, along the third injection conduit 9c, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the third sample fluid will contact the test surfaces of each of the first, second, third and fourth flow cells 3a-d; and more specifically will contact ligands which are present on said respective test surfaces. If the third sample fluid contains molecules which can bind to the ligands which are on the test surfaces of any the first, second, third and fourth flow cells 3a-d, these molecules will become bound to those ligands when the third sample fluid flows through that flow cell.

As the third sample fluid flows through the first, second, third and fourth flow cells 3a-d, this sensor 50 is operated to detect if molecules of the third sample fluid have become bound to ligands on the test surfaces of any of the first, second, third or fourth flow cells 3a-d.

The third sample fluid will flow out of the respective first, second, third and fourth flow cells 3a-d, via the respective outputs 3a″-3d″ of the respective flow cells 3a-d. The third sample fluid which flows out of the first flow cell 3a will flow through the first valve 6a of the second selector valve unit 6, and into the first waste reservoir 23; the third sample fluid which flows out of the second flow cell 3b will flow through the second valve 6b of the second selector valve unit 6, and into the first waste reservoir 23; the third sample fluid which flows out of the third flow cell 3c will flow through the third valve 6c of the second selector valve unit 6, and into the first waste reservoir 23; the third sample fluid which flows out of the fourth flow cell 3d will flow through the fourth valve 6d of the second selector valve unit 6, and into the first waste reservoir 23.

Optionally, the above-mentioned rinsing step is performed again.

The fourth pumping means 12′d is then configured to provide a positive pressure; the positive pressure forces the fourth sample fluid present in the fourth buffer conduit 8d, to flow through all of the m flow cells 3a-d. Specifically the positive pressure provided by the single pumping mean 12 flows into the fourth buffer conduit 8d where the positive pressure pushes the fourth sample fluid along the fourth buffer conduit 8d, into the fourth input 7d″ of the second set 107″ of inputs of the switching valve unit 7, and then into the fourth injection conduit 9d via the fourth output 7d′″ of the switching valve unit 7, along the fourth injection conduit 9d, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the fourth sample fluid will contact the test surfaces of each of the first, second, third and fourth flow cells 3a-d; and more specifically will contact ligands which are present on said respective test surfaces. If the fourth sample fluid contains molecules which can bind to the ligands which are on the test surfaces of any the first, second, third and fourth flow cells 3a-d, these molecules will become bound to those ligands when the fourth sample fluid flows through that flow cell.

As the fourth sample fluid flows through the first, second, third and fourth flow cells 3a-d, this sensor 50 is operated to detect if molecules of the fourth sample fluid have become bound to ligands on the test surfaces of any of the first, second, third or fourth flow cells 3a-d.

The fourth sample fluid will flow out of the respective first, second, third and fourth flow cells 3a-d, via the respective outputs 3a″-3d″ of the respective flow cells 3a-d. The fourth sample fluid which flows out of the first flow cell 3a will flow through the first valve 6a of the second selector valve unit 6, and into the first waste reservoir 23; the fourth sample fluid which flows out of the second flow cell 3b will flow through the second valve 6b of the second selector valve unit 6, and into the first waste reservoir 23; the fourth sample fluid which flows out of the third flow cell 3c will flow through the third valve 6c of the second selector valve unit 6, and into the first waste reservoir 23; the fourth sample fluid which flows out of the fourth flow cell 3d will flow through the fourth valve 6d of the second selector valve unit 6, and into the first waste reservoir 23.

Optionally, the above-mentioned rinsing step is performed again.

The fifth pumping means 12′e is then configured to provide a positive pressure; the positive pressure forces the fifth sample fluid present in the fifth buffer conduit 8e, to flow through all of the m flow cells 3a-d. Specifically the positive pressure provided by the single pumping mean 12 flows into the fifth buffer conduit 8e where the positive pressure pushes the fifth sample fluid along the fifth buffer conduit 8e, into the fifth input 7e″ of the second set 107″ of inputs of the switching valve unit 7, and then into the fifth injection conduit 9e via the fifth output 7e′″ of the switching valve unit 7, along the fifth injection conduit 9e, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the fifth sample fluid will contact the test surfaces of each of the first, second, third and fourth flow cells 3a-d; and more specifically will contact ligands which are present on said respective test surfaces. If the fifth sample fluid contains molecules which can bind to the ligands which are on the test surfaces of any the first, second, third and fourth flow cells 3a-d, these molecules will become bound to those ligands when the fifth sample fluid flows through that flow cell.

As the fifth sample fluid flows through the first, second, third and fourth flow cells 3a-d, this sensor 50 is operated to detect if molecules of the fifth sample fluid have become bound to ligands on the test surfaces of any of the first, second, third or fourth flow cells 3a-d.

The fifth sample fluid will flow out of the respective first, second, third and fourth flow cells 3a-d, via the respective outputs 3a″-3d″ of the respective flow cells 3a-d. The fifth sample fluid which flows out of the first flow cell 3a will flow through the first valve 6a of the second selector valve unit 6, and into the first waste reservoir 23; the fifth sample fluid which flows out of the second flow cell 3b will flow through the second valve 6b of the second selector valve unit 6, and into the first waste reservoir 23; the fifth sample fluid which flows out of the third flow cell 3c will flow through the third valve 6c of the second selector valve unit 6, and into the first waste reservoir 23; the fifth sample fluid which flows out of the fourth flow cell 3d will flow through the fourth valve 6d of the second selector valve unit 6, and into the first waste reservoir 23.

Optionally, the above-mentioned rinsing step is performed again.

The sixth pumping means 12′f is then configured to provide a positive pressure; the positive pressure forces the sixth sample fluid present in the sixth buffer conduit 8f, to flow through all of the m flow cells 3a-d. Specifically the positive pressure provided by the single pumping mean 12 flows into the sixth buffer conduit 8f where the positive pressure pushes the sixth sample fluid along the sixth buffer conduit 8f, into the sixth input 7e″ of the second set 107″ of inputs of the switching valve unit 7, and then into the sixth injection conduit 9f via the sixth output 7f′ of the switching valve unit 7, along the sixth injection conduit 9f, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the sixth sample fluid will contact the test surfaces of each of the first, second, third and fourth flow cells 3a-d; and more specifically will contact ligands which are present on said respective test surfaces. If the sixth sample fluid contains molecules which can bind to the ligands which are on the test surfaces of any the first, second, third and fourth flow cells 3a-d, these molecules will become bound to those ligands when the sixth sample fluid flows through that flow cell.

As the sixth sample fluid flows through the first, second, third and fourth flow cells 3a-d, this sensor 50 is operated to detect if molecules of the sixth sample fluid have become bound to ligands on the test surfaces of any of the first, second, third or fourth flow cells 3a-d.

The sixth sample fluid will flow out of the respective first, second, third and fourth flow cells 3a-d, via the respective outputs 3a″-3d″ of the respective flow cells 3a-d. The sixth sample fluid which flows out of the first flow cell 3a will flow through the first valve 6a of the second selector valve unit 6, and into the first waste reservoir 23; the sixth sample fluid which flows out of the second flow cell 3b will flow through the second valve 6b of the second selector valve unit 6, and into the first waste reservoir 23; the sixth sample fluid which flows out of the third flow cell 3c will flow through the third valve 6c of the second selector valve unit 6, and into the first waste reservoir 23; the sixth sample fluid which flows out of the fourth flow cell 3d will flow through the fourth valve 6d of the second selector valve unit 6, and into the first waste reservoir 23.

Optionally, the above-mentioned rinsing step is performed again.

The seventh pumping means 12′g is then configured to provide a positive pressure; the positive pressure forces the seventh sample fluid present in the seventh buffer conduit 8g, to flow through all of the m flow cells 3a-d. Specifically the positive pressure provided by the single pumping mean 12 flows into the seventh buffer conduit 8g where the positive pressure pushes the seventh sample fluid along the seventh buffer conduit 8g, into the seventh input 7g″ of the second set 107″ of inputs of the switching valve unit 7, and then into the seventh injection conduit 9g via the seventh output 7g′″ of the switching valve unit 7, along the seventh injection conduit 9g, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23. Accordingly the seventh sample fluid will contact the test surfaces of each of the first, second, third and fourth flow cells 3a-d; and more specifically will contact ligands which are present on said respective test surfaces. If the seventh sample fluid contains molecules which can bind to the ligands which are on the test surfaces of any the first, second, third and fourth flow cells 3a-d, these molecules will become bound to those ligands when the seventh sample fluid flows through that flow cell.

As the seventh sample fluid flows through the first, second, third and fourth flow cells 3a-d, this sensor 50 is operated to detect if molecules of the seventh sample fluid have become bound to ligands on the test surfaces of any of the first, second, third or fourth flow cells 3a-d.

The seventh sample fluid will flow out of the respective first, second, third and fourth flow cells 3a-d, via the respective outputs 3a″-3d″ of the respective flow cells 3a-d. The seventh sample fluid which flows out of the first flow cell 3a will flow through the first valve 6a of the second selector valve unit 6, and into the first waste reservoir 23; the seventh sample fluid which flows out of the second flow cell 3b will flow through the second valve 6b of the second selector valve unit 6, and into the first waste reservoir 23; the seventh sample fluid which flows out of the third flow cell 3c will flow through the third valve 6c of the second selector valve unit 6, and into the first waste reservoir 23; the seventh sample fluid which flows out of the fourth flow cell 3d will flow through the fourth valve 6d of the second selector valve unit 6, and into the first waste reservoir 23.

Optionally, the above-mentioned rinsing step is performed again.

The eighth pumping means 12′h is then configured to provide a positive pressure; the positive pressure forces the eighth sample fluid present in the eighth buffer conduit 8h, to flow through all of the m flow cells 3a-d. Specifically the positive pressure provided by the single pumping mean 12 flows into the eighth buffer conduit 8h where the positive pressure pushes the eighth sample fluid along the eighth buffer conduit 8h, into the eighth input 7h″ of the second set 107″ of inputs of the switching valve unit 7, and then into the eighth injection conduit 9h via the eighth output 7h′″ of the switching valve unit 7, along the eighth injection conduit 9h, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23.

Accordingly the eighth sample fluid will contact the test surfaces of each of the first, second, third and fourth flow cells 3a-d; and more specifically will contact ligands which are present on said respective test surfaces. If the eighth sample fluid contains molecules which can bind to the ligands which are on the test surfaces of any the first, second, third and fourth flow cells 3a-d, these molecules will become bound to those ligands when the eighth sample fluid flows through that flow cell.

As the eighth sample fluid flows through the first, second, third and fourth flow cells 3a-d, this sensor 50 is operated to detect if molecules of the eighth sample fluid have become bound to ligands on the test surfaces of any of the first, second, third or fourth flow cells 3a-d.

The eighth sample fluid will flow out of the respective first, second, third and fourth flow cells 3a-d, via the respective outputs 3a″-3d″ of the respective flow cells 3a-d. The eighth sample fluid which flows out of the first flow cell 3a will flow through the first valve 6a of the second selector valve unit 6, and into the first waste reservoir 23; the eighth sample fluid which flows out of the second flow cell 3b will flow through the second valve 6b of the second selector valve unit 6, and into the first waste reservoir 23; the eighth sample fluid which flows out of the third flow cell 3c will flow through the third valve 6c of the second selector valve unit 6, and into the first waste reservoir 23; the eighth sample fluid which flows out of the fourth flow cell 3d will flow through the fourth valve 6d of the second selector valve unit 6, and into the first waste reservoir 23.

Optionally, the above-mentioned rinsing step is performed again.

Advantageously, in the present embodiment, rapid screening of a plurality of sample fluids, to identify if any one or more of said sample fluids have molecules which can bind to predefined ligands (said predefined ligands being of the type provided on the test surfaces of one or more of the flow cells 3a-d) can be achieved. In this example each of the eight sample fluids which were present in the respective reservoirs 1a-h of a first row of the sample tray holder 1 are passed consecutively, without any substantial delay between sample fluids, through the flow cells 3a-d in the flow cell unit 3, and the sensor 50 is used to detect if the molecules bind to ligands on the test surfaces of the flow cells as each respective sample fluid is passed through the flow cells 3a-d.

In a preferred embodiment, the respective sample fluids are flowed through the flow cells 3a-d in rapid succession, this is to ensure that the molecules of the sample fluids contact the same test surface (of the flow cells 3a-d) in rapid succession. Preferably, the time period between passing flowing consecutive sample fluids through the flow cells 3a-d is less than 10 seconds, or is preferably is less than below 5 seconds, or is more preferably is less than 2 seconds, or is most preferably is less than 1 second. For example the time period between the time when the first pumping means 12′a is configured to provide a positive pressure which forces the first sample fluid present in the first injection conduit 9a, to flow through all of the m flow cells 3a-d, and the time when the second pumping means 12′b is configured to provide a positive pressure which forces the second sample fluid present in the second injection conduit 9b, to flow through all of the m flow cells 3a-d, is less than 10 seconds (or is preferably is less than below 5 seconds, or is more preferably is less than 2 seconds, or is most preferably is less than 1 second). Likewise the time period between the time when the second pumping means 12′b is configured to provide a positive pressure which forces the second sample fluid present in the second injection conduit 9c, to flow through all of the m flow cells 3a-d, and the time when the third pumping means 12′c is configured to provide a positive pressure which forces the third sample fluid present in the third injection conduit 9c, to flow through all of the m flow cells 3a-d, is less than 10 seconds (or is preferably is less than below 5 seconds, or is more preferably is less than 2 seconds, or is most preferably is less than 1 second). The same is true for all of the respective sample fluids—in other words, the time period between the time when a sample fluid present in an injection conduit is forced by any of the n pumping means 12′a-h, to flow through all of the m flow cells 3a-d, and the time when the next sample fluid present in an injection conduit is forced by any of the n pumping means 12′a-h, to flow through all of the m flow cells 3a-d, is less than 10 seconds (or is preferably is less than below 5 seconds, or is more preferably is less than 2 seconds, or is most preferably is less than 1 second).

In another preferred embodiment, in order to minimize sample dilution edge effects due to Taylor Aris dispersion, any of the n pumping means 12′a-h dispenses at a high flowrate when it is configured to provide a positive pressure which forces sample fluid present in an injection conduit 9a-h, to flow through all of the flow cells 3a-d. Likewise the pumping means 11 dispenses at a high flowrate during the rinsing step. Preferably, the respective pumping means dispense at a flowrate above 500 microliters per minute, or above 1 millilitres per minute, or above 2 millilitres per minute, or above 5 millilitres per minute.

In a further preferred embodiment, the time-resolved sensor signals from the sensor 50 are recorded at a rate of more than 50 points per seconds, or more than 100 points per second, or more than 100 points per second, while sample fluids flow through all of the flow cells 3a-d or at least during the rinsing step; this allows to resolve fast transitions and fast off-rates.

Optionally, after all of the first, second, third, fourth, fifth, sixth, seventh, and eighth sample fluids have been passed through the flow cells 3a-d the needle unit 2 is moved (preferably by the moveably stage 2′) to the washing station 28. At the washing station 28 the hollow needles 2a-d are washed, in the manner described for the previous embodiment 101, to avoid contamination of sample fluids (residing in another, second, row of reservoirs 1a-h provided in the sample tray holder 1) which will be subsequently aspirated into the respective hollow needles 2a-h of the needle unit 2.

The afore mentioned steps are then repeated so that each of the sample fluids contained in said other row of reservoirs 1a′-h′ are screened.

If the sample tray holder 1 comprises more than one other row of reservoirs which contain sample fluids which are to be screened then, preferably, the above-mentioned steps are repeated until the sample fluids contained in all of the rows of reservoirs have been screened.

In the above embodiment the sample fluids being aspirated into the hollow needles 2a-h from the sample tray holder 1, however it should be understood that this is not an essential step; in another embodiment, instead of the sample fluids being aspirated into the hollow needles 2a-h from the sample tray holder 1, the sample fluids are already present in one or more of said n hollow needles 2a-h of said needle unit 2. For example a first sample fluid is present in the first hollow needle 2a; a second sample fluid is present in the second hollow needle 2b; a third sample fluid is present in the first hollow needle 2c; a fourth sample fluid is present in the fourth hollow needle 2d; a fifth sample fluid is present in the fifth hollow needle 2e; a sixth sample fluid is present in the sixth hollow needle 2f; a seventh sample fluid is present in the seventh hollow needle 2g; an eighth sample fluid is present in the eighth hollow needle 2h.

Also it should be understood that the present invention is not limited to requiring that the sample fluids in each of the n hollow needles 2a-h be different sample fluids (i.e. different compositions); on the contrary in another embodiment some of the sample fluids in the n hollow needles 2a-h have the same composition e.g. two of more of the n hollow needles may have sample fluids which have the same composition. It can be that the composition of the sample fluids is entirely unknown. The sample fluids in each of the n hollow needles 2a-h could have come from the same or be different sources.

As mentioned above, the sensor 50 is operated to detect if molecules of a sample fluid have become bound to ligands on the test surfaces of any of the first, second, third or fourth flow cells 3a-d. One way to detect using the sensor 50 if molecules of a particular sample fluid have become bound to ligands on the test surface of any of a flow cell 3a-d is to compare an output signal of the sensor 50 to a reference output signal which is a signal which the sensor 50 outputs when said sample fluid flows through said flow cell, hereafter called reference flow cell, when no ligands are provided on its test surface. Alternatively, the test surface of the reference flow cell may contain reference ligands, such as ligands with similar characteristics as a test ligand but lacking a specific molecular structure relevant to a specific molecular binding. Thus, the method may further comprise the steps of, for each of the respective m (eight) sample fluids: passing that sample fluid through the reference flow cell; obtaining an output signal from the sensor 50 as the sample fluid passes through the reference flow cell, wherein this output signal defines a reference signal.

Then any of the above-mentioned steps of operating the sensor 50 to detect if molecules of a sample fluid have become bound to ligands on the test surfaces of any of the first, second, third or fourth flow cells 3a-d, may comprise, obtaining an output signal from the sensor as the sample fluid passes through the first, second, third or fourth flow cells 3a-d (one or more of which are not the reference flow cell); and comparing said output signal with said reference signal. It is then determined that a molecule of said sample fluid has bound to the ligands of a flow cell if the output signal differs from the reference signal. Most preferably, the steps of passing that sample fluid through the reference flow cell and passing that sample fluid through one or more of the flow cells which are not the reference flow cell, are executed simultaneously. In other words, most preferable, in the assembly 101 one of the flow cells 3a-d in the flow cell unit may be a reference flow cell; and during the method of screening a plurality of sample fluids, the step of passing that sample fluid through the reference flow cell takes place simultaneously to passing that sample fluid through the other flow cells (which are not reference flow cells).

Optionally, prior to performing the method of screening a plurality of sample fluids, to identify if any one or more of said sample fluids have molecules which can bind to predefined ligands (said predefined ligands being of the type provided on the test surfaces of one or more of the flow cells 3a-d) described above, a further step of providing ligands on the respective test surfaces of one or more of said m flow cells 3a-h in said flow cell unit 3 of the assembly 103 may be performed.

Most preferably such a further step of providing ligands on the respective test surfaces of one or more of said m flow cells 3a-h in said flow cell unit 3 would be performed prior to using the assembly 101 to screen one or more sample fluids for molecules which can bind to predefined ligands (said predefined ligands being of the type provided on the test surfaces of one or more of the flow cells 3a-d)), and even prior to providing sample fluids in said n hollow needles 2a-h. Most preferably the step of providing ligands on the respective test surfaces of one or more of said m flow cells 3a-h in said flow cell unit 3 comprises providing ligands on the test surfaces of a plurality (at least two) said flow cells 3a-h in said flow cell unit 3, wherein the type of ligands provided on the test surfaces differ between flow cells such that the test surfaces of said plurality of flow cells have different types of ligands.

In the following there will be described the steps carried out to provide: ligands of a first type, which can bind to a first type of molecule, are provided on the test surface of the first flow cell 3a; ligands of a second type, which can bind to a second type of molecule, are provided on the test surface of the second flow cell 3b; ligands of a third type, which can bind to a third type of molecule, are provided on the test surface of the third flow cell 3c; ligands of a fourth type, which can bind to a fourth type of molecule, are provided on the test surface of the fourth flow cell 3d (it should be understood that it is optional to provide ligands of a fourth type on the test surface of the fourth flow cell 3d; in a variation of this embodiment no ligands are provided on the test surface of the fourth flow cell 3b, so in other words the test surface of the fourth flow cell 3b is without any ligands):

A first immobilization reagent is provided in a first reservoir 1a of a row in said sample try holder 1. It should be understood that the first immobilization reagent may comprise any suitable immobilization reagent; for example the first immobilization reagent may comprise qa mixture of 1-Ethyl-3-(3-dimethylaminopropyl)carbodiimide(EDC) and N-hydroxysuccinimide (NHS) and/or Ethanolamine for amine coupling, and/or NiCl2 for His-Tag coupling, and/or any other suitable reagents. In this example the first immobilization reagent comprises a 1:1 mixture of EDC/NHS.

r different types of ligands are provided in respective r different reservoirs 1a-h of said row of said sample tray holder 1, wherein r is greater than one. As mentioned in this example four different types of ligands will be provided on the respective test surfaces of the respective flow cells 3a-d accordingly in this example r is four. It should be understood that r may have any value greater than one. In this example r is equal to m so four different types of ligands are provided in the respective second, third, fourth and fifth reservoirs 1b′-f′ of said row (i.e. the same row to which said first reservoir 1a′ belongs) of said sample tray holder 1:

Ligands of a first type (referred to hereafter as first ligands) are provided in the second reservoir 1b of said row. In this example said first ligands, optionally diluted in acetate buffer, are provided in the second reservoir 1b.

Ligands of a second type (referred to hereafter as second ligands) are provided in the third reservoir 1c. In this example said second ligands, optionally diluted in acetate buffer, are provided in the second reservoir 1c.

Ligands of a third type (referred to hereafter as third ligands) are provided in the fourth reservoir 1d′. In this example said third ligands, optionally diluted in acetate buffer, is provided in the fourth reservoir 1d′.

In this example ligands of a fourth type (referred to hereafter as fourth ligands) are provided in the fifth reservoir 1e. In this example said fourth ligands, optionally diluted in acetate buffer, are provided in the fifth reservoir 1e. In this particular example the fourth ligands are the same type as either the first, second, or third ligands, with the exception that the fourth ligands are modified (genetically) so that the fourth ligands lack any binding sites. However, it should be understood that it is optional to provide ligands of a fourth type in the fifth reservoir 1e; in a variation of this embodiment no ligands are provided on the test surface of the fourth flow cell 3b, in which case no ligands are provided in the fifth reservoir 1e.

A second immobilization reagent is provided in at least one of the remaining reservoirs 1f-h in said row. In this example the second immobilization reagent comprises Ethanolamine, however it will be understood that the second immobilization reagent may take any suitable form. In this example the second immobilization reagent is provided in the sixth reservoir 1f of said row.

Optionally a buffer is provided in the seventh and eighth reservoirs 1g, 1h of said row.

The needle unit 2 is then arranged so that each of the respective n hollow needles 2a-h is simultaneously inserted into a respective reservoir 1a-h; at least the tip of each hollow needle 2a-h is simultaneously submerged in the respective sample fluid contained in the respective reservoir 1a-h into which it is inserted. It should be noted that the moveable stage 2′ may move the needle unit 2 into this position.

Preferably the second selector valve unit 6 is then moved into its sixth position wherein all of the first, second, third and fourth valves 6a-d of the second selector valve unit 6 are closed. The second valve 22 is also configured to be closed, so that the first valve 22 can block the flow of fluid from the second junction 105 into the second waste reservoir 24. When the second selector valve unit 6 is in its sixth position and the second valve 22 is closed, the flow of fluids along the n injection conduits 9a-h is restricted; accordingly fluids flowing from the hollow needles 2a-h into the n inputs 7a′-7h′ of the first set 107′ of inputs of the switching valve unit 7, will flow into the respective buffer conduits 8a-h via the n inputs 7a″-7h″ of the second set 107″ of inputs of the switching valve unit 7.

The switching valve unit 7 is then arranged in its first configuration so that the switching valve unit 7 simultaneously fluidly connects each of the n inputs 7a′-7h′ of the first set 107′ of inputs with a respective n output 7a″′-7h′″ (specifically the switching valve unit 7 simultaneously fluidly connects all of the first, second, third, fourth, fifth, sixth, seventh and eight inputs 7a′-7h′ of the first set 107′ of inputs with the respective first, second, third, fourth, fifth, sixth, seventh and eighth outputs 7a″′-7h′″).

Each of then pumping means (12′a-12′h) is then configured to provide a negative pressure (e.g. negative fluid pressure) so that respective fluids in each of said reservoirs 1a-h are aspirated, simultaneously, into the respective hollow needles 2a-h, through the respective hollow needles 2a-h and through the switching valve unit 7, and into respective buffer conduits 8a-h: Specifically, in this example the first immobilization reagent is aspirated into the first hollow needle 2a of said needle unit 2, and from there the negative pressure forces the first immobilization reagent to flow through the first hollow needle 2a, through the switching valve unit 7, and into the first buffer conduit 8a; said first ligands (which are optionally diluted in an acetate buffer) are aspirated into the second hollow needle 2b and from there the negative pressure forces the first ligands to flow through the second hollow needle 2b, through the switching valve unit 7, and into the second buffer conduit 8b; said second ligands (which are optionally diluted in an acetate buffer) are aspirated into the third hollow needle 2c and from there the negative pressure forces the second ligands to flow through the third hollow needle 2c, through the switching valve unit 7, and into the third buffer conduit 8c; said third ligands (which are optionally diluted in an acetate buffer) are aspirated into the fourth hollow needle 2d and from there the negative pressure forces the third ligands to flow through the fourth hollow needle 2d, through the switching valve unit 7, and into the fourth buffer conduit 8d; said fourth ligands (which are optionally diluted in an acetate buffer) are aspirated into the fifth hollow needle 2e and from there the negative pressure forces the fourth ligands to flow through the fifth hollow needle 2e, through the switching valve unit 7, and into the fifth buffer conduit 8e; said second immobilization reagent is aspirated into the sixth hollow needle 2f and from there the negative pressure forces the second immobilization reagent to flow through the sixth hollow needle 2f, through the switching valve unit 7, and into the sixth buffer conduit 8f; and optionally, said buffer fluid in the seventh reservoir 1g is aspirated into the seventh needle 2g, and from there the negative pressure forces the buffer fluid to flow through the seventh hollow needle 2g, through the switching valve unit 7, and into the seventh buffer conduit 8g; and optionally, said buffer fluid in the eighth reservoir 1h is aspirated into the eighth hollow needle 2h and from there the negative pressure forces the buffer fluid to flow through the eighth hollow needle 2h, through the switching valve unit 7, and into the eighth buffer conduit 8h.

Accordingly, after this step has been performed the first buffer conduit 8a contains the first immobilization reagent; the second buffer conduit 8b contains the said first ligands (which are optionally diluted in an acetate buffer); the third buffer conduit 8c contains said second ligands (which are optionally diluted in an acetate buffer); the fourth buffer conduit 8d contains said third ligands (which are optionally diluted in an acetate buffer); the fifth buffer conduit 8e contains said fourth ligands (which are optionally diluted in an acetate buffer); the sixth buffer conduit 8f contains said second immobilization reagent; and optionally, the seventh buffer conduit 8g contains buffer fluid; and optionally, the eighth buffer conduit 8h contains buffer fluid.

The switching valve unit 7 arranged in its second configuration so that the switching valve unit 7 blocks the flow of fluid between said n inputs 7a′-7h′ of the first set 107′ of inputs and the n outputs 7a″′-7h″′. In this second configuration the switching valve unit 7 prevents fluid, which is present in any of the n buffer conduits 8a-h, from flowing back into the hollow needles 2a-h.

The second selector valve unit 6 is arranged in its fifth position so that second selector valve unit 6 fluidly connects all of the outputs 3a″-d″ of all of the flow cells 3a-d in the flow cell unit 3 with the first waste reservoir 23.

The first pumping means 12′a is then configured to provide a positive pressure; the positive pressure forces the first immobilization reagent present in the first buffer conduit 8a, to flow through all of the m flow cells. Specifically the positive pressure provided by the single pumping mean 12 flows into the first buffer conduit 8a where the positive pressure pushes the first immobilization reagent along the first buffer conduit 8a, into the first input 7a″ of the second set 107″ of inputs of the switching valve unit 7, and then into the first injection conduit 9a via the first output 7a′″ of the switching valve unit 7, along the first injection conduit 9a, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23.

When the first immobilization reagent flows through the first, second, third and fourth flow cells 3a-d, the first immobilization reagent will contact the test surfaces of each flow cell 3a-d, thereby activating the test surfaces. Activation of a test surface of a flow cell means providing an immobilization agent (i.e. an agent which can hold a ligand) on the test surface of the flow cell. An immobilization agent may include reactive groups by carboxyl activation for example. Importantly, once a test surface of a flow cell has been activated by the first immobilization agent, ligands which subsequently contact that test surface (e.g. ligands which flow over that test surface) will become attached to said test surface. The ligands which have become attached to the test surface, can in turn bind to molecules in sample fluids which flow through said flow cell. The sensor 50 can be used to detect if molecules in a sample fluid have bound to the ligands on the test surface of a flow cell.

Optionally, the flow cells 3a-d in the flow cell unit 3 are then rinsed in a rinsing step: The second pumping means 11 may be selectively configured to dispense a buffer fluid which can be used to rinse the flow cells 3a-d. In order to rinse the flow cells 3a-d each of the n pumping means 12′a-h is configured so that it does not provide any positive or negative pressure (e.g. each of the n pumping means 12′a-h); the second selector valve unit 6 is moved into its sixth position wherein all of the first, second, third and fourth valves 6a-d of the second selector valve unit 6 are closed; the first valve 22 is configured to be in its open configuration so that fluid can flow from the second junction 105 through the first valve 22 and into the second waste reservoir 24; the third selector valve unit 17 is arranged into its fifth configuration so that the second pumping means 11 is fluidly connected to all of the flow cells 3a-d. The second pumping means 11 is then operated to dispense buffer fluid. Specifically, the second pumping means 11 is typically first emptied by configuring the switching valve 11b to fluidly connect the syringe 11a to the waste reservoir 11d, and then dispensing the fluid contents of the syringe 11a into the waste reservoir 11d. Then the switching valve 11b is configured to fluidly connect the syringe 11a to the buffer reservoir 11c, so as to allow buffer fluid which is preset in the buffer reservoir 11c, to pass from the buffer reservoir 11c to the syringe 11a. The syringe 11a is then filled with buffer fluid from the buffer reservoir 11c by aspirating buffer fluid from the buffer reservoir 11c. The switching valve 11b is then configured to fluidly connect the syringe 11a to the output 11e; the buffer fluid contained in the syringe 11a is then dispensed from the syringe 11a.

The buffer fluid flows from the second pumping means 11, through all of the valves 17a-d of the third selector valve unit 17, along the buffer inlet conduits 16a, 16b, 16c, 16d, and into all of the flow cells 3a-d in the flow cell unit 3 via the subsidiary conduits 19a, 19b, 19c, 19d. Since the second selector valve unit 6 is in its sixth position the buffer fluid will be prevented from flowing along the subsidiary conduits 19a, 19b, 19c, 19d and into the first waste reservoir 23, thus the buffer fluid is forced to flow along the subsidiary conduits 19a, 19b, 19c, 19d to the flow cells 3a-d. When the buffer fluid flows through the flow cells 3a-d it will rinse the flow cells 3a-d. The buffer fluid flows through the flow cells 3a-d and along the single conduit 5′, through the second junction 105, through the first valve 22 (which is opened) and into the second waste reservoir 24.

The assembly is kept in this configuration for a predefined amount of time until the flow cells 3a-d have been rinsed for said predefined amount of time. Accordingly the second pumping means 11 is maintained in its configuration where it dispenses buffer fluid for said predefined amount of time.

After said predefined amount of time has lapsed, the second pumping means 11 is configured to stop dispensing buffer fluid (e.g. the second pumping means 11 is turned off); and the first valve 22 is configured to be in its closed configuration so that it blocks the flow of fluid from the second junction 105 into the second waste reservoir 24.

Once the above-mentioned, optional, rinsing of the flow cells 3a-d has been performed the next steps in the method may be executed:

The second selector valve unit 6 is arranged in its first position wherein the first valve 6a is opened and the second, third, fourth valves 6b-d are closed thereby fluidly connecting the output 3a″ of the first flow cell 3a only with the first waste reservoir 23. The third selector valve unit 17 is arranged in its first configuration.

The second pumping means 12′b is then configured to provide a positive pressure; the positive pressure forces the first ligands present in the second buffer conduit 8b, to flow through the first flow cell 3a only. Specifically the positive pressure provided by the second pumping means 12′a flows into the second buffer conduit 8b where the positive pressure pushes the first ligands along the second buffer conduit 8b, into the second input 7b″ of the second set 107″ of inputs of the switching valve unit 7, and then into the second injection conduit 9b via the second output 7b′″ of the switching valve unit 7, along the second injection conduit 9b, and then along the single conduit 5′, and subsequently through the first flow cell 3a only, through the first valve 6a only of the second selector valve 6 and into the first waste reservoir 23.

Because the second selector valve 6 is in its first position, the first ligands arriving at the flow cell unit 3 from the single conduit 5′, will flow through the first flow cell 3a only (not through the second, third or fourth flow cells 3b-d) and into the first waste reservoir 23. As the first ligands flow through the first flow cell 3a they will become attached to the test surface of the first flow cell 3a (the first immobilization agent which flowed over the test surface of the first flow cell 3a in the preceding step primed the test surface of the first flow cell 3a so that the first ligands will attach to the test surface of the first flow cell 3a when the first ligands flow over the test surface of the first flow cell 3a).

Optionally, the sensor 50 is used to monitor the amount of first ligands which attach to the test surface of the first flow cell 3a. This can be done by recording the signal output by the sensor 50 as the first ligands flow through the first flow cell 3a.

Optionally, the above-mentioned rinsing step is performed again.

The second selector valve unit 6 is arranged in its second position wherein the second valve 6b is opened and the first, third, and fourth valves 6a,c,d are closed thereby fluidly connecting the output 3b″ of the second flow cell 3b only with the first waste reservoir 23. The third selector valve unit 17 is arranged in its second configuration.

The third pumping means 12′c is then configured to provide a positive pressure; the positive pressure forces the second ligands present in the third buffer conduit 8c, to flow through the second flow cell 3b only. Specifically the positive pressure provided by the third pumping means 12′c flows into the third buffer conduit 8c where the positive pressure pushes the second ligands along the third buffer conduit 8c, into the third input 7c″ of the second set 107″ of inputs of the switching valve unit 7, and then into the third injection conduit 9c via the third output 7b′″ of the switching valve unit 7, along the third injection conduit 9c, and then along the single conduit 5′, and subsequently through the second flow cell 3b only, and then through the second valve 6a only of the second selector valve 6 and into the first waste reservoir 23.

Because the second selector valve 6 is in its second position, the second ligands arriving at the flow cell unit 3 from the single conduit 5′, will flow through the second flow cell 3b only (not through the first, third or fourth flow cells 3a,c,d) and into the first waste reservoir 23. As the second ligands flow through the second flow cell 3b they will become attached to the test surface of the second flow cell 3a (the first immobilization agent which flowed over the test surface of the second flow cell 3b primed the test surface of the second flow cell 3b so that the second ligands will attach to the test surface of the second flow cell 3b when the second ligands flow over the test surface of the second flow cell 3b).

Optionally, the sensor 50 is used to monitor the amount of second ligands which attach to the test surface of the second flow cell 3b. This can be done by recording the signal output by the sensor 50 as the second ligands flow through the second flow cell 3b.

Optionally, the above-mentioned rinsing step is performed again.

The second selector valve unit 6 is arranged in its third position wherein the third valve 6c is opened and the first, second, and fourth valves 6a,b,d are closed thereby fluidly connecting the output 3c″ of the third flow cell 3c only with the first waste reservoir 23. The third selector valve unit 17 is arranged in its third configuration.

The fourth pumping means 12′d is then configured to provide a positive pressure; the positive pressure forces the third ligands present in the fourth buffer conduit 8d, to flow through the third flow cell 3c only.

Specifically the positive pressure provided by the single pumping mean 12 flows into the fourth buffer conduit 8d where the positive pressure pushes the third ligands along the fourth buffer conduit 8d, into the fourth input 7d″ of the second set 107″ of inputs of the switching valve unit 7, and then into the fourth injection conduit 9d via the fourth output 7d′″ of the switching valve unit 7, along the fourth injection conduit 9d, and then along the single conduit 5′, and subsequently through the third flow cell 3a only, and then through the third valve 6d only of the second selector valve 6 and into the first waste reservoir 23.

Because the second selector valve 6 is in its third position, the third ligands arriving at the flow cell unit 3 from the single conduit 5′, will flow through the third flow cell 3c only (not through the first, second or fourth flow cells 3a,b,d) and into the first waste reservoir 23. As the third ligands flow through the third flow cell 3c they will become attached to the test surface of the third flow cell 3c (the first immobilization agent which flowed over the test surface of the third flow cell 3c primed the test surface of the third flow cell 3c so that the third ligands will attach to the test surface of the third flow cell 3c when the third ligands flow over the test surface of the third flow cell 3b).

Optionally, the sensor 50 is used to monitor the amount of third ligands which attach to the test surface of the third flow cell 3c. This can be done by recording the signal output by the sensor 50 as the third ligands flow through the third flow cell 3c.

Optionally, the above-mentioned rinsing step is performed again.

The second selector valve unit 6 is arranged in its fourth position wherein the fourth valve 6d is opened and the first, second, and third valves 6a,b,c are closed thereby fluidly connecting the output 3d″ of the fourth flow cell 3d only with the first waste reservoir 23. The third selector valve unit 17 is arranged in its fourth configuration.

The fifth pumping means 12′e is then configured to provide a positive pressure; the positive pressure forces the fourth ligands present in the fifth buffer conduit 8e, to flow through the fourth flow cell 3d only.

Specifically the positive pressure provided by the single pumping mean 12 flows into the fifth buffer conduit 8e where the positive pressure pushes the fourth ligands along the fifth buffer conduit 8e, into the fifth input 7e″ of the second set 107″ of inputs of the switching valve unit 7, and then into the fifth injection conduit 9e via the fifth output 7e′″ of the switching valve unit 7, along the fifth injection conduit 9e, and then along the single conduit 5′, and subsequently through the fourth flow cell 3a only, and then through the fourth valve 6d only of the second selector valve 6 and into the first waste reservoir 23.

Because the second selector valve 6 is in its fourth position, the fourth ligands arriving at the flow cell unit 3 from the single conduit 5′, will flow through the fourth flow cell 3d only (not through the first, second or third flow cells 3a,b,c) and into the first waste reservoir 23. As the fourth ligands flow through the fourth flow cell 3d they will become attached to the test surface of the fourth flow cell 3d (the first immobilization agent which flowed over the test surface of the fourth flow cell 3c primed the test surface of the fourth flow cell 3d so that the fourth ligands will attach to the test surface of the fourth flow cell 3d when the fourth ligands flow over the test surface of the fourth flow cell 3d).

In this particular example the fourth ligands are the same as either the first, second, or third ligands, with the exception that the fourth ligands are modified (genetically) so that the fourth ligands lack a specific binding site. Most preferably the aim when screening a plurality of sample fluids is to identify sample(s) which have molecules which can bind to a specific binding site of a ligand. It is possible that molecules bind to other parts of the ligand (which are not binding sites), and molecules of a sample fluid which bind to other parts of the ligand which are not binding sites of the ligand, are referred to as being a sticky compound”. Advantageously, having a fourth ligands which are the same as either the first, second, or third ligands, with the exception that the fourth ligands are modified (genetically) so that the fourth ligands lack a specific binding site, allows to identify if a sample fluid contains a “sticky compound”, thus allowing to determine if molecules of a sample fluid which have bound to ligands in that flow cell have bound to the specific binding site of the ligand or have likely bound to another part of the ligand. For example, if the fourth ligands are the same as the first ligands, but are modified (genetically) so that the fourth ligands lack a specific binding site, and molecules within a sample fluid which has been passed through the flow cells 3a-d were shown (via the sensor) to bind to the first ligands in the first flow cell, and to also bind to the fourth ligands in the fourth flow cell, this indicates that the sample fluid contains a “sticky compound” and potentially the molecules of the sample fluid did not bind to the specific binding site on the first ligands but rather bound to another part of the first ligands (often such a sample fluid would not be considered as a good drug candidate for binding to equivalent ligands within the human body). If on the other hand the molecules within a sample fluid which has been passed through the flow cells 3a-d was shown (via the sensor) to bind to the first ligands in the first flow cell, but not to bind to the fourth ligands in the fourth flow cell, this indicates that sample fluid does not contain a “sticky compound” and that the molecules of the sample fluid did bind to the specific binding site on the first ligands (often such a sample fluid would be considered to be a good drug candidate for binding to equivalent ligands within the human body).

Optionally, the sensor 50 is used to monitor the amount of fourth ligands which attach to the test surface of the fourth flow cell 3d. This can be done by recording the signal output by the sensor 50 as the fourth ligands flow through the fourth flow cell 3d.

Optionally, the above-mentioned rinsing step is performed again.

It should be understood that providing the fourth flow cell with ligands (in this case fourth ligands) is an optional step; in a variation of this embodiment the fourth flow cell is not provided with any ligands on its test surface. According the test surface of the fourth flow cell 3d is without any ligands. In such a case the output of the sensor measuring binding in the fourth flow cell, when the sample fluid passes through all of the flow cells, can be used as a reference signal, to which the output of the sensor measuring binding in the first, second, and third flow cell 3a-c can be compared. When a sample fluid is passed through all of the flow cells 3a-d, and if the output of the sensor measuring binding in the first flow cell 3a, differs from the output of the sensor measuring binding in the fourth flow cell 3d, this indicates that molecules of that sample fluid have bound to the first ligands in the first flow cell 3a. Likewise when a sample fluid is passed through all of the flow cells 3a-d, and if the output of the sensor measuring binding in the second flow cell 3b, differs from the output of the sensor measuring binding in the fourth flow cell 3d, this indicates that molecules of that sample fluid have bound to the second ligands in the second flow cell 3b. Likewise, when a sample fluid is passed through all of the flow cells 3a-d, and if the output of the sensor measuring binding in the third flow cell 3c, differs from the output of the sensor measuring binding in the fourth flow cell 3d, this indicates that molecules of that sample fluid have bound to the third ligands in the third flow cell 3c.a

Referring back to the present embodiment, the second selector valve unit 6 is arranged in its fifth position so that second selector valve unit 6 fluidly connects all of the outputs 3a″-d″ of all of the flow cells 3a-d in the flow cell unit 3 with the first waste reservoir 23.

The sixth pumping means 12′f is then configured to provide a positive pressure; the positive pressure forces the second immobilization reagent present in the sixth buffer conduit 8f, to flow through all of the m flow cells 3a-d.

Specifically the positive pressure provided by the single pumping mean 12 flows into the sixth buffer conduit 8f where the positive pressure pushes the second immobilization reagent along the sixth buffer conduit 8f, into the sixth input 7f″ of the second set 107″ of inputs of the switching valve unit 7, and then into the sixth injection conduit 9f via the sixth output 7f′″ of the switching valve unit 7, along the sixth injection conduit 9f, and then along the single conduit 5′, and subsequently through the first, second, third and fourth flow cells 3a-d, through the second selector valve 6 (i.e. through the first, second, third and/or fourth valves 6a-d of the second selector valve 6) and into the first waste reservoir 23.

When the second immobilization reagent flows through the first, second, third and fourth flow cells 3a-d, the second immobilization reagent will act to passivate the test surfaces of the respective first, second, third and fourth flow cells 3a-d. In the present application to passivate a test surface means to provide a passivating agent on the test surface, wherein a passivating agent is an agent removes immobilization agents from the test surface (thereby ensuring that there is no immobilization agent which can hold a ligand present on the test surface, thus ensuring that there is no ligands present on the test surface). An example of a passivating agent includes, but is not limited to, Ethanolamine.

Optionally, the above-mentioned rinsing step is performed again.

Optionally, The second selector valve unit 6 is maintained in its fifth position so that second selector valve unit 6 fluidly connects all of the outputs 3a″-d″ of all of the flow cells 3a-d in the flow cell unit 3 with the first waste reservoir 23.

The seventh pumping means 12′g is then configured to provide a positive pressure; the positive pressure forces the optional buffer which is present in the seventh buffer conduit 8g, to flow through all of the m flow cells 3a-h.

Specifically the positive pressure provided by the single pumping mean 12 flows into the seventh buffer conduit 8g where the positive pressure pushes the buffer along the seventh buffer conduit 8g, into the seventh input 7g″ of the second set 107″ of inputs of the switching valve unit 7, and then into the seventh injection conduit 9g via the seventh output 7g′″ of the switching valve unit 7, along the seventh injection conduit 9g, and then along the single conduit 5′, and subsequently through the first, second, third and fourth flow cells 3a-d, and through the second selector valve 6 (i.e. through the first, second, third and/or fourth valves 6a-d of the second selector valve 6) and into the first waste reservoir 23.

When the buffer flows through the first, second, third and fourth flow cells 3a-d, the buffer will act to equilibrate the test surfaces within the flow cells 3a-d.

Optionally, the above-mentioned rinsing step is performed again.

Optionally, the second selector valve unit 6 is maintained in its fifth position so that second selector valve unit 6 fluidly connects all of the outputs 3a″-d″ of all of the flow cells 3a-d in the flow cell unit 3 with the first waste reservoir 23.

The eight pumping means 12′g is then configured to provide a positive pressure; the positive pressure forces the optional buffer which is present in the eighth buffer conduit 8h, to flow through all of the m flow cells 3a-h.

Specifically the positive pressure provided by the single pumping mean 12 flows into the eighth buffer conduit 8h where the positive pressure pushes the buffer along the eighth buffer conduit 8h, into the eighth input 7h″ of the second set 107″ of inputs of the switching valve unit 7, and then into the eighth injection conduit 9h via the eighth output 7h′″ of the switching valve unit 7, along the eighth injection conduit 9h, and then along the single conduit 5′, and subsequently through the first, second, third and fourth flow cells 3a-d, and through the second selector valve 6 (i.e. through the first, second, third and/or fourth valves 6a-d of the second selector valve 6) and into the first waste reservoir 23.

When the buffer flows through the first, second, third and fourth flow cells 3a-d, the buffer will act to equilibrate the test surfaces within the flow cells 3a-d. Example of suitable buffers are Phosphate-buffered saline (PBS), or buffers based on 4-(2-hydroxyethyl)-1-piperazineethanesulfonic acid) (HEPES).

Optionally, the above-mentioned rinsing step is performed again.

Optionally the hollow needles 2a-h in the needle unit 2 are then washed. Most preferably the hollow needles 2a-h are washed before they are filled with sample fluids which is to undergo screening according to the afore-method. For example after the ligands have been provided on the test surfaces of the respective flow cells 3 the moveable stage 2′ may operate to move the needle unit 2 to the wash station 28 where the hollow needles 2a-h are washed; after the hollow needles 2a-h have been washed the moveable stage 2′ moves the needle unit 2 to a position over the sample tray holder 1 where each of the needle unit 2 can aspirate sample fluids from respective reservoirs which are to be screened.

It should be understood that the first, second, third and fourth ligands may take any suitable form. The first, second, third and fourth ligands can bind to molecules which have a predefined characteristic such as having a high affinity to the ligands either via a simple lock-and-key mechanism where a molecule fits into a binding pocket of a ligand, or assisted by more complex molecular processes such as conformational changes. Thus, it can be determined which molecules in a sample fluid have said predefined characteristic of having a high affinity to the ligands, by passing the sample fluid over the surfaces of the flow cell unit 3 and then determining which molecules have become bound to the ligands. In drug discovery applications where a multitude of molecules from a compound library are screened for finding suitable drug candidates binding to a drug target, typically, the different ligands can be used to exclude non-specific binding effects, for instance by providing a drug target as first ligands, and similar molecules as the drug target but lacking a specific binding pocket as second and third and fourth ligands. Thus, any of the flow cells comprising test surfaces with immobilized second, third or fourth ligands can be used as reference flow cell. In another example, three different drug targets are provided as first, second and third ligands on the test surfaces of three flow cells, and the fourth flow cell is the reference flow cell with an empty test surface.

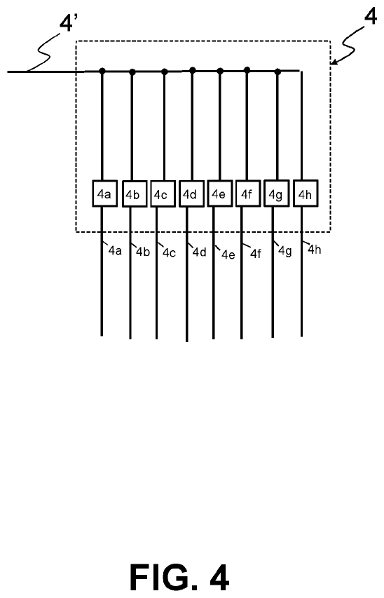

FIG. 4 shows a magnified view of one possible implementation of the first selector valve unit 4 which can be used in any of the assemblies of the present invention. As shown FIG. 4 the first selector valve 4 has a single input 4′ (which is to be fluidly connected to the single pumping mean 12 in the assembly), and plurality of outputs 4a-h (namely a first output 4a; a second output 4b; a third output 4c; a fourth output 4d; a fifth output 4e; a sixth output 4f; a seventh output 4g; an eighth output 4h). Most preferably the number of outputs 4a-h which the first selector valve unit 4 has corresponds to the number of hollow needles in the needle unit 2 (which in the above described assemblies is eight); however it will be understood that the first selector valve unit 4 could have any number of outputs 4a-h.

The first selector valve 4 comprises a plurality of valves 4a′-h′. Most preferably the number of valves 4a′-h′ corresponds to the number of outputs 4a-h; therefore in this example the first selector valve 4 comprises eight valves 4a′-h′ (namely a first valve 4a′; a second valve 4b′; a third valve 4c′; a fourth valve 4d′; a fifth valve 4e′; a sixth valve 4f′; a seventh valve 4g′; an eighth valve 4h′). Each valve 4a′-h′ is fluidly connected between the single input 4′ of the first selector valve 4 and a respective output 4a-h. Each valve 4a′-h′ can be arranged in an open configuration or a closed configuration; when a valve 4a′-h′ is in its open configuration that valve 4a′-h′ fluidly connects the single input 4′ to a respective output 4a-h, when a valve 4a′-h′ is in its closed configuration that valve 4a′-h′ blocks the flow of fluid from the single input 4′ to said respective output 4a-h.

As mentioned with respect to the exemplary assemblies 101-103, the first selector valve unit 4 can be selectively configured into any one of n+1 different configurations (wherein n is the number of hollow needles 2a-h in the needle unit 2): when the first selector valve unit 4 is in a first configuration the single input 4′ is fluidly connected to the first output 4a only; in the implementation shown in FIG. 4 the first configuration is achieved by opening the first valve 4a′ only and closing each of the other valves 4b′-4h′. When the first selector valve unit 4 is in a second configuration the single input 4′ is fluidly connected to the second output 4b only; in the implementation shown in FIG. 4 the second configuration is achieved by opening the second valve 4b′ only and closing each of the other valves 4a′,4c′-4h′. When the first selector valve unit 4 is in a third configuration the single input 4′ is fluidly connected to the third output 4c only; in the implementation shown in FIG. 4 this third configuration is achieved by opening the third valve 4c′ only and closing each of the other valves 4a′,b′,4d′-4h′. When the first selector valve unit 4 is in a fourth configuration the single input 4′ is fluidly connected to the fourth output 4d only; in the implementation shown in FIG. 4 this fourth configuration is achieved by opening the fourth valve 4d′ only and closing each of the other valves 4a′-c′ and 4e′-h′. When the first selector valve unit 4 is in a fifth configuration the single input 4′ is fluidly connected to the fifth output 4e only; in the implementation shown in FIG. 4 this fifth configuration is achieved by opening the fifth valve 4e′ only and closing each of the other valves 4a′-d′ and 4f′-h′. When the first selector valve unit 4 is in a sixth configuration the single input 4′ is fluidly connected to the sixth output 4f only; in the implementation shown in FIG. 4 this sixth configuration is achieved by opening the sixth valve 4f′ only and closing each of the other valves 4a′-e′ and 4g′-h′. When the first selector valve unit 4 is in a seventh configuration the single input 4′ is fluidly connected to the seventh output 4g only; in the implementation shown in FIG. 4 this seventh configuration is achieved by opening the seventh valve 4g′ only and closing each of the other valves 4a′-f′ and 4h′. When the first selector valve unit 4 is in an eighth configuration the single input 4′ is fluidly connected to the eighth output 4h only; in the implementation shown in FIG. 4 this eighth configuration is achieved by opening the eighth valve 4h′ only and closing each of the other valves 4a′-g′. When the first selector valve unit 4 is in a ninth configuration the single input 4′ is simultaneously fluidly connected to all of the first, second, third, fourth, fifth, sixth, seventh, and eighth outputs 4a-h. In the implementation shown in FIG. 4 the ninth configuration is achieved by opening the all of the valves 4a′-h′ (more specifically by having all of the valves 4a′-h′ open simultaneously).

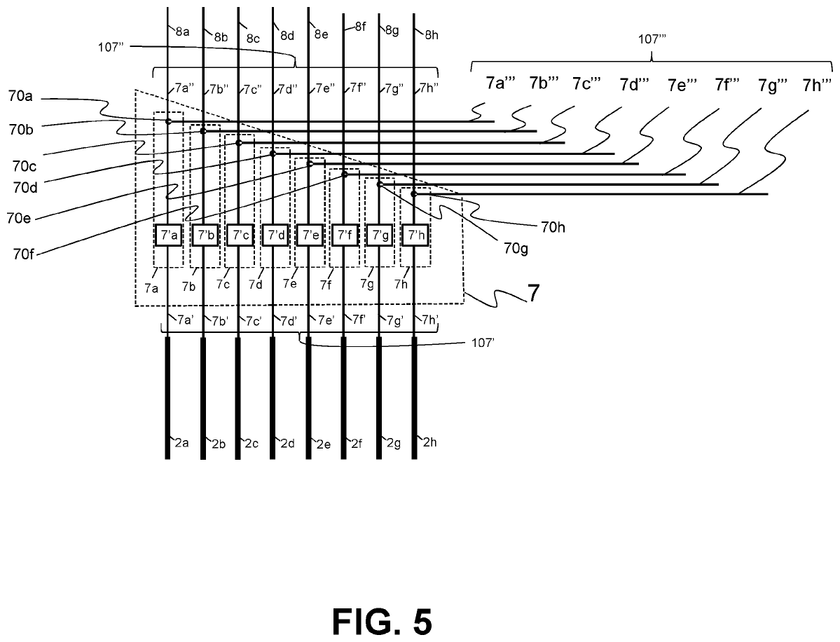

FIG. 5 shows a magnified view of one possible implementation of the switching valve unit 7 which can be used in any of the assemblies of the present invention.

As already described in the assembly embodiment above, the switching valve unit 7 has a first set 107′ of inputs 7a′-h′, and a second set 107″ of inputs 7a″-h″, and a set 107′″ of outputs 7a″′-7h″′.

The first set 107′ of inputs comprises a plurality of inputs 7a′-7h′ (in this example n inputs) (which are to be fluidly connected to respective n hollow needles 2a-h in the assembly). Most preferably the number of inputs 7a′-h′ in the first set 107′ of inputs correspond to the number of hollow needles 2a-h in the needle unit 2.

The second set 107″ of inputs comprises a plurality of inputs 7a″-7h″ (in this example n inputs) (which are to be fluidly connected to respective n outputs 4a-h of the first selector valve unit 4 in the assembly). Preferably the number of inputs 7a″-7h″ in the second set 107″ of inputs correspond to the number of inputs 7a′-h′ in the first set 107′ of inputs. Preferably the number of inputs 7a″-7h″ in the second set 107″ of inputs correspond to the number of hollow needles 2a-h in the needle unit 2. Preferably the number of inputs 7a″-7h″ in the second set 107″ of inputs correspond to the number of outputs 4a-h of the first selector valve unit 4.

The set of outputs 107′″ comprises a plurality of outputs 7a″′-7h″′. Each of said outputs 7a″′-7h′″ are to be fluidly connected to a respective injection conduit 9a-h in the assembly. Preferably the number of outputs 7a″′-7h′″ correspond to the number of hollow needles 2a-h in the needle unit 2. Preferably the number of outputs 7a″′-7h′″ correspond to the number of inputs 7a″-7h″ in the second set 107″ of inputs and also correspond to the number of inputs 7a′-h′ in the first set 107′ of inputs.

Each respective input 7a″-7h″ of the second set 107″ of inputs is fluidly connected to a respective output 7a″′-7h′″ at respective junction 70a-h. Each of said junctions 70a-h are preferably valveless.

The switching valve unit 7 further comprises a plurality of valves 7′a-7h. The number of valves preferably correspond to the number of hollow needles 2a-h in the needle unit 2. Each respective valve 7′a-7′h has an input which is fluidly connected to a respective input 7a′-h′ of the first set 107′, and an output which is fluidly connected to a respective junction 70a-h. Accordingly, each respective valve 7′a-7′h is located between a respective input 7a′-h′ of the first set 107′ of inputs and a respective junction 70a-h. Each respective valve 7′a-7′h can be selectively arranged in an open configuration or a closed configuration; when a valve 7′a-7′h is in its open configuration fluid can flow from the respective input of the valve to the respective junction 70a-h, and thus fluid can flow from the respective input 7a′-h′ of the first set 107′ of inputs to which the input of said valve 7′a-h is connected, to the respective junction 70a-h to which the output of said valve 7′a-h is connected.

As already described with respect to the assemblies 101-103 above, the switching valve unit 7 can be selectively arranged in a first configuration or a second configuration, wherein in said first configuration the switching valve unit 7 fluidly connects the n inputs 7a′-7h′ of the first set 107′ of inputs with said n inputs 7a″-7h″ of the second set 107″ of inputs, and in said second configuration the switching valve unit 7 blocks the flow of fluid between the n inputs 7a′-7h′ of the first set 107′ of inputs and said n inputs 7a″-7h″ of the second set 107″ of inputs. In the implementation shown in FIG. 3, the first configuration is achieved by opening all of the valves 7′a-h; and the second configuration is achieved by closing all of the valves 7′a-h.

In another preferred embodiment, the switching valve unit 7 comprises a rotary valve with custom rotor and stator to simultaneously allow parallel opening and closing of the respective conduits.

It should be understood that the flow cell unit 3 used in any of the above-mentioned assembly embodiments may be provided in a cartridge which can be selectively removed from the assembly; the cartridge may be a disposable cartridge for example. It should be understood that the cartridge may take any suitable form; however, the cartridge will always contain the flow cells 3a-d of the flow cell unit 3.

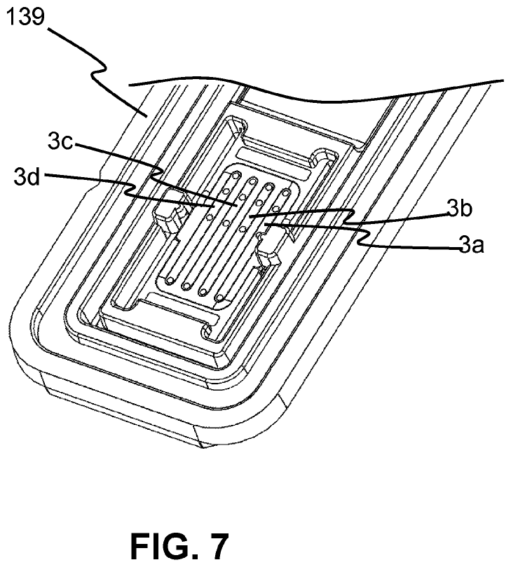

FIG. 7 provides the bottom view of portion of an exemplary cartridge. In this example the cartridge 139 is a disposable cartridge. Referring to FIG. 7 there is shown the flow cells 3a-d of the flow cell unit 3 provided in the disposable cartridge 139. The flow cells 3a-d are integral to the disposable cartridge 139. When the flow cells 3a-d of the cartridge become damaged or non-useable the cartridge is simply removed, and a new cartridge is provided in the assembly.

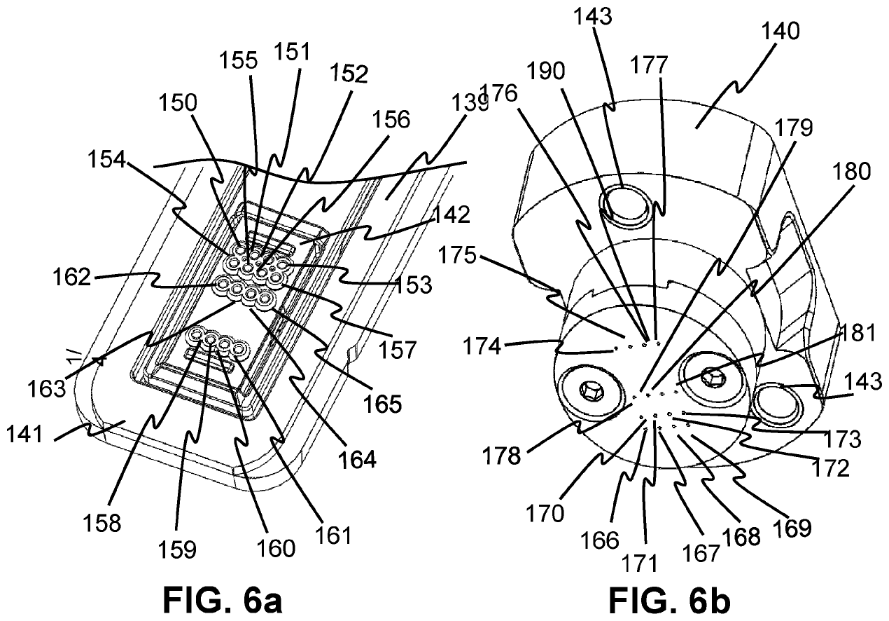

FIG. 6a provides a perspective view of a portion of the disposable cartridge 139 and FIG. 6b provides a perspective view of an exemplary plunger assembly 140, wherein the disposable cartridge 139 and plunger assembly 140 can mechanically cooperate with one another; the disposable cartridge 139 and plunger assembly 140 can be used in any of the above-mentioned assemblies.

FIG. 6a shows a partial perspective-top view of the cartridge 139, which can be used in any of above-described assemblies to define the flow cell unit 3. The cartridge 139 comprises fluidic interfaces 150-165. Each fluidic interface 150-165 comprises a ring member made of an elastomeric compound such as EPDM, FKM or silicone. FIG. 6b shows a perspective-bottom view of a plunger assembly 140 which is fixed part of the assembly. The plunger assembly 140 is suitable for cooperating with the cartridge 139. The plunger assembly 140 further comprises fluidic channels 190 having positions corresponding the positions fluidic interfaces 150-165 provided in the cartridge 139; the respective rim at the open end of each fluidic channel 190 defines a corresponding interface 166-181. The number of fluidic channels preferably corresponds to the number of fluidic interfaces 150-165 provided on the cartridge.

The cartridge 139 comprise a main body 141, the main body 141 may be injected molded, preferably comprising a thermoplastic material such as Polycarbonate or Cyclic Olefin CopolymerPreferably the plunger assembly comprises hard and inert material with high resistance to chemicals, for example precision machined or polished stainless steel or PEEK.

The plunger assembly 140 comprises linear bearings 143 which allow it to be movable in a direction perpendicular to the plane of fluidic interfaces 150-165 of the cartridge 139; in particular, the plunger assembly 140 can be moved to abut the cartridge 139 so as to bring the respective rim at the open end of each fluidic channel 190 which defines a corresponding interface 166-181, into abutment with a corresponding ring member with defines a respective fluidic interface 150-165 on the cartridge. The plunger assembly 140 and cartridge 139 may be maintained in such a position (i.e. a position where by the interfaces are aligned and abut) by means of a pinion such as a stainless steel bolt, or a spring.

Preferably, the plunger assembly 140 is positioned in the assembly so that the respective rims at the open end of each fluidic channel 190 which defines a corresponding interface 166-181, abut respective ring members on the cartridge 139 with define respective fluidic interface 150-165 form a fluid-impermeable seal between the fluidic interfaces 150-165 on the cartridge 139 and the fluidic interfaces 166-181 on the plunger assembly 140. Preferably the plunger assembly 140 is positioned so that the respective rims at the open end of each fluidic channel 190 which defines a corresponding interface 166-181, compress respective ring members on the cartridge 139 with define respective fluidic interface 150-165 form a fluid-impermeable seal between the fluidic interfaces 150-165 on the cartridge 139 and the fluidic interfaces 166-181 on the plunger assembly 140. As an example, the respective rim at the open end of the fluidic channel 190 which defines a fluidic interface 174 is pressed onto the small rings forming the ninth fluidic interface 158, thereby combining and sealing the cartridge part of the second conduit 15 and the fixed parts of the second conduit 15. When moving the plunger assembly 140 away from the cartridge, the fluidic interfaces are separated allowing easy removal and disposable and replacement of the cartridge 139.

In the depicted embodiment, the fluidic interfaces 150-165 on the cartridge 139 comprise rings of elastomeric material; preferably the rings are provided as a sinnle substrate and that sinnle substrate is attached to the main body 141 of the cartridge 139; the centre of each ring is aligned with a respective hole which is defined in the main body 141. In a further preferred embodiment, the fluidic interfaces 150-165 are formed integral to the main body 141 of the cartridge 139; in such an embodiment the main body 141 and the fluidic interfaces 150-165 may both be formed from a single injection molded part; the single injection molded part may comprise dual materials and integrated elastomeric ring seals.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. An assembly comprising,
a needle unit comprising ‘n’ hollow needles, wherein n is greater than one, and wherein each hollow needle can receive a respective sample fluid;
a flow cell unit comprising ‘m’ flow cells, wherein to is greater than one, each flow cell having an input and an output, and a test surface on which ligands can be provided located between the input and output;
a means for consecutively moving sample fluids, from each of said n hollow needles respectively, into all said m flow cells, so that said sample fluids flow consecutively through the same flow cells.

2. An assembly according to claim 1 wherein,
said means for consecutively moving sample fluids, from each of said n hollow needles respectively, into all said m flow cells, comprises
at least one pumping means which can be selectively configured to provide positive pressure or negative pressure;
a switching valve unit having a first set of inputs comprising n inputs which are fluidly connected to respective n hollow needles, and a second set of inputs comprising n inputs which can be fluidly connected to said at least one pumping means, and a set of outputs comprising n outputs, and wherein the switching valve unit can be selectively arranged in a first configuration or a second configuration, wherein in said first configuration the switching valve unit fluidly connects one or more of the n inputs of the first set of inputs with one or more of said n outputs, and in said second configuration the switching valve unit blocks the flow of fluid between the one or more of the n inputs of the first set of inputs with one or more of said n outputs.

3. An assembly according to claim 2 wherein said means for consecutively moving sample fluids, from each of said n hollow needles respectively, into all said m flow cells, comprises, a single pumping means which can be selectively configured to provide positive fluid pressure or negative fluid pressure; and a first selector valve unit having a single input which is fluidly connected to the single pumping mean, and n outputs and wherein first selector valve unit is configured such that it can selectively fluidly connect its single input with one or more of its n outputs; and wherein the switching valve unit comprises a first set of inputs comprising n inputs which are fluidly connected to respective n hollow needles, and a second set of inputs comprising n inputs which are fluidly connected to respective n outputs of the first selector valve unit, and a set of outputs comprising n outputs, and wherein the switching valve unit can be selectively arranged in a first configuration or a second configuration, wherein in said first configuration the switching valve unit fluidly connects one or more of the n inputs of the first set of inputs with one or more of said n outputs, and in said second configuration the switching valve unit blocks the flow of fluid between the one or more of then inputs of the first set of inputs with one or more of said n outputs.

4. An assembly according to claim 3 wherein the first selector valve unit (4) comprises a n valves each valve being fluidly connected to said single pumping means, and each being fluidly connected to a respective one of said n outputs of said first selector valve unit, wherein each of the n valve can be selectively configured to be opened or closed.

5. An assembly according to claim 3 wherein the switching valve unit comprises n switching valve subunits, wherein each subunit comprise a first port which is fluidly connected to a respective hollow needle, a second port which is fluidly connected to a respective output of the first selector valve unit, and third port which is fluidly connected to a respective output of the switching valve unit.

6. An assembly according to claim 3 wherein the switching valve unit comprises n switching valve subunits, wherein each subunit comprises a valve which can be selectively configured to be opened or closed, and one valveless junction wherein, a respective output of the first selector valve unit is fluidly connected to the said valveless junction, said valve is fluidly connected to said valveless junction, and one of said n outputs of said switching valve unit is fluidly connected to said valveless junction; and wherein said valve is arranged between a respective one of said n needles and said valveless junction.

7. An assembly according to claim 3 wherein each respective output of the first selector valve unit is fluidly connected to a respective input of the switching valve unit via a respective conduit.

8. An assembly according to claim 2 wherein said means for consecutively moving sample fluids, from each of said n hollow needles respectively, into all said m flow cells, comprises,
n pumping means each of which has a respective output so as to provide n outputs, and wherein each of said each of said n pumping means can be selectively configured to provide positive fluid pressure or negative fluid pressure at its respective outputs; and
and wherein the switching valve unit comprises a first set of inputs comprising n inputs which are fluidly connected to respective n hollow needles, and a second set of inputs comprising n inputs which are fluidly connected to respective n outputs of said respective n pumping means, and a set of outputs comprising n outputs, and wherein the switching valve unit can be selectively arranged in a first configuration or a second configuration, wherein in said first configuration the switching valve unit fluidly connects one or more of then inputs of the first set of inputs with one or more of said n outputs, and in said second configuration the switching valve unit blocks the flow of fluid between the one or more of the n inputs of the first set of inputs with one or more of said n outputs.

9. An assembly according to claim 2, wherein each of said n outputs of said switching valve unit are fluidly connected to a single conduit, and wherein said single conduit is fluidly connected to respective m inputs of said m flow cells in said flow cell unit.

10. An assembly according to claim 9 wherein each respective output of the switching valve unit is fluidly connected to said single conduit, via a respective conduit.

11. An assembly according to claim 9, wherein the assembly further comprises a first valve and a waste reservoir, and
wherein the first valve is fluidly connected between said waste reservoir and a second junction, wherein said second junction is located between where the n outputs of said switching valve unit are fluidly connected to said single conduit and the in inputs of said m flow cells in said flow cell unit.

12. An assembly according to claim 1 further comprising,
a waste reservoir; and
a second selector valve unit, wherein the second selector valve unit is fluidly connected between respective in outputs of the in flow cells in said flow cell unit and said waste reservoir, and wherein the second selector valve unit is configured to selectively fluidly connect one or more of said m outputs of them flow cells with said first waste reservoir.

13. An assembly according to claim 1 further comprising,
a second pumping means which can be selectively configured to provide positive pressure or negative pressure; and
a third selector valve unit which is arranged between the second pumping means and respective m outputs of the m flow cells, wherein the third selector valve unit is configured to selectively fluidly connect the second pumping means with one or more of said in outputs of the in flow cells.

14. An assembly according to claim 1 further comprising,
a third pumping means can be selectively configured to provide positive pressure or negative pressure, wherein said third pumping means is fluidly connected to a third junction, wherein said third junction is located between where the n outputs of said switching valve unit are fluidly connected to a single conduit and the m inputs of said in flow cells in said flow cell unit.

15. An assembly according to claim 2, wherein each of said n outputs of said switching valve unit are fluidly connected to a single conduit, and wherein said single conduit is fluidly connected to respective m inputs of said m flow cells in said flow cell unit; and
wherein the assembly further comprises an a waste reservoir which is fluidly connected to a valve, and wherein the valve is fluidly connected to a junction, such that the valve is located between said junction and said waste reservoir, and wherein the valve is moveable between a first position wherein the junction is fluidly connected to said waste reservoir, and a second position wherein the valve blocks the flow of fluid from the junction to the waste reservoir; and a auxiliary sample delivery unit which is fluidly connected to said junction;
wherein the assembly further comprising an addressing means, which comprises, a first port which is fluidly connected to said single conduit down-stream of where the n outputs of said switching valve unit are fluidly connected to a single conduit; and a second port which is fluidly connected to said junction; and a third port which is fluidly connected to the inputs of one or more of said m flow cells; and a fourth port which is fluidly connected to the inputs of one or more other of said m flow cells;
and wherein the addressing means further comprises a valve which is configured such that it can be selectively arranged in first configuration and a second configuration, wherein in the first configuration the valve fluidly connects the first port with the third port and fluidly connects the second port and the fourth port, and wherein in the second configuration the valve fluidly connects the first port with fourth port, and fluidly connects the third port with the second port.

16. An assembly according to claim 15 wherein the m flow cells comprise at least a first subset of flow cells and a second subset of flow cells; and wherein the third port is fluidly connected to the inputs of all of the flow cells in the first subset and the fourth port which is fluidly connected to the inputs of all of the flow cells in the second subset.

17. An assembly according to claim 16 further comprising,
a second pumping means which can be selectively configured to provide positive pressure or negative pressure;
a third pumping means which can be selectively configured to provide positive pressure or negative pressure;
a first valve which is fluidly connected to the outputs of all of the flow cells in the first subset; and which is fluidly connected to the second pumping means, wherein the first valve is arranged between said outputs and said second pumping means and can be selectively arranged in a first configuration wherein the first valve fluidly connects the outputs of all of the flow cells in the first subset with the second pumping means, and a second configuration wherein the first valve blocks the flow of fluid between the outputs of all of the flow cells in the first subset and the second pumping means;
a second valve which is fluidly connected to the outputs of all of the flow cells in the second subset, and which is fluidly connected to the third pumping means, wherein the second valve is arranged between said outputs and said third pumping means and can be selectively arranged in a first configuration wherein the second valve fluidly connects the outputs of all of the flow cells in the second subset with the third pumping means, and a second configuration wherein the second valve blocks the flow of fluid between the outputs of all of the flow cells in the first subset and the third pumping means.

18. An assembly according to claim 1 further comprising, a moveable stage which is configured to move the needle unit between a first position where hollow needles of the needle unit can be washed and a second position where sample fluid is provided in the hollow needles of the needle unit.

19. A method of screening a sample fluids for molecules which can bind to predefined ligands, using the assembly of claim 1, the method comprising the steps of,
receiving a respective sample fluid into each of said n hollow needles;
consecutively moving each sample fluid, from its respective hollow needle, into all said m flow cells, so that said sample fluids are made to consecutively flow through said same flow cells

20. A method according to claim 19, using the assembly of claim 3, comprising the steps of,
(a) arranging the switching valve unit in its first configuration;
(b) arranging the first selector valve unit such that it fluidly connect its single input with all of its n outputs;
(c) operating the pumping means to provide a negative pressure so that sample fluids in each of said needles are forced to flow out of the respective needles and through the switching valve unit, wherein the sample fluid in each respective needle is different;
(d) arranging the switching valve unit in its second configuration;
(e) arranging the first selector valve unit such that it fluidly connect its single input with one of its n outputs;
(f) operating the pumping means to provide a positive pressure so that one of said sample fluids is forced to flow through each of said m flow cells;
(g) arranging the first selector valve unit such that it fluidly connect its single input with another one of its n outputs;
(h) operating the pumping means to provide a positive pressure so that another one of said sample fluids is forced to flow through each of said m flow cells.

21. A method according to claim 20 comprising the step,
(i) repeating steps d-g until each of said sample fluids has been forced to flow through each of said m flow cells.

22. A method according to claim 20, further comprising the step of providing different sample fluids in each of said hollow needles of said needle unit, by,
simultaneously inserting each of said needles into a respective well containing a sample fluid;
arranging the switching valve unit in its first configuration;
arranging the first selector valve unit such that it fluidly connect its single input with all of its n outputs;
operating the pumping means to provide a negative pressure so that sample fluids in said wells are aspirated into the respective hollow needles.

23. A method according to claim 19 further comprising the steps of,
detecting, using a sensor, if molecules of a sample fluid have become bound to ligands on the test surfaces of one or more of said flow cells.

24. A method according to claim 23 wherein the step of detecting, using a sensor, if molecules of a sample fluid have become bound to ligands on the test surfaces of one or more of said flow cells comprises,
passing the sample fluid through a flow cell which is without ligands on its test surface;
obtaining an output signal from the sensor as the sample fluid passes through said flow cell which is without ligands on its test surface, wherein the output signal defines a reference signal;
obtaining an output signal from the sensor as the sample fluid passes through a flow cell which has ligands on its test surface, and comparing said output signal with said reference signal;
determining that a molecule of said sample fluid has bound to the ligands of the flow cell if the output signal differs from the reference signal.

25. A method according to claim 19 further comprising the steps of providing ligands on the respective test surfaces of one or more of said flow cells in said flow cell unit.

26. A method according to claim 25 wherein the step of providing ligands on the respective test surfaces of one or more of said flow cells in said flow cell unit comprises providing ligands the test surfaces of a plurality of said flow cells, wherein the type of ligands provided on the test surfaces differ between flow cells such that the test surfaces of said plurality of flow cells have different types of ligands.

27. A method according to claim 25, wherein the steps of providing ligands on the respective test surfaces of one or more of said flow cells in said flow cell unit, comprises,
providing a first immobilization reagent in a first hollow needle of said needle unit;
providing a r different types of ligands in respective r different hollow needles of the needle unit, wherein r is greater than one;
providing a second immobilization reagent in another hollow needle;
passing the first immobilization reagent in the first hollow needle though the two or more flow cells in the flow cell unit, so that the first immobilization reagent contacts the test surface of each flow cell;
for each of said r hollow needles, passing the ligands which are in those respective hollow needles through a respective flow cell, so that the test surfaces of respective two or more flow cells are provided with different types of ligands;
passing the second immobilization reagent in said other hollow needle though the plurality of flow cells in the flow cell unit, to passivate the test surface of each of said two or more flow cells.

28. A method according to claim 27, wherein each respective output of the first selector valve unit is fluidly connected to a respective input of the switching valve unit via a respective conduit, and wherein the step of passing the immobilization reagent in the hollow needle though the two or more flow cells in the flow cell unit, so that the immobilization reagent contacts the test surface of each flow cell, comprises,
arranging the switching valve unit in its first configuration;
operating the pumping means to provide a negative pressure which simultaneously moves the first immobilization reagent in a first hollow needle of said needle unit into a first conduit, moves said r different types of ligands into respective r different conduits, and moves the second immobilization reagent in a first hollow needle of said needle unit into a another conduit;
arranging the switching valve unit in its second configuration;
arranging the first selector valve unit such that it fluidly connects its single input to its output which is fluidly connected to said first conduit;
operating the pumping means to provide a positive pressure so that the first immobilization reagent, which is in said first conduit, is forced to flow through all of said m flow cells;
for each one of the r different output of said switching valve unit, arranging the first selector valve unit such that it fluidly connects its single input to its output which is fluidly connected to said respective one of said conduits, and operating the pumping means to provide a positive pressure so that the ligand in that conduit is forced to flow through one of said flow cells, wherein each different ligand in the r different inputs is forced to flow through a different one of said m flow cells;
arranging the first selector valve unit such that it fluidly connects its single input to its output which is fluidly connected to said other conduit;
operating the pumping means to provide a positive pressure so that the second immobilization reagent, which is in said other conduit, is forced to flow through all of said m flow cells.

29. A method according to claim 28 wherein the method further comprises the steps of,
providing a buffer fluid in at least one other hollow needle of said needle unit;
passing the buffer fluid in said at least one other hollow needle though said two or more flow cells in the flow cell unit.

30. A method according to claim 19, further comprising the step of rinsing the test surfaces of said flow cells using a buffer fluid.

31. A method according to claim 19, using the assembly of claim 8 the method comprising the steps of,
(a) arranging the switching valve unit in its first configuration;
(b) operating the n pumping means to provide a negative pressure, so that each of said sample fluids in each of said needles are forced to flow out of the respective needles and through the switching valve unit (7), wherein the sample fluid in each respective needle is different;
(c) arranging the switching valve unit in its second configuration;
(d) consecutively operating each of said respective n pumping means to consecutively provide a positive pressure so that each of said sample fluids are forced consecutively to flow through said m flow cells.
